(19) United States
(12) Patent Application Publication
(10) Pub. No.: US 2010/0166053 A1
(43) Pub. Date: Jul. 1, 2010

(54) INFORMATION PROCESSING DEVICE AND METHOD

(75) Inventors: Takahiro Fukuhara, Kanagawa (JP); Junya Araki, Tokyo (JP); Kazuhisha Hosaka, Tokyo (JP); Satoshi Tsubaki, Kanagawa (JP); Tamotsu Munakata, Kanagawa (JP); Koji Kamiya, Kanagawa (JP); George Fujita, Shizuoka (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Minato-ku (JP)

(21) Appl. No.: 12/293,551

(22) PCT Filed: Jan. 30, 2008
(86) PCT No.: PCT/JP08/51353

§ 371 Date: Sep. 19, 2008

(30) Foreign Application Priority Data
Jan. 31, 2007 (JP) 2007-020523

(51) Int. Cl. H04N 7/26

(52) U.S. Cl. 375/240.01; 375/260; 375/E07.026

(57) ABSTRACT

The present invention relates to an information processing device and method, program, and communication system, whereby encoded data can be transmitted with low delay. A data control unit 137 causes encoded data supplied in order from lowband component to be temporarily accumulated in a memory unit 301 and counts the code amount of the encoded data accumulated, cuts off obtaining of encoded data at the stage where the encoded data reaches a predetermined amount, reads out part or all of encoded data accumulated in the memory unit 301, and supplies to a packetizing unit 302 as return encoded data. The present invention can be applied to, for example, a digital triax system.

### TECHNICAL FIELD

The present invention relates to an information processing device and method, and particularly, relates to an information processing device and method whereby encoded data can be transmitted with low delay.

### BACKGROUND ART

Conventionally, as a video picture transmission/reception device, there has been a triax system employed for sports relay broadcasting or the like at a broadcasting station or stadium. Triax systems which have been employed so far have been primarily for analog pictures, but along with recent digitization of image processing, it can be conceived that digital triax systems for digital pictures will become widespread from now on.

With a common digital triax system, a video picture is captured at a camera head and sent to a transmission path (main line video picture), and the main line video picture is received at a camera control unit, and the picture is output to a screen.

Now, the camera control unit is a separate system from the main line video picture, and transmits a return video picture to the camera head side. The return video picture may be the main line video picture supplied from the camera head having been converted, or may be a video picture externally input at the camera control unit. The camera head outputs this return video picture to the screen, for example.

In general, the band of a transmission path between the camera head and camera control unit is limited, so a video picture needs to be compressed to be transmitted through the transmission path. For example, in a case wherein a main line video picture to be transmitted from the camera head toward the camera control unit is HDTV (High Definition Television) signals (current signals are around 1.5 Gbps), it is realistic to compress these to around 150 Mbps which is around 1/10.

As for such a picture compression method, there are various compression methods, for example, MPEG (Moving Picture Experts Group) and so forth (see Patent Document 1, for example). An example of a conventional digital triax system in a case of compressing a picture in this way is shown in FIG. 1.

A camera head 11 has a camera 21, encoder 22, and decoder 23, wherein picture data (moving images) taken at the camera 21 are encoded at the encoder 22 and the encoded data is supplied to a camera control unit 12 via a main line D10 which is 1 system of the transmission cable. The camera control unit 12 has a decoder 41 and encoder 42, and upon obtaining the encoded data supplied from the camera head 11, decodes this at the decoder 41, supplies the decoded picture data to a main view 51 which is a display for main line pictures via a cable D11, and causes the image to be displayed.

Also, the picture data is retransmitted from the camera control unit 12 to the camera head 11 as a return video picture, in order to cause the user of the camera head 11 to confirm whether or not the camera control unit 12 has received the picture sent out from the camera head 11. Generally, the bandwidth of the return line D13 for transmitting this return video picture is narrower in comparison with the main line D10, so the camera control unit 12 re-encodes the picture data decoded at the decoder 41 at the encoder 42, generates encoded data of a desired bit rate (in normal cases, a bit rate lower than when transmitting over the main line), and supplies this encoded data to the camera head 11 via the return line D13 which is 1 system of the transmission cable, as a return video picture.

Upon obtaining the encoded data (return video picture), the camera head 11 decodes at the decoder 23, supplies the decoded picture data to a return view 31 which is a display for return video images, via a cable D14, and causes the image to be displayed.

The above is the basic configuration and operations of the digital triax system.

### Patent Document 1: Japanese Unexamined Patent Application Publication No. 9-261633

### DISCLOSURE OF INVENTION

### Technical Problem

However, with such a method, there has been the concern that the delay time from encoding being started at the encoder 22 (from the video picture signal being obtained at the camera 21) to output being started of the decoded picture data by the decoder 23 might be long. Also, the camera control unit 12 also needs the encoder 42, so there has been the concern that the circuit scale and cost might increase.

The relation in timing of each processing performed as to the picture data is shown in FIG. 2.

As shown in FIG. 2, even if the time required for transmission between the camera head 11 and the camera control unit 12 is assumed to be 0, there is delay of P [msec] for example, between the timing of the encoder 22 of the camera head 11 starting processing and the timing of the decoder 41 of the camera control unit 12 starting output, due to processing and the like of the encoding and decoding.

And, even if the encoder 42 encodes the decoded picture data immediately, there is further delay of P [msec] until the decoder 23 of the camera head 11 starts output, due to processing and the like of the encoding and decoding.

That is to say, delay of (P×2) [msec] which is twice the delay occurring at the main line video picture occurs from starting of encoding at the encoder 22 to starting of output of decoded picture data by the decoder 23. In a system where low delay is demanded, delay time cannot be sufficiently shortened with such a method.

The present invention has been proposed in light of the above-described conventional actual state, and is for enabling transmission of encoded data with low delay.

### Technical Solution

One aspect of the present invention is an information processing device for encoding image data and generating encoded data, comprising: rearranging means for rearranging beforehand coefficient data split into every frequency band, in an order in which synthesizing processing is performed for synthesizing coefficient data of a plurality of sub-bands split into frequency bands to generate image data, for every line block including image data of a number of lines worth necessary to generate one line worth of coefficient data of a lowest band component sub-band; encoding means for encoding coefficient data, rearranged by the rearranging means, every line block, and generating encoded data; storage means for storing encoded data generated by the encoding means; calculating means for calculating the sum of code amount of the encoded data, each time the storage means store a plurality of the line blocks worth of encoded data; and output means for outputting the encoded data stored in the storage means, in the event that the sum of code amount calculated by the calculating means reaches the target code amount.

The output means may convert the bit rate of the encoded data.

The rearranging means may rearrange the coefficient data in order from lowband component to highband component, every line block.

This may further comprise control means for controlling the rearranging means and the encoding means so as to each operate in parallel, every line block.

The rearranging means and the encoding means may perform each processing in parallel.

This may further comprise filter means for performing filtering processing as to the image data every line block, and generating a plurality of sub-bands made up of coefficient data split into every frequency band.

This may further comprise decoding means for decoding the encoded data.

This may further comprise modulation means for modulating the encoded data at mutually different frequency regions and generating modulation signals; amplifying means for performing frequency multiplexing and amplification of modulation signals generated by the modulation means; and transmission means for synthesizing and transmitting modulation signals amplified by the modulation means.

This may further comprise modulation control means for setting a modulation method of the modulation means, based on attenuation rate of a frequency region.

This may further comprise control means for, in the event that the attenuation rate of a frequency region is at or above a threshold value, setting signal point distance as to a highband component so as to be great.

This may further comprise control means for, in the event that the attenuation rate of a frequency region is at or above a threshold value, setting an appropriation amount of error correction bits as to the highband component so as to be larger.

This may further comprise control means for, in the event that the attenuation rate of a frequency region is at or above a threshold value, setting a compression rate as to the highband component so as to be larger.

The modulation means may perform modulation by OFDM method.

This may further comprise a synchronization control unit for performing control of synchronization timing between the encoding means and decoding means for decoding the encoded data, using image data of which a data amount is smaller than a threshold value.

The image data of which a data amount is smaller than a threshold value may be an image of one picture worth wherein all pixels are black.

An aspect of the present invention is also an information processing method for an information processing device encoding image data and generating encoded data, comprising the steps of: rearranging coefficient data beforehand split into every frequency band, in an order in which synthesizing processing is performed for synthesizing coefficient data of a plurality of sub-bands split into frequency bands to generate image data, for every line block including image data of a number of lines worth necessary to generate one line worth of coefficient data of a lowest band component sub-band; encoding rearranged coefficient data, every line block, and generating encoded data; storing generated encoded data; calculating the sum of code amount of the encoded data, each time a plurality of the line blocks worth of encoded data is stored; and outputting the stored encoded data, in the event that the calculated sum of code amount reaches the target code amount.

According to an aspect of the present invention, coefficient data split into every frequency band is rearranged in an order in which synthesizing processing is performed for synthesizing coefficient data of a plurality of sub-bands split into frequency bands to generate image data, for every line block including image data of a number of lines worth necessary to generate one line worth of coefficient data of a lowest band component sub-band; rearranged coefficient data is encoded, every line block, and encoded data is generated; generated encoded data is stored; the sum of code amount of the encoded data is calculated each time a plurality of the line blocks worth of encoded data is stored; and the stored encoded data is output, in the event that the calculated sum of code amount reaches the target code amount.

### ADVANTAGEOUS EFFECTS

According to the present invention, the bit rate of data to be transmitted can be easily controlled. Particularly, the bit rate thereof can be easily changed without decoding encoded data.

### BRIEF DESCRIPTION OF DRAWINGS

FIG. 1 is a block diagram illustrating a configuration example of a conventional digital triax system.

FIG. 2 is a diagram illustrating the relation in timing of each processing performed as to picture data, with the digital triax system shown in FIG. 1.

FIG. 3 is a block diagram illustrating a configuration example of a digital triax system to which the present invention has been applied.

FIG. 4 is a block diagram illustrating a detailed configuration example of a video signal encoding unit in FIG. 3.

FIG. 5 is an outlined line drawing for schematically explaining about wavelet transformation.

FIG. 6 is an outlined line drawing for schematically explaining about wavelet transformation.

FIG. 7 is an outlined line drawing illustrating an example of performing filtering by lifting with a 5×3 filter, to division level=2.

FIG. 8 is an outlined line drawing schematically illustrating the flow of wavelet transformation and wavelet inverse transformation according to the present invention.

FIG. 9 is a schematic diagram for explaining an example of the way in which encoded data is exchanged.

FIG. 10 is a diagram illustrating a configuration example of a packet.

FIG. 11 is a block diagram illustrating a detailed configuration example of a data conversion unit shown in FIG. 3.

FIG. 12 is a block diagram illustrating a configuration example of a video signal decoding unit shown in FIG. 3.

FIG. 13 is an outlined line drawing schematically illustrating an example of parallel operation.

FIG. 14 is a diagram for describing an example of the way in which bit rate conversion is made.

FIG. 15 is a diagram illustrating the relation in timing of each processing performed as to picture data, with the digital triax system shown in FIG. 3.

FIG. 16 is a block diagram illustrating a detailed configuration example of a data control unit in FIG. 11.

FIG. 17 is a flowchart for explaining an example of the primary flow of processing executed at the entire digital triax system in FIG. 3.

FIG. 18 is a flowchart for explaining a detailed example of a flow of encoding processing.

FIG. 19 is a flowchart for explaining a detailed example of a flow of decoding processing.

FIG. 20 is a flowchart for explaining a detailed flow example of bit rate conversion processing.

FIG. 21 is a block diagram illustrating another example of the video signal encoding unit in FIG. 3.

FIG. 22 is an outlined line diagram for explaining the flow of processing in the case of performing wavelet coefficient rearranging processing at the video signal encoding unit.

FIG. 23 is an outlined line diagram for explaining the flow of processing in the case of performing wavelet coefficient rearranging processing at the video signal decoding unit.

FIG. 24 is a diagram for explaining an example of the way in which data amount is counted.

FIG. 25 is a diagram for explaining another example of the way in which data amount is counted.

FIG. 26 is a block diagram illustrating another configuration example of a data control unit.

FIG. 27 is a flowchart for explaining another example of bit rate conversion processing.

FIG. 28 is a block diagram illustrating another configuration example of the digital triax system to which the present invention has been applied.

FIG. 29 is a block diagram illustrating a configuration example of a conventional digital triax system corresponding to the digital triax system in FIG. 28.

FIG. 30 is a block diagram illustrating another configuration example of the camera control unit.

FIG. 31 is a block diagram illustrating a configuration example of a communication system to which the present invention has been applied.

FIG. 32 is a schematic diagram illustrating an example of a display screen.

FIG. 33 is a diagram illustrating an example of frequency distribution of modulation signals.

FIG. 34 is a diagram illustrating an example of attenuation properties of a triax cable.

FIG. 35 is a block diagram illustrating yet another configuration example of the digital triax system.

FIG. 36 is a flowchart for explaining an example of the flow of rate control processing.

FIG. 37 is a block diagram illustrating yet another configuration example of the digital triax system.

FIG. 38 is a diagram for explaining an example of the way in which data is transmitted.

FIG. 39 is a block diagram illustrating yet another configuration example of the digital triax system.

FIG. 40 is a flowchart for explaining an example of the flow of control processing.

FIG. 41 is a diagram illustrating a configuration example of an information processing system to which the present invention has been applied.

### EXPLANATION OF REFERENCE NUMERALS

100 digital triax system, 120 video signal encoding unit, 136 video signal decoding unit, 137 data control unit, 138 data converting unit, 301 memory unit, 302 packetizing unit, 321 de-packetizing unit, 353 line block determining unit, 354 accumulation value count unit, 355 accumulation results determining unit, 356 encoded data accumulation control unit, 357 first encoded data output unit, 358 second encoded data output unit, 453 encoded data accumulation control unit, 454 accumulation determining unit, 456 group determining unit, 457 accumulation value count unit, 458 accumulation results determining unit, 459 first encoded data output unit, 460 second encoded data output unit, 512 camera control unit, 543 data control unit, 544 memory unit, 581 camera control unit, 601 communication device, 602 communication device, 623 data control unit, 643 data control unit, 1113 rate control unit, 1401 modulation control unit, 1402 encoding control unit, 1403 C/N ratio measuring unit, 1404 error rate measuring unit, 1405 measurement result determining unit, 1761 synchronization control unit, 1771 synchronization control unit

### BEST MODES FOR CARRYING OUT THE INVENTION

Embodiments of the present invention will be explained below.

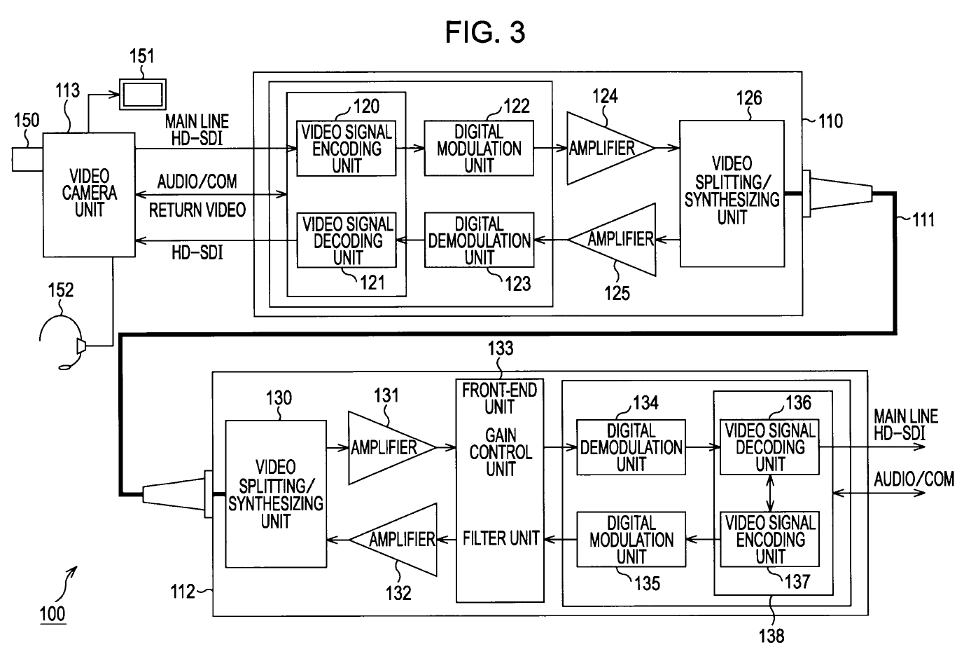

FIG. 3 is a block diagram illustrating a configuration example of a digital triax system to which the present invention has been applied.

In FIG. 3, the digital triax system 100 is a system in which, at the time of studio recording or relay at a television broadcast station or production studio, multiple signals such as picture signals, audio signal, return (return) picture signals, synchronization signals, and so forth, are superimposed, and supply of power source is also performed, with a single coaxial cable connecting a video camera, and a camera control unit or switcher.

With this digital triax system 100, a transmission unit 110 and camera control unit 112 are connected through a triax cable (coaxial cable) 111. Sending of digital video signals and digital audio signals actually broadcasted or used as footage from the transmission unit 110 to the camera control unit 112 (hereafter referred to as main line signals), and sending out of intercom audio signals and return digital video signals from the camera control unit 112 to the video camera unit 113, are performed via the triax cable 111.

The transmission unit 110 is built in an unshown video camera device, for example. The transmission unit 110 is not restricted to this, and may be connected with a video camera device by a predetermined method and used, as an external device as to the video camera device. Also, the camera control unit 112 is, for example, a device generally called a CCU (Camera Control Unit).

Note that with regard to digital audio signals, description will be omitted to avoid complication, since there is little relation to the essence of this invention.

The video camera unit 113 is configured within, for example, an unshown video camera device, receives light from a subject, which is entered through an optical system 150 including a lens, focus mechanism, zoom mechanism, iris adjustment mechanism, and so forth, at an unshown imaging device made up of a CCD (Charge Coupled Device) and so forth. The imaging device converts the received light into an electric signal by photoelectric conversion, further subjects this to predetermined signal processing, and outputs a baseband digital video signal. This digital video signal is subjected to mapping to the HD-SDI (High Definition-Serial Data Interface) format, and is output.

Also, the video camera unit 113 is connected with a display unit 151 employed as a monitor, and an intercom 152 for exchanging audio externally.

The transmission unit 110 has a video signal encoding unit 120 and video signal decoding unit 121, digital modulation unit 122 and digital demodulation unit 123, amplifiers 124 and 125, and a video splitting/synthesizing unit 126.

At the transmission unit 110, baseband digital video signals, mapped to the HD-SDI format for example, are supplied from the video camera unit 113. The digital video signals are main line picture data which are compressed and encoded at the video signal encoding unit 120 to become encoded data (code stream), which is supplied to the digital modulation unit 122. The digital modulation unit 122 modulates the supplied code stream into signals of a format suitable for transmission over the triax cable 111, and outputs. The signals output from the digital modulation unit 122 are supplied to the video splitting/synthesizing unit 126 via an amplifier 124. The video splitting/synthesizing unit 126 sends the supplied signals to the triax cable 111. These signals are supplied to the camera control unit 112 via the triax cable 111.

Also, the signals output from the camera control unit 112 are supplied to and received at the transmission unit 110 via the triax cable 111. Those received signals are supplied to the video splitting/synthesizing unit 126, and the portion of digital video signals and the portion of other signals are separated. Of the received signals, the portion of the digital video signals is supplied via an amplifier 125 to the digital demodulation unit 123, the signals modulated into a format suitable for transmission over the triax cable 111 are demodulated at the camera control unit 112 side, and the code stream is restored.

The code stream is supplied to the video signal decoding unit 121, the compression encoding is decoded, and becomes the baseband digital video signals. The decoded digital video signals are mapped to the HD-SDI format and output, and supplied to the video camera unit 113 as return digital video signals (return video picture data). The return digital video signals are supplied to the display unit 151 connected to the video camera unit 113, and used for monitoring of the return video picture and so forth by the camera operator.

The camera control unit 112 has a video splitting/synthesizing unit 130, amplifiers 131 and 132, a front-end unit 133, a digital demodulation unit 134 and digital modulation unit 135, and a video signal decoding unit 136 and data control unit 137.

Signals output from the transmission unit 110 are supplied to and received at the camera control unit 112 via the triax cable 111. The received signals are supplied to the video splitting/synthesizing unit 130. The video splitting/synthesizing unit 130 supplies the signals supplied thereto to the digital demodulation unit 134 via the amplifier 131 and front-end unit 133. Note that the front-end unit 133 has a gain control unit for adjusting gain of input signals, a filter unit for performing predetermined filter processing on input signals, and so forth.

The digital demodulation unit 134 demodulates the signals modulated into signals of a format suitable for transmission over the triax cable 111 at the transmission unit 110 side, and restores the code stream. The code stream is supplied to the video signal decoding unit 136, the compression encoding is decoded, and becomes the baseband digital video signals. The decoded digital video signals are mapped to the HD-SDI format and output, and output externally as main line digital video signals.

The digital audio signals are supplied externally to the camera control unit 112. The digital audio signals are supplied to the intercom 152 of the camera operator for example, to be used for propagating external audio instructions to the camera operator. The video signal decoding unit 136 decodes the encoding stream supplied from the digital demodulation unit 134 and also supplies the encoded stream before decoding thereof to the data control unit 137. The data control unit 137 converts the bit rate of the encoded stream to a suitable value, for processing as an encoded stream of return digital video signals.

Note that in the following, the video signal decoding unit 136 and the data control unit 137 may also be collectively referred to as a data converting unit 138, to facilitate description. That is to say, the data converting unit 138 is a processing unit which performs processing relating to conversion of data, such as decoding and bit rate conversion for example, which includes the video signal decoding unit 136 and the data control unit 137. Of course, the data converting unit 138 may perform conversion processing other than this, as well.

Generally, there are many cases where it is said that it is permissible for the image quality of return digital video signals to be lower than the main line digital video signals. Accordingly, the data control unit 137 lowers the bit rate of the supplied encoded stream to a predetermined value. Details of the data control unit 137 will be described later. The encoded stream of which the bit rate has been converted is supplied to the digital modulation unit 135 by the data control unit 137. The digital modulation unit 135 modulates the supplied code stream into signals of a format suitable for transmission over the triax cable 111, and outputs. The signals output from the digital modulation unit 135 are supplied to the video splitting/synthesizing unit 130 via the front-end unit 133 and amplifier 132, the video splitting/synthesizing unit 130 multiplexes these signals with other signals, and sends out to the triax cable 111. The signals are supplied to the transmission unit 110 via the triax cable 111 as return digital video signals.

The video splitting/synthesizing unit 126 supplies the signals supplied thereto to the digital demodulation unit 123 via the amplifier 125. The digital demodulation unit 123 demodulates the signals supplied thereto, restores the encoded stream of the return digital video signals, and supplies this to the video signal decoding unit 121. The video signal decoding unit 121 decodes the encoded stream of the return digital video signals that has been supplied, and upon obtaining the return digital video signals, supplies this to the video camera unit 113. The video camera unit 113 supplies the return digital video signals to the display unit 151, and causes the return video picture to be displayed.

While details will be described later, the data control unit 137 thus changes the bit rate of the encoded stream of main line digital video signals without decoding, and accordingly the encoded stream of which the bit rate has been converted can be used as an encoded stream of the return digital video signals, and transferred to the video camera unit 113. Accordingly, the digital triax system 100 can further shorten the delay time up to displaying the return video picture on the display unit 151. Also, at the camera control unit 112, there is no more need to provide an encoder for return digital video signals, so the circuit scale and cost of the camera control unit 112 can be reduced.

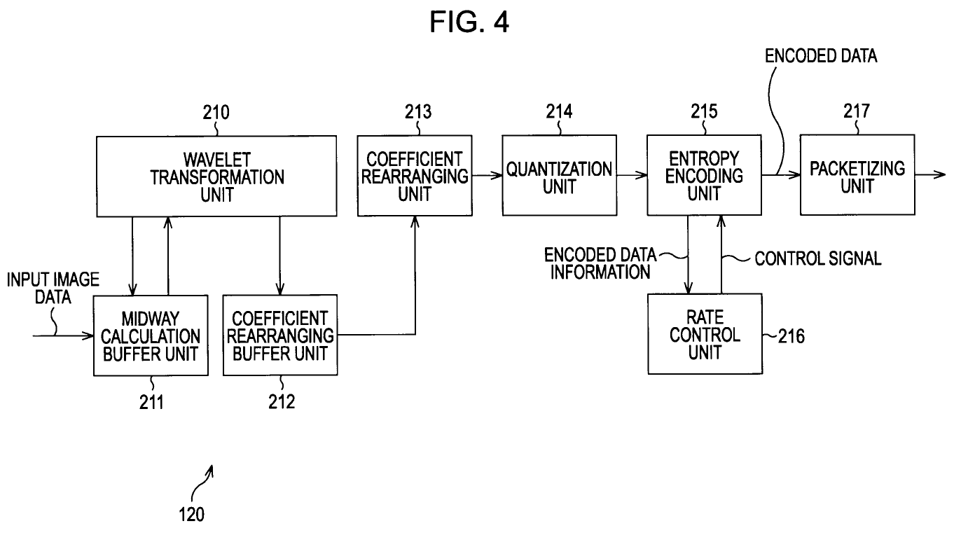

FIG. 4 is a block diagram illustrating a detailed configuration example of the video signal encoding unit 120 shown in FIG. 3.

In FIG. 4, the video signal encoding unit 120 includes a wavelet transformation unit 210, midway calculation buffer unit 211, coefficient rearranging buffer unit 212, coefficient rearranging unit 213, quantization unit 214, entropy encoding unit 215, rate control unit 216, and packetizing unit 217.

The input image data is temporarily stored in the midway calculation buffer unit 211. The wavelet transformation unit 210 subjects the image data stored in the midway calculation buffer unit 211 to wavelet transformation. That is to say, the wavelet transformation unit 210 reads out the image data from the midway calculation buffer unit 211, subjects this to filter processing using an analysis filter to generate the coefficient data of lowband components and highband components, and stores the generated coefficient data in the midway calculation buffer unit 211. The wavelet transformation unit 210 includes a horizontal analysis filter and vertical analysis filter, and subjects an image data group to analysis filter processing regarding both of the screen horizontal direction and screen vertical direction. The wavelet transformation unit 210 reads out the coefficient data of the lowband components stored in the midway calculation buffer unit 211 again, subjects the read coefficient data to filter processing using the analysis filter to further generate the coefficient data of highband components and lowband components. The generated coefficient data is stored in the midway calculation buffer unit 211.

The wavelet transformation unit 210 repeats this processing, and when the division level reaches a predetermined level, reads out the coefficient data from the midway calculation buffer unit 211, and writes the read coefficient data in the coefficient rearranging buffer unit 212.

The coefficient rearranging unit 213 reads out the coefficient data written in the coefficient rearranging buffer unit 212 in a predetermined order, and supplies this to the quantization unit 214. The quantization unit 214 quantizes the supplied coefficient data, and supplies this to the entropy encoding unit 215. The entropy encoding unit 215 encodes the supplied coefficient data using a predetermined entropy encoding method such as Huffman encoding, arithmetic coding, or the like, for example.

The entropy encoding unit 215 operates synchronously with the rate control unit 216, and is controlled such that the bit rate of the compression encoded data to be output is a generally constant value. That is to say, based on encoded data information from the entropy encoding unit 215, the rate control unit 216 supplies, to the entropy encoding unit 215, control signals for effecting control so as to end encoding processing by the entropy encoding unit 215 at the point that the bit rate of the data compression encoded by the entropy encoding unit 215 reaches the target value or immediately before reaching the target value. At the point that the encoding processing ends in accordance with the control signal supplied from the rate control unit 216, the entropy encoding unit 215 supplies the encoded data to the packetizing unit 217. The packetizing unit 217 sequentially packetizes the supplied encoded data, and outputs to the digital modulation unit 122 shown in FIG. 3.

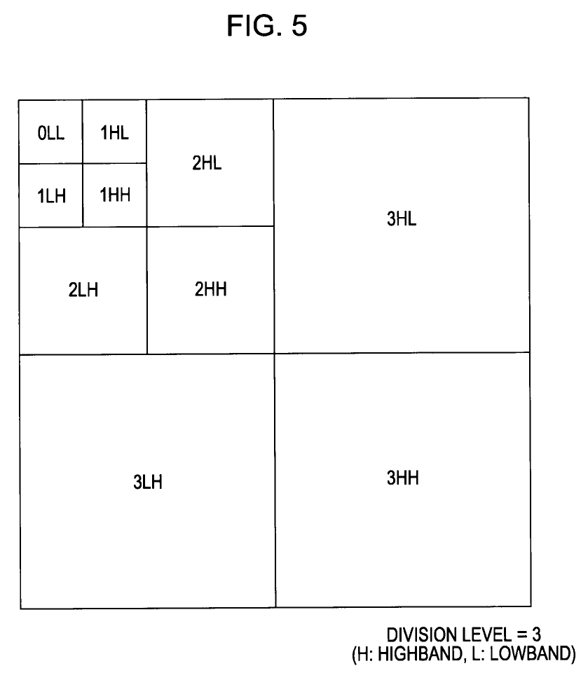

Next, description will be made in more detail regarding the processing performed by the wavelet transformation unit 210. First, wavelet transformation will be described schematically. With wavelet transformation as to image data, as schematically illustrated in FIG. 5, processing for dividing image data into a high spatial frequency band and a low spatial frequency band is repeated recursively as to a low spatial frequency band obtained as a result of division. Thus, low spatial frequency band data is driven into a smaller region, thereby enabling effective compression encoding.

Now, FIG. 5 is an example of a case wherein dividing processing of the lowest band component region of image data into lowband component regions L and highband component regions H is repeated three times, thereby obtaining division level=3. In FIG. 5, “L” and “H” represent a lowband component and highband component respectively, and with regard to the order of “L” and “H”, the front side indicates a band which is a division result in the horizontal direction, and the rear side indicates a band which is a division result in the vertical direction. Also, a numeral before “L” and “H” indicates the division level of the region thereof.

Also, as can be understood from the example shown in FIG. 5, the processing is performed in a stepwise manner from the right lower region to the left upper region of the screen, thereby driving lowband components into a small region. That is to say, with the example shown in FIG. 5, the right lower region of the screen is set to a region 3HH including the least lowband components (including the most highband components), and the left upper region obtained by the screen being divided into four regions is further divided into four regions, and of the four divided regions, the left upper region is further divided into four regions. The leftmost upper corner region is set to a region 0LL including the most lowband components.

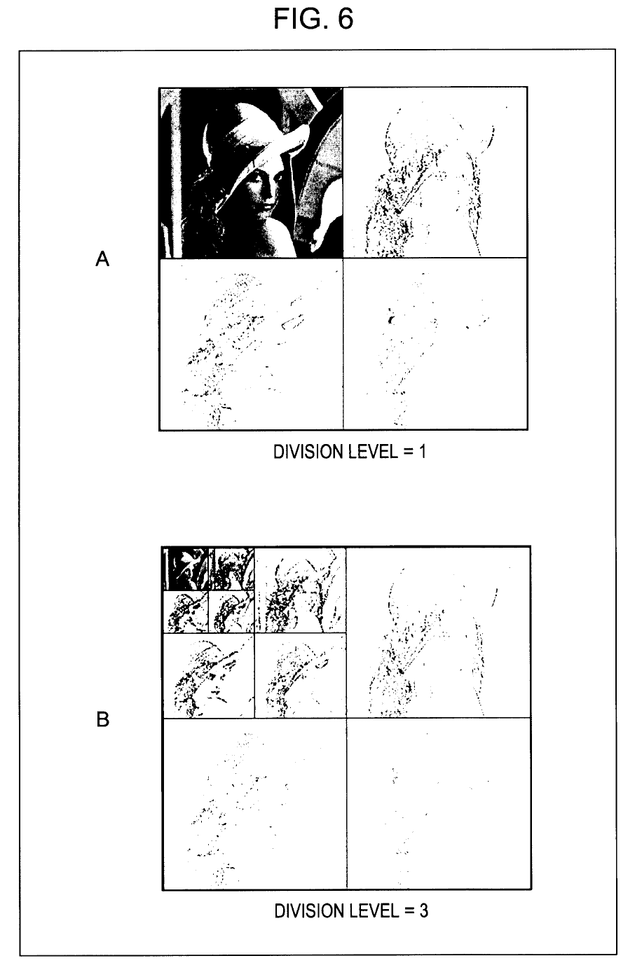

The reason why conversion and division are repeatedly performed as to lowband components is because the energy of the screen concentrates on lowband components. This can also be understood from a situation wherein as the division level is advanced from a state of division level=1 of which an example is shown in A in FIG. 6 to a state of division level=3 of which an example is shown in B in FIG. 6, sub-bands are formed such as shown in B in FIG. 6. For example, the division level of wavelet transformation shown in FIG. 5 is 3, and as a result thereof, ten sub-bands are formed.

The wavelet transformation unit 210 usually performs the processing such as described above using a filter bank made up of a lowband filter and highband filter. Note that a digital filter usually has impulse response of multiple tap lengths, i.e., a filter coefficient, so there is usually the need to subject input image data or coefficient data to buffering as much as filter processing can be performed beforehand. Also, similarly, even in a case wherein wavelet transformation is performed with multiple stages, there is the need to subject the wavelet transformation coefficient generated at the previous stage to buffering as much as filter processing can be performed.

A method employing a 5×3 filter will be described as a specific example of wavelet transformation. This method employing a 5×3 filter is also employed with JPEG (Joint Photographic Experts Group) 2000 standard already described in the Related Art, and is an excellent method in that wavelet transformation can be performed with few filter taps.

Impulse response of a 5×3 filter (Z transform expression) is, as shown in the following Expressions (1) and (2), configured of a lowband filter H₀(z) and a highband filter H₁(z). According to Expressions (1) and (2), it can be found that the lowband filter H₀(z) is five taps, and the highband filter H₁(z) is three taps.

H₀(z)=(−1+2z⁻¹+6z⁻²+2z⁻³−z⁻⁴)/8 (1)

H₁(z)=(−1+2z⁻¹−z⁻²)/2 (2)

According to these Expression (1) and Expression (2), the coefficients of lowband components and highband components can be calculated directly. Here, employing a lifting technique enables computation of filter processing to be reduced.

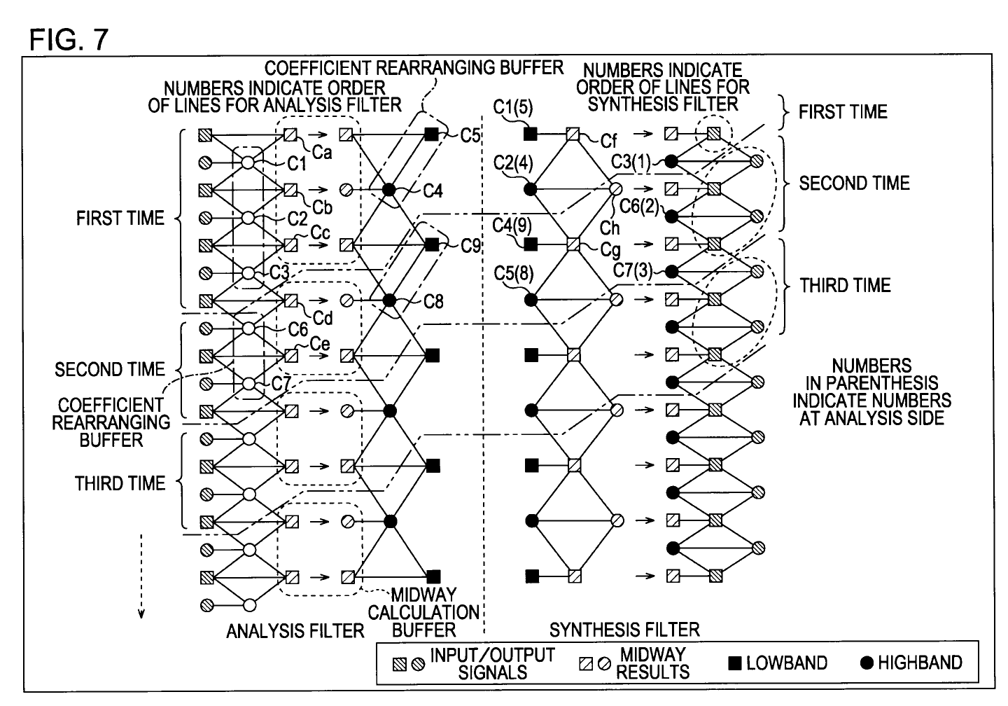

Next, this wavelet transformation method will be described more specifically. FIG. 7 is illustrates an example wherein filter processing according to lifting of a 5×3 filter is executed up to division level=2. Note that, in FIG. 7, the portion shown as analysis filters at the left side of the drawing is the filters of the wavelet transformation unit 210 in the video signal encoding unit 120. Also, the portion shown as synthesis filters at the right side of the drawing is the filters of a wavelet inverse transformation unit in a later-described video signal decoding unit 136.

Note that with the following description, for example, let us say that with the pixel of the left upper corner of the screen as the head at a display device or the like, pixels are scanned from the left edge to the right edge of the screen, thereby making up one line, and scanning for each line is performed from the upper edge to the lower edge of the screen, thereby making up one screen.

In FIG. 7, the left edge column illustrates that pixel data disposed at corresponding positions on the line of original image data is arrayed in the vertical direction. That is to say, the filter processing at the wavelet transformation unit 210 is performed by pixels on the screen being scanned vertically using a vertical filter. The first through third columns from the left edge illustrate division level=1 filter processing, and the fourth through sixth columns illustrate division level=2 filter processing. The second column from the left edge illustrates highband component output based on the pixels of the original image data of the left edge, and the third column from the left edge illustrates lowband component output based on the original image data and highband component output. The division level=2 filter processing is performed as to the output of the division level=1 filter processing, such as shown in the fourth through sixth columns from the left edge.

With the division level=1 filter processing, highband component coefficient data is calculated based on the pixels of the original image data as a first stage of the filter processing, lowband component coefficient data is calculated based on the highband component coefficient data calculated at the first stage of the filter processing, and the pixels of the original image data. An example of the division level=1 filter processing is illustrated at the first through third columns at the left side (analysis filter side) in FIG. 7. The calculated highband component coefficient data is stored in the coefficient rearranging buffer unit 212 described with reference to FIG. 4. Also, the calculated lowband component coefficient data is stored in the midway calculation buffer unit 211.

In FIG. 7, the data surrounded with single dot broken lines is temporarily saved in the coefficient rearranging buffer unit 212, and the data surrounded with dotted lines is temporarily saved in the midway calculation buffer unit 211.

The division level=2 filter processing is performed based on the results of the division level=1 filter processing held at the midway calculation buffer unit 211. With the division level=2 filter processing, the coefficient data calculated as lowband coefficients at the division level=1 filter processing is regarded as coefficient data including lowband components and highband components, the same filter processing as that of the division level=1 filter processing is performed. The highband component coefficient data and lowband component coefficient data calculated by the division level=2 filter processing is stored in the coefficient rearranging buffer unit 212 described with reference to FIG. 4.

With the wavelet transformation unit 210, the filter processing such as described above is performed each in the horizontal direction and vertical direction of the screen. For example, first, the division level=1 filter processing is performed in the horizontal direction, and the generated coefficient data of highband components and lowband components is stored in the midway calculation buffer unit 211. Next, the coefficient data stored in the midway calculation buffer unit 211 is subjected to the division level=1 filter processing in the vertical direction. According to the processing in the horizontal and vertical directions at the division level=1, there are formed four regions of a region HH and region HL obtained by further dividing highband components each into highband components and lowband components, and a region LH and region LL obtained by further dividing lowband components each into highband components and lowband components.

Subsequently, at the division level=2, the lowband component coefficient data generated at the division level=1 is subjected to filter processing regarding each of the horizontal direction and vertical direction. That is to say, at the division level=2, the region LL formed by being divided at the division level=1 is further divided into four regions, a region HH, region HL, region LH, and region LL are formed within the region LL.

The wavelet transformation unit 210 is configured so as to perform filter processing according to wavelet transformation in a stepwise manner by dividing the filter processing into processing in increments of several lines regarding the vertical direction of the screen, i.e., dividing into multiple times. With the example shown in FIG. 7, at first processing equivalent to processing from the first line on the screen, seven lines are subjected to filter processing, and at second processing and thereafter equivalent to processing from the eighth line, filter processing is performed every four lines. The number of lines is based on the number of lines necessary for generating one line worth of the lowest band components after the region is divided into two of highband components and lowband components.

Note that, hereafter, a line group including other sub-bands, which is necessary for generating one line worth of the lowest band components (one line worth of coefficient data of the lowest band component sub-band), will be referred to as a line block (or precinct). Here, a line indicates one row worth of pixel data or coefficient data formed within a picture, field, or each sub-band corresponding to the image data before wavelet transformation. That is to say, a line block (precinct) indicates, with the original image data before wavelet transformation, a pixel data group equivalent to the number of lines necessary for generating one line worth of the lowest band component sub-band coefficient data after wavelet transformation, or a coefficient data group of each sub-band obtained by subjecting the pixel data group thereof to wavelet transformation.

According to FIG. 7, a coefficient C5 obtained as a filter processing result at the division level=2 is calculated based on a coefficient C4 and a coefficient Cₐ stored in the midway calculation buffer unit 211, and a coefficient C4 is calculated based on the coefficient Cₐ, coefficient C_{b}, and coefficient C_{c} stored in the midway calculation buffer unit 211. Further, the coefficient C_{c} is calculated based on the coefficient C2 and coefficient C3 stored in the coefficient rearranging buffer unit 212, and the pixel data of the fifth line. Also, the coefficient C3 is calculated based on the pixel data of the fifth through seventh lines. Thus, in order to obtain the coefficient C5 which is a lowband component at the division level=2, the pixel data of the first through seventh lines is needed.

On the other hand, with the second filter processing and on, the coefficient data already calculated at the filter processing so far and stored in the coefficient rearranging buffer unit 212 can be employed, so necessary number of lines can be suppressed to be less.

That is to say, according to FIG. 7, of the lowband component coefficients obtained as filter processing results at the division level=2, a coefficient C9, which is the next coefficient of the coefficient C5, is calculated based on the coefficient C4 and coefficient C8, and the coefficient C_{c} stored in the midway calculation buffer unit 211. The coefficient C4 has been already calculated at the above-mentioned first filter processing, and stored in the coefficient rearranging buffer unit 212. Similarly, the coefficient C_{c} has been already calculated at the above-mentioned first filter processing, and stored in the midway calculation buffer unit 211. Accordingly, with the second filter processing, only the filter processing to calculate the coefficient C8 is newly performed. This new filter processing is performed further using the eighth line through eleventh line.

Thus, with the second filter processing and on, the data calculated at the filter processing so far and stored in the midway calculation buffer unit 211 and coefficient rearranging buffer unit 212 can be employed, whereby each processing can be suppressed to processing every four lines.

Note that in a case wherein the number of lines on the screen is not identical to the number of lines for encoding, the lines of the original image data are copied using a predetermined method so as to match the number of lines for encoding, thereby performing filter processing.

Thus, the filter processing whereby one line worth of the lowest band component coefficient data can be obtained is performed in a stepwise manner by being divided into multiple times (in increments of line blocks) as to the lines of the entire screen, whereby a decoded image can be obtained with low delay at the time of sending encoded data.

In order to perform wavelet transformation, a first buffer employed for executing wavelet transformation itself, and a second buffer for storing coefficients generated until a predetermined division level is obtained are needed. The first buffer corresponds to the midway calculation buffer unit 211, and the data surrounded with the dotted lines in FIG. 7 is temporarily stored therein. Also, the second buffer corresponds to the coefficient rearranging buffer unit 212, and the data surrounded with the single dot broken lines in FIG. 7 is temporarily stored therein. The coefficients stored in the second buffer are employed at the time of decoding, so these are to be subjected to entropy encoding processing of the subsequent stage.

The processing of the coefficient rearranging unit 213 will be described. As described above, the coefficient data calculated at the wavelet transformation unit 210 is stored in the coefficient rearranging buffer unit 212, the order thereof is rearranged by the coefficient rearranging unit 213, and the rearranged coefficient data is read out and sent to the quantization unit 214.

As already described above, with wavelet transformation, coefficients are generated from the highband component side to the lowband component side. In the example in FIG. 7, at the first time, the highband component coefficient C1, coefficient C2, and coefficient C3 are sequentially generated at the division level=1 filter processing, from the pixel data of the original image. The division level=2 filter processing is then performed as to the lowband component coefficient data obtained at the division level=1 filter processing, whereby lowband component coefficient C4 and coefficient C5 are sequentially generated. That is to say, the first time, coefficient data is generated in the order of coefficient C1, coefficient C2, coefficient C3, coefficient C4, and coefficient C5. The generating order of the coefficient data is always in this order (the order from highband to lowband) based on the principle of wavelet transformation.

Conversely, on the decoding side, in order to immediately decode with low delay, generating and outputting an image from lowband components is necessary. Therefore, rearranging the coefficient data generated on the encoding side from the lowest band component side to the highband component side and supplying this to the decoding side is desirable.

Further detailed description will be given with reference to FIG. 7. The right side of FIG. 7 shows a synthesis filter side performing wavelet inverse transformation. The first-time synthesizing processing (wavelet inverse transformation processing) including the first line of output image data on the decoding side is performed employing the lowest band component coefficient C4 and coefficient C5, and coefficient C1, generated at the first-time filter processing on the encoding side.

That is to say, with the first-time synthesizing processing, coefficient data is supplied from the encoding side to the decoding side in the order of coefficient C5, coefficient C4, and coefficient C1, whereby on the decoding side, synthesizing processing as to the coefficient C5 and coefficient C4 are performed to generate the coefficient C_{f}, by synthesizing level=2 processing which is synthesizing processing corresponding to the division level=2, and stores the coefficient C_{f} in the buffer. Synthesizing processing as to the coefficient C_{f} and the coefficient C1 is then performed with the synthesizing level=1 processing which is synthesizing processing corresponding to the division level=1, whereby the first line is output.

Thus, with the first-time synthesizing processing, the coefficient data generated on the encoding side in the order of coefficient C1, coefficient C2, coefficient C3, coefficient C4, and coefficient C5 and stored in the coefficient rearranging buffer unit 212 is rearranged to the order of coefficient C5, coefficient C4, coefficient C1, and so forth, and supplied to the decoding side.

Note that with the synthesis filter side shown on the right side of FIG. 7, the coefficients supplied from the encoding side are referenced with a number of the coefficient on the encoding side in parentheses, and shows the line number of the synthesis filter outside the parentheses. For example, coefficient C1 (5) shows that on the analysis filter side on the left side of FIG. 7 this is coefficient C5, and on the synthesis filter side is on the first line.

The synthesizing processing at the decoding side by the coefficient data generated with the second-time filter processing and thereafter on the encoding side can be performed employing coefficient data supplied from the synthesizing in the event of synthesizing processing from the previous time or from the encoding side. In the example in FIG. 7, the second-time synthesizing processing on the decoding side which is performed employing the lowband component coefficient C8 and coefficient C9 generated with the second-time filter processing on the encoding side further requires coefficient C2 and coefficient C3 generated at the first-time filter processing on the encoding side, and the second line through the fifth line are decoded.

That is to say, with the second-time synthesizing processing, coefficient data is supplied from the encoding side to the decoding side in the order of coefficient C9, coefficient C8, coefficient C2, coefficient C3. On the decoding side, with the synthesizing level=2 processing, a coefficient C_{g} is generated employing coefficient C8 and coefficient C9, and coefficient C4 supplied from the encoding side at the first-time synthesizing processing, and the coefficient C_{g} is stored in the buffer. A coefficient Cₕ is generated employing the coefficient C_{g} and the above-described coefficient C4, and coefficient C_{f} generated by the first-time synthesizing process and stored in the buffer, and the coefficient Cₕ is stored in the buffer.

With the synthesizing level=1 processing, synthesizing processing is performed employing the coefficient C_{g} and coefficient Cₕ generated at the synthesizing level=2 processing and stored in the buffer, the coefficient C2 supplied from the encoding side (shown as coefficient C6 (2) with the synthesis filter), and coefficient C3 (shown as coefficient C7 (3) with the synthesis filter), and the second line through fifth line are decoded.

Thus, with the second-time synthesizing processing, the coefficient data generated on the encoding side in the order of coefficient C2, coefficient C3, (coefficient C4, coefficient C5), coefficient C6, coefficient C7, coefficient C8, coefficient C9 is rearranged and supplied to the decoding side in the order of coefficient C9, coefficient C8, coefficient C2, coefficient C3, and so forth.

Thus, with the third synthesizing processing and thereafter as well, similarly, the coefficient data stored in the coefficient rearranging buffer unit 212 is rearranged in a predetermined order and supplied to the decoding unit, wherein the lines are decoded in four-line increments.

Note that with the synthesizing processing on the decoding side corresponding to the filter processing including the lines at the bottom end of the screen on the encoding side (hereafter called the last time), the coefficient data generated in the processing up to then and stored in the buffer are all to be output, so the number of output lines increases. With the example in FIG. 7, eight lines are output during the last time.

Note that the rearranging processing of coefficient data by the coefficient rearranging unit 213 sets the readout addresses in the event of reading the coefficient data stored in the coefficient rearranging buffer unit 212, for example, into a predetermined order.

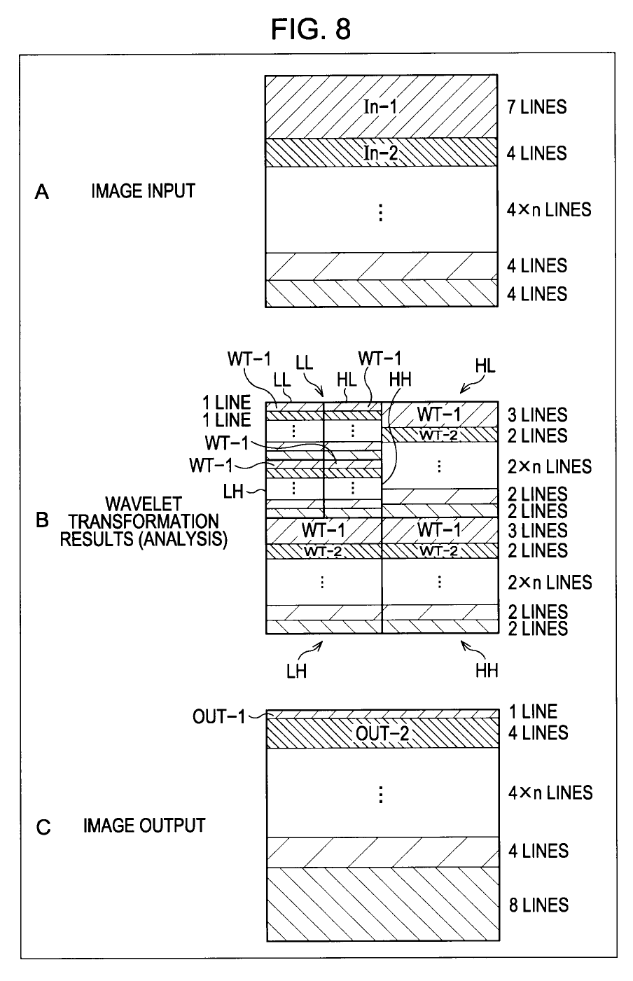

The above processing will be described in further details with reference to FIG. 8. FIG. 8 is an example of performing filter processing by wavelet transformation up to the division level=2, employing a 5×3 filter. With the wavelet transforming unit 210, as one example is shown in A in FIG. 8, the first-time filter processing is performed on the first line through the seventh line of the input image data in each of the horizontal and vertical directions (In-1 in A in FIG. 8).

With the division level=1 processing of the first-time filter processing, the coefficient data for three lines worth of the coefficient C1, coefficient C2, and coefficient C3 is generated, and as one example shown in B in FIG. 8, are each disposed in the region HH, region HL, and region LH formed with the division level=1 (WT-1 in B in FIG. 8).

Also, the region LL formed with the division level=1 is further divided into four with the filter processing in the horizontal and vertical directions by the division level=2. With the coefficient C5 and coefficient C4 generated with the division level=2, one line is disposed in the region LL by the coefficient C5 by the division level=1, and one line is disposed in each of the region HH, region HL, and region LH, by the coefficient C4.

With the second-time filter processing and thereafter by the wavelet transformation unit 210, filter processing is performed in increments of four lines (In-2 . . . in A in FIG. 8), coefficient data is generated in increments of two lines at the division level=1 (WT-2 in B in FIG. 8) and coefficient data is generated in increments of one line at the division level=2.

With the example of the second time in FIG. 7, coefficient data worth two lines of the coefficient C6 and coefficient C7 is generated at the division level=1 filter processing, and as one example is shown in B in FIG. 8, is disposed following the coefficient data which is generated at the first-time filter processing of the region HH, region HL, and region LH formed with the division level=1. Similarly, within the region LL by the division level=1, the coefficient C9 worth one line generated with the division level=2 filter processing is disposed in the region LL, and the coefficient C8 worth one line is disposed in each of region HH, region HL, and region LH.

In the event of decoding the data subjected to wavelet transformation as in B in FIG. 8, as one example is shown in FIG. 8C, the first line by the first-time synthesizing processing on the decoding side is output (Out-1 in C in FIG. 8) corresponding to the first-time filter processing by the first line through the seventh line on the encoding side. Thereafter, four lines at a time are output on the decoding side (Out-2 . . . in C in FIG. 8) corresponding to the filter processing from the second time until before the last time on the encoding side. Eight lines are output on the decoding side corresponding to the filter processing for the last time on the encoding side.

The coefficient data generated by the wavelet transformation unit 210 from the highband component side to the lowband component side is sequentially stored in the coefficient rearranging buffer unit 212. With the coefficient rearranging unit 213, when coefficient data is accumulated in the coefficient rearranging buffer unit 212 until the above-described coefficient data rearranging can be performed, the coefficient data is rearranged in the necessary order for synthesizing processing and read from the coefficient rearranging buffer unit 212. The read out coefficient data is sequentially supplied to the quantization unit 214.

The quantization unit 214 subjects the coefficient data supplied from the coefficient rearranging unit 213 to quantization. Any kind of method may be employed as this quantizing method, for example, a common method, i.e., such as shown in the following Expression (3), a method for dividing coefficient data W by a quantization step size Δ may be employed.

Quantization coefficient=W/Δ (3)

The entropy encoding unit 215 controls encoding operations so that the bit-rate of the output data becomes a target bit-rate based on control signals supplied from the rate control unit 216 as to the coefficient data thus quantized and supplied and subjects this to entropy encoding. The encoded data subjected to entropy encoding is supplied to the decoding side. As for an encoding method, Huffman encoding or arithmetic encoding or the like which are known techniques can be conceived. It goes without saying that the encoding method is not restricted to these, as long as reversible encoding processing can be performed, other encoding methods may be employed.

As described with reference to FIG. 7 and FIG. 8, the wavelet transformation unit 210 performs wavelet transformation processing in increments of multiple lines (in increments of line blocks) of image data. The encoded data encoded with the entropy encoding unit 215 is output in increments of line blocks. That is to say, in the case of performing processing up to the division level=2 employing a 5×3 filter as described above, for the output of one screen of data, output is obtained as one line for the first time, four lines each for the second time through the next to last time, and eight lines are output on the last time.

Note that in the case of subjecting the coefficient data after rearranging with the coefficient rearranging unit 213 to entropy encoding, for example in the event of performing entropy encoding on the line of the first coefficient C5 with the first-time filter processing shown in FIG. 7 for example, there is no historical line, i.e. there is no line where coefficient data has already been generated. Accordingly in this case, only the one line is subjected to entropy encoding. Conversely, in the event of encoding the line of the coefficient C1, the lines of the coefficient C5 and coefficient C4 become historical lines. These multiple lines nearing one another can be considered to be configured with similar data, thus subjecting the multiple lines to entropy encoding together is effective.

Also, as described above, with the wavelet transformation unit 210, an example for performing filter processing with wavelet transformation employing a 5×3 filter has been described, but should not be limited to this example. For example with the wavelet transformation unit 210, a filter with an even longer tap number such as a 9×7 filter may be used. In this case, if the tap number of the filter is longer the number of lines accumulated in the filter also increases, so the delay time from input of the image data until output of the encoded data becomes longer.

Also, with the above description, the division level of the wavelet transformation has been described as division level=2 for the sake of description, but should not be limited to this, and division levels can be further increased. The more the division level is increased, the better a high compression rate can be realized. For example, in general, with wavelet transformation, filter processing of up to division level=4 is repeated. Note that as the division level increases, the delay time also increases greatly.

Accordingly, in the event of applying the present invention to an actual system, determining the filter tap number or the division level according to the delay time or picture quality of the decoded image required by the system, is desirable. The filter tap number or division level does not need to be a fixed value, but can be selectable appropriately as well.

The coefficient data subjected to wavelet transformation and rearranged as described above is quantized with the quantizing unit 214 and encoded with the entropy encoding unit 215. The obtained encoded data is then transmitted to the camera control unit 112 via the digital modulation unit 122, amplifier 124, video splitting/synthesizing unit 126, and so forth. At this time, the encoded data is packetized at the packetizing unit 217, and transmitted as packets.

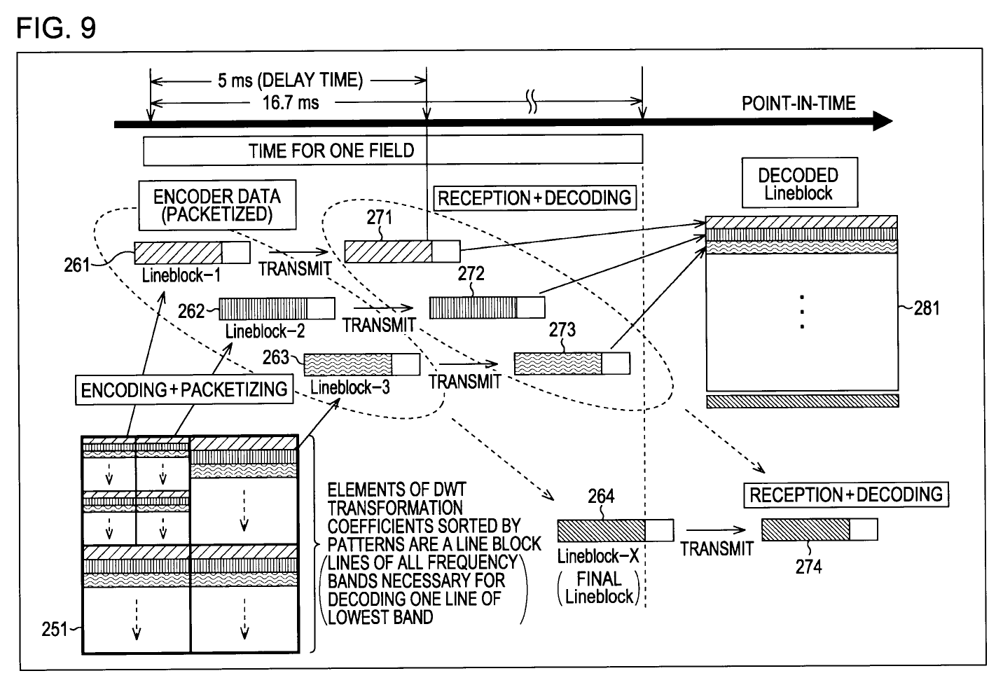

FIG. 9 is a schematic diagram for describing an example of how the encoded data is exchanged. As described above, the image data is subjected to wavelet transformation while being input in increments of line blocks, for a predetermined number of lines worth (sub-band 251). At the time of reaching the predetermined wavelet transformation division level, the coefficient lines from the lowest band sub-band to the highest band sub-band are rearranged in an inverse order from the order when they were generated, i.e. in the order from lowband to highband.

With the sub-band 251 in FIG. 9, the portions divided out by the patterns of diagonal lines, vertical lines, and wavy lines are each different line blocks (as shown by the arrows, the white space in the sub-band 251 is also divided in increments of line blocks and processed, in the same way). The coefficients of line blocks after rearranging are subjected to entropy encoding as described above, and encoded data is generated.

Here, if the transmission unit 110 transmits the encoded data as is, for example, there are cases wherein camera control unit 112 has difficulty identifying the boundaries of the various line blocks (or complicated processing may be required). With an arrangement wherein the packetizing unit 217 attaches a header to the encoded data in increments of line blocks for example, generates a packet formed of a header of encoded data, and transmits the packet, whereby processing relating to exchange of data can be made simpler.

As shown in FIG. 9, upon generating encoded data (encode data) of the first line block (Lineblock-1), the transmission unit 110 packetizes this, and sends this out to the camera control unit 112 as a transmission packet 261. Upon the camera control unit 112 receiving the packet (reception packet 271), the packet is de-packetized and the encoded data thereof is extracted, and the encoded data is decoded (decode).

In the same way, upon generating encoded data of the second line block (Lineblock-2), the transmission unit 110 packetizes this, and sends this out to the camera control unit 112 as a transmission packet 262. Upon the camera control unit 112 receiving the packet (reception packet 272), the encoded data is decoded (decode). Further in the same way, upon generating encoded data of the third line block (Lineblock-3), the transmission unit 110 packetizes this, and sends this out to the camera control unit 112 as a transmission packet 263. Upon the camera control unit 112 receiving the packet (reception packet 273), the encoded data is decoded (decode).

The transmission unit 110 and camera control unit 112 repeat processing such as above until the X'th final line block (Lineblock-X) (transmission packet 264, reception packet 274). Thus a decoded image 281 is generated at the camera control unit 112.

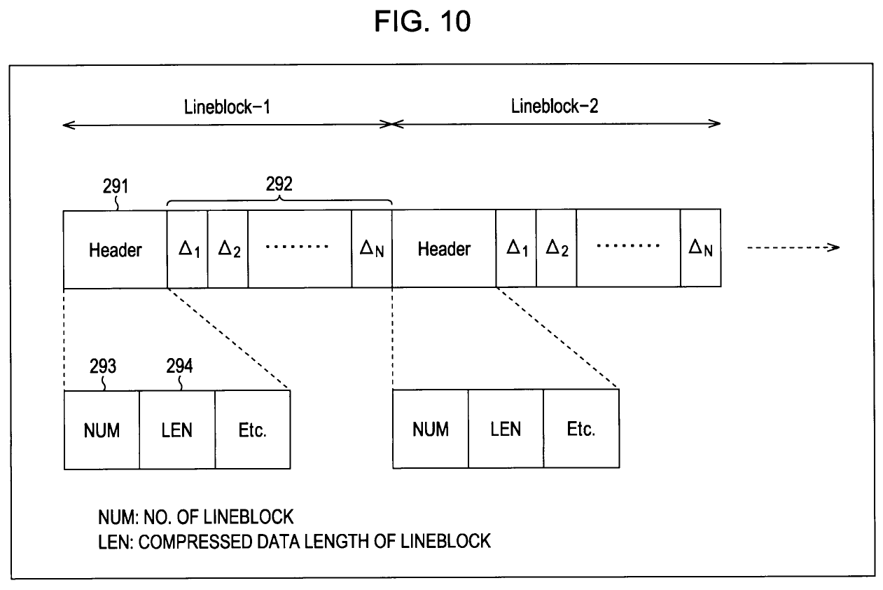

FIG. 10 illustrates a configuration example of a header. As described above, the packet comprises a header (Header) 291 and encoded data, the Header 291 including descriptions of a line block number (NUM) 293 and encoded data length (LEN) 294 indicating code amount in increments of sub-bands configuring the line block. Further, a description of a quantization step size (Δ1 through ΔN) 292 in increments of sub-bands configuring the line block is added as information relating to encoding (encoding information).

The camera control unit 112 which receives the packet can easily identify the boundary of each line block by reading the information included in the header added to the received encoded data, and can reduce the load of decoding processing and processing time. Also, by reading the encoding information, the camera control unit 112 can perform inverse quantization in increments of sub-bands, and is able to perform further detailed image quality control.

Also, the transmission unit 110 and camera control unit 112 may be arranged to concurrently (in pipeline fashion) execute the various processes of encoding, packetizing, exchange of packets, and decoding, in increments of line blocks.

Thus, the delay time until the image output is obtained at the camera control unit 112 can be greatly reduced. As an example, FIG. 9 shows an operation example with interlaced motion images (60 fields/sec). With this example, the time for one field is 1 second÷60=approximately 16.7 msec, but by concurrently performing the various processing, the image output can be arranged to be obtained with a delay time of approximately 5 msec.

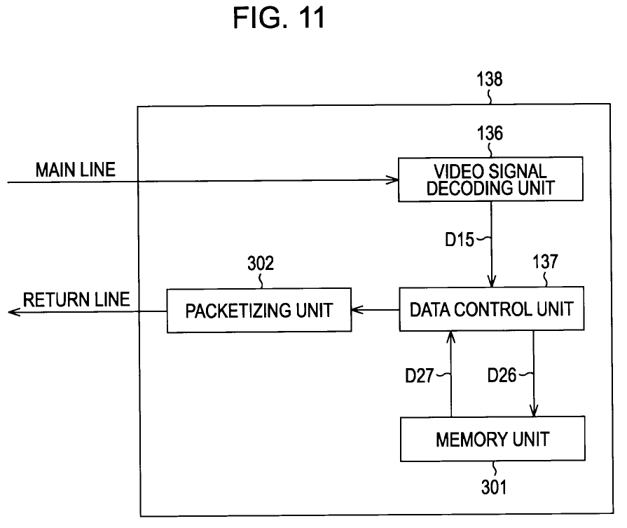

Next, description will be made regarding the data converting unit 138 in FIG. 3. FIG. 11 is a block diagram illustrating a detailed configuration example of the data converting unit 138.

The data converting unit 138 has the video signal decoding unit 136 and data control unit 137, as described above. Further, as shown in FIG. 11, the data converting unit 138 has a memory unit 301 and packetizing unit 302.

The memory unit 301 has a rewritable storage medium such as RAM (Random Access Memory), and stores information supplied from the data control unit 137, and supplies stored information to the data control unit 137 based on requests from the data control unit 137.

The packetizing unit 302 packetizes return encoded data supplied from the data control unit 137, and supplies the packets thereof to the digital modulation unit 135. The configuration and operations of this packetizing unit 302 is basically the same as the packetizing unit 217 shown in FIG. 4.

Upon obtaining packets of encoded data supplied from the digital demodulation unit 134, the video signal decoding unit 136 performs de-packetizing, and extracts encoded data. The video signal decoding unit 136 performs decoding processing of that encoded data, and also supplies encoded data before the decoding processing to the data control unit 137 via a bus D15. The data control unit 137 controls the bit rate of the return encoded data by supplying the encoded data to the memory unit 301 via the bus D26 and accumulating, or by obtaining via a bus D27 the encoded data accumulated in the memory unit 301 and supplying to the packetizing unit 302 as return data, or the like.

While the details of processing relating to this bit rate conversion will be described later, the data control unit 137 temporarily accumulates the encoded data supplied in order form the lowband component in the memory unit 301, and at the stage of reaching a predetermined data amount, reads out part or all of the encoded data accumulated in that memory unit 301, and supplies to the packetizing unit 302 as return encoded data. That is to say, the data control unit 137 uses the memory unit 301 to extract and output a part from the supplied encoded data, and discards the rest, thereby lowering (changing) the bit rate of the encoded data. Note that in the event that the bit rate is not to be changed, the data control unit 137 outputs the entirety of the supplied encoded data.

The packetizing unit 302 packetizes the encoded data supplied from the data control unit 137 every predetermined size, and supplies to the digital modulation unit 135. At this time, the information relating to the header of the encoded data is supplied from the video signal decoding unit 136 performing de-packetizing. The packetizing unit 302 performs packetizing wherein the information relating to the header that has been supplied is suitably correlated with the bit rate conversion processing contents performed at the data control unit 137.

Note that while the above has been described with two systems of busses that are mutually independent, with the bus D26 used at the time of supplying encoded data from the data control unit 137 to the memory unit 301, and the bus D27 used at the time of supplying encoded data read out from the memory unit 301 to the data control unit 137, an arrangement may be made wherein the exchange of the encoded data is performed with one system of bus which can transmit in both directions.

Also, data other than encoded data, such as variables which the data control unit 137 uses for bit rate conversion, for example, may also be saved in the memory unit 301.

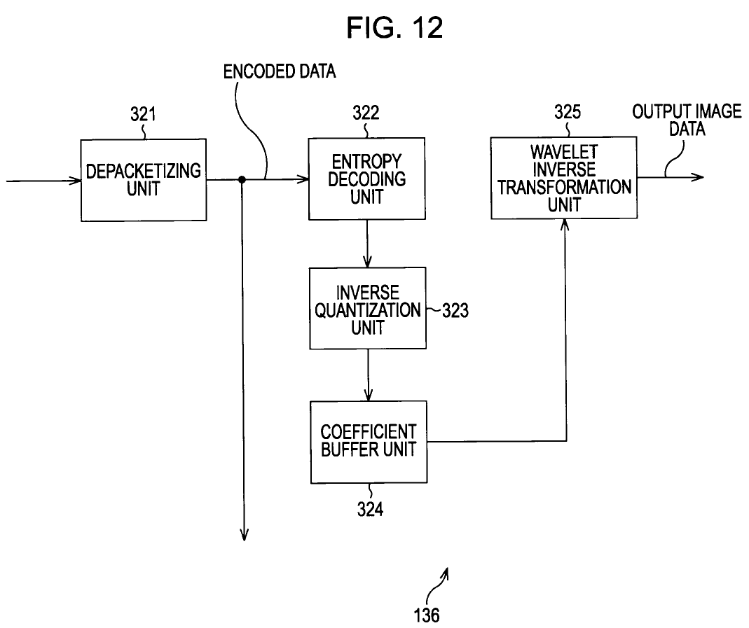

FIG. 12 is a block diagram illustrating a configuration example of the video signal decoding unit 136. The video signal decoding unit 136 is a decoding unit corresponding to the video signal encoding unit 120, and as shown in FIG. 12, has a de-packetizing unit 321, entropy decoding unit 322, inverse quantization unit 323, coefficient buffer unit 324, and wavelet inverse transformation unit 325.

The packets of encoded data output from the packetizing unit 217 of the video signal encoding unit 120 are supplied to the de-packetizing unit 321 of the video signal decoding unit 136, via various types of processing. The de-packetizing unit 321 de-packetizes the supplied packets, and extracts encoded data. The de-packetizing unit 321 supplies the encoded data to the entropy decoding unit 322, and also supplies to the data control unit 137.

Upon obtaining the encoded data, the entropy decoding unit 322 performs entropy decoding of the encoded data for each line, and supplies the obtained coefficient data to the inverse quantization unit 323. The inverse quantization unit 323 subjects the supplied coefficient data to inverse quantization based on information relating to quantization obtained from the de-packetizing unit 321, supplies the obtained coefficient data to the coefficient buffer unit 324, and stores. The wavelet inverse transformation unit 325 performs synthesis filter processing by synthesis filtering, using the coefficient data stored in the coefficient buffer unit 324, and stores the results of the synthesis filtering processing in the coefficient buffer unit 324 again. The wavelet inverse transformation unit 325 repeats this processing in accordance with the division level, and obtains decoded image data (output image data). The wavelet inverse transformation unit 325 outputs this output image data externally from the video signal decoding unit 136.

In the case of a general wavelet inverse transformation method, first, horizontal synthesis filtering has been performed in the horizontal direction of the screen on all coefficients of the division level to be processed, and next, vertical synthesis filtering has been performed in the vertical direction of the screen. That is to say, there is the need to hold the result of synthesis filtering processing in the buffer each time each synthesis filtering is performed, and at this time, the buffer needs to hold the results of the synthesis filtering of the division level at that point, and all coefficients of the next division level, meaning that a great memory capacity is required (the amount of data to be held is great).

Also, in this case, no image data output is performed until all wavelet inverse transformation is performed within the picture (field, in the case of interlaced method), so the delay time from input to output increases.

Conversely, with the case of the wavelet inverse transformation unit 325, the vertical synthesis filtering processing and horizontal synthesis filtering processing are continuously performed to level 1 in increments of line blocks, so the amount of data which needs to be buffered at once (at the same time) is small as compared to the conventional method, and the amount of memory of the buffer to be prepared can be markedly reduced. Also, by performing synthesis filtering processing (wavelet inverse transformation) to level 1, the image data can be sequentially output before the entire image data within the picture is obtained (in increments of line blocks), so the delay time can be markedly reduced in comparison with the conventional method.

Note that the video signal decoding unit 121 of the transmission unit 110 (FIG. 3) also has basically the same configuration as this video signal decoding unit 136, and executes similar processing. Accordingly, the description described above with reference to FIG. 12 can basically be applied also to the video signal decoding unit 121. However, in the case of the video signal decoding unit 121, output from the de-packetizing unit 321 is only supplied to the entropy decoding unit 322, and no supply to the data control unit 137 is performed.

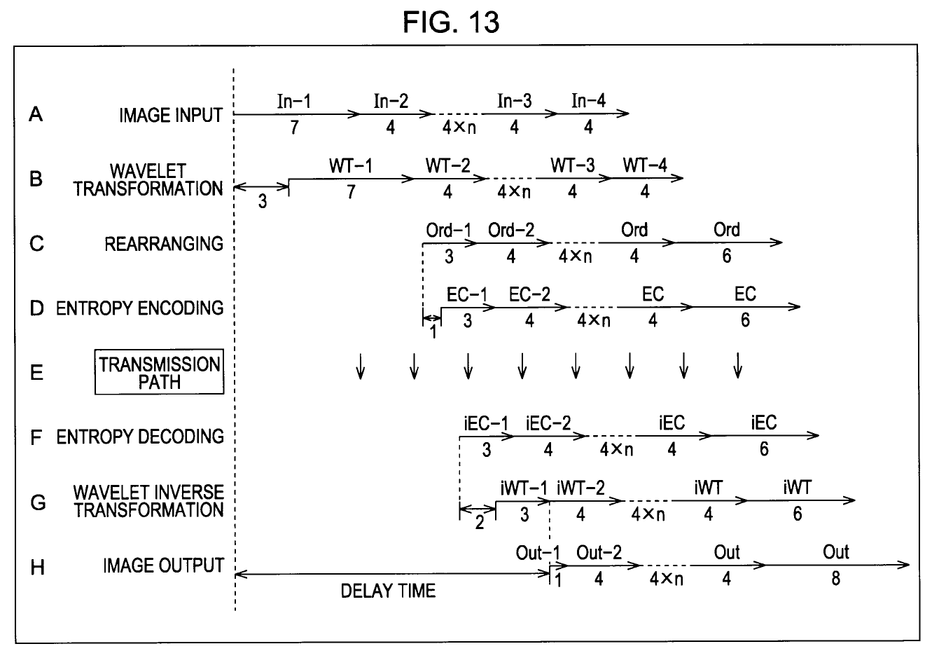

The various processes executed by the components shown in FIG. 3 as above are executed in parallel as appropriate, as shown in FIG. 13 for example.

FIG. 13 is a drawing schematically showing an example of parallel operations for various elements of the processing executed by the portions shown in FIG. 3. This FIG. 13 corresponds to the above-described FIG. 8. Wavelet transformation WT-1 at the first time is performed (B in FIG. 13) with the wavelet transformation unit 210 (FIG. 4) as to the input In-1 (A in FIG. 13) of the image data. As described with reference to FIG. 7, the wavelet transformation WT-1 at the first time is started at the point-in-time that the first three lines are input, and the coefficient C1 is generated. That is to say, a delay of three lines worth occurs from the input of the image data In-1 to the start of the wavelet transformation WT-1.

The generated coefficient data is stored in the coefficient rearranging buffer unit 212 (FIG. 4). Thereafter, wavelet transformation is performed as to the input image data and the processing at the first time is finished, whereby the processing is transferred without change to the wavelet transformation WT-2 at the second time.

Rearranging Ord-1 of three, coefficient C1, coefficient C4, and coefficient C5 is executed (C in FIG. 13) with the coefficient rearranging unit 213 (FIG. 4) in parallel with the input of image data In-2 for the purpose of wavelet transformation WT-2 at the second time and the processing of the wavelet transformation WT-2 at the second time.

Note that a delay from the end of the wavelet transformation WT-1 until the rearranging Ord-1 starts is a delay based on a device or system configuration, and is a delay associated with the transmission of a control signal to instruct rearranging processing to the coefficient rearranging unit 213, a delay needed for processing starting of the coefficient rearranging unit 213 as to the control signal, or a delay needed for program processing, for example, and is not an substantive delay associated with encoding processing.

The coefficient data is read from the coefficient rearranging buffer unit 212 in the order that rearranging is finished, is supplied to the entropy encoding unit 215 (FIG. 4), and is subjected to entropy encoding EC-1 (D in FIG. 13). The entropy encoding EC-1 can be started without waiting for the end of all rearranging of the three coefficient C1, coefficient C4, and coefficient C5. For example, at the point-in-time that the rearranging of one line by the coefficient C5 output at first is ended, entropy encoding as to the coefficient C5 can be started. In this case, the delay from the processing start of the rearranging Ord-1 to the processing start of the entropy encoding EC-1 is one line worth.

The encoded data regarding which entropy encoding EC-1 by the entropy encoding unit 215 has ended is subjected to predetermined signal processing, and then transmitted to the camera control unit 112 via the triax cable 111 (E in FIG. 13). At this time, the encoded data is packetized and transmitted.

Image data is sequentially input to the video signal encoding unit 120 of the transmission unit 110, following the seven lines worth of image data input at the first processing, on to the end line of the screen. At the video signal encoding unit 120, every four lines are subjected to wavelet transformation WT-n, reordering Ord-n, and entropy encoding EC-n, as described above, in accordance with image data input In-n (where n is 2 or greater). Reordering Ord and entropy encoding EC performed as to the processing of the last time at the video signal encoding unit 120 is performed on six lines. These processes are performed at the video signal encoding unit 120 in parallel, as illustrated exemplarily in A through D in FIG. 13.

Packets of encoded data encoded by the entropy encoding EC-1 by the video signal encoding unit 120 are transmitted to the camera control unit 112, subjected to predetermined signal processing and supplied to the video signal decoding unit 136. The de-packetizing unit 321 extracts the encoded data from the packets, and thereupon supplies this to the entropy decoding unit 322. The entropy decoding unit 322 sequentially performs decoding iEC-1 of entropy encoding as to the encoded data which is encoded with the entropy encoding EC-1, and restores the coefficient data (F in FIG. 13). The restored coefficient data is subjected to inverse quantization at the inverse quantization unit 323, and then sequentially stored in the coefficient buffer unit 324. Upon as much coefficient data as can be subjected to wavelet inverse transformation being stored in the coefficient buffer unit 324, the wavelet inverse transformation unit 325 reads the coefficient data from the coefficient buffer unit 324, and performs wavelet inverse transformation iWT-1 using the read coefficient data (G in FIG. 13).

As described with reference to FIG. 7, the wavelet inverse transformation iWT-1 at the wavelet inverse transformation unit 325 can be started at the point-in-time of the coefficient C4 and coefficient C5 being stored in the coefficient buffer unit 324. Accordingly, the delay from the start of decoding iEC-1 with the entropy decoding unit 322 to the start of the wavelet inverse transformation iWT-1 with the wavelet inverse transformation unit 325 is two lines worth.

With the wavelet inverse transformation unit 325, upon the wavelet inverse transformation iWT-1 of three lines worth with the wavelet transformation at the first time ending, output Out-1 of the image data generated with the wavelet inverse transformation iWT-1 is performed (H in FIG. 13). With the output Out-1, as described with reference to FIG. 7 and FIG. 8, the image data of the first line is output.

Following the input of the encoded coefficient data worth three lines with the processing at the first time by the video signal encoding unit 120 to the video signal decoding unit 136, the coefficient data encoded with the entropy encoding EC-n (n is 2 or greater) is sequentially input. With the video signal decoding unit 136, the input coefficient data is subjected to entropy decoding iEC-n and wavelet inverse transformation iWT-n for every four lines, as described above, and output Out-n of the image data restored with the wavelet inverse transformation iWT-n is sequentially performed. The entropy decoding iEC and wavelet inverse transformation iWT corresponding to the last time with the video signal encoding unit 120 is performed as to six lines, and eight lines of output Out are output. This processing is performed in parallel as exemplified in F in FIG. 13 through H in FIG. 13 at the video signal decoding unit 136.

As described above, by performing each processing in parallel at the video signal encoding unit 120 and the video signal decoding unit 136, in order from the top of the image toward the bottom thereof, image compression processing and image decoding processing can be performed with little delay.

With reference to FIG. 13, the delay time from the image input to the image output in the case of performing wavelet transformation to division level=2 using a 5×3 filter will be calculated. The delay time from inputting the image data of the first line into the video signal encoding unit 120 until the image data of the first line is output from the video signal decoding unit 136 becomes the sum of the various elements described below. Note that delays differing based on the system configuration, such as delay in the transmission path and delay associated with actual processing timing of the various portions of the device, are excluded.

(1) Delay D_WT from the first line input until the wavelet transformation WT-1 worth seven lines ends

(2) Time D_Ord associated with three lines worth of coefficient rearranging Ord-1

(3) Time D_EC associated with three lines worth of entropy encoding EC-1

(4) Time D_iEC associated with three lines worth of entropy decoding iEC-1

(5) Time D_iWT associated with three lines worth of wavelet inverse transformation iWT-1

Delay due to the various elements described above will be calculated with reference to FIG. 13. The delay D_WT in (1) is ten lines worth of time. The time D_Ord in (2), time D_EC in (3), time D_iEC in (4), and time D_iWT in (5) are each three lines worth of time. Also, with the video signal encoding unit 120, the entropy encoding EC-1 can be started after one line from the start of the rearranging Ord-1. Similarly, with the video signal decoding unit 136, the wavelet inverse transformation iWT-1 can be started after two lines from the start of entropy decoding iEC-1. Also, the entropy decoding iEC-1 can start processing at the point-in-time of one line worth of encoding with the entropy encoding EC-1 being finished.

Accordingly, with the example in FIG. 13, the delay time from the image data of the first line input into the video signal encoding unit 120 until the image data of the first line output from the video signal decoding unit 136 becomes 10+1+1+2+3=17 lines worth.

The delay time will be considered with a more specific example. In the case that the input image data is an interlace video signal of an HDTV (High Definition Television), for example one frame is made up of a resolution of 1920 pixels×1080 lines, and one field is 1920 pixels×540 lines. Accordingly, in the case that the frame frequency is 30 Hz, the 540 lines of one field is input to the video signal encoding unit 120 in the time of 16.67 msec (=1 sec/60 fields).

Accordingly, the delay time associated with the input of seven lines worth of image data is 0.216 msec (=16.67 msec×7/540 lines), and becomes a very short time as to the updating time of one field, for example. Also, delay time of the sum total of the above-described delay D_WT in (1), time D_Ord in (2), time D_EC in (3), time D_iEC in (4), and time D_iWT in (5) is significantly shortened, since the number of lines to be processed is small. Hardware-izing the components for performing each processing will enable the processing time to be shortened even further.

Next, the operations of the data control unit 137 will be described.

As described above, the image data is wavelet transformed in increments of line blocks at the video signal encoding unit 120, and following the coefficient data of each sub-band obtained being rearranged in order from lowband to high band, is quantized, encoded, and supplied to the data converting unit 138.

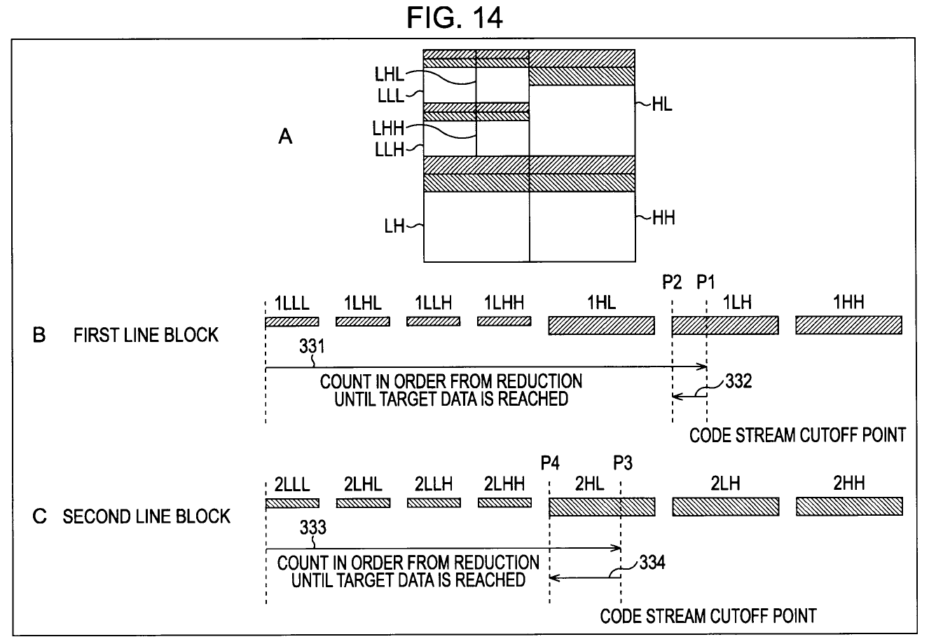

For example, if we say that wavelet transformation wherein division processing is repeated twice as shown in A in FIG. 14 (wavelet transformation in the case of division level=2) is performed at the video signal encoding unit 120, and that the obtained sub-bands are each LLL, LHL, LLH, LHH, HL, LH, HH from the lowband, these sub-band encoded data are supplied to the data converting unit 138 in order from the lowband to highband, for each line block, as shown in B in FIG. 14 and C in FIG. 14. That is to say, de-packetized encoded data is also supplied to the data control unit 137 in a similar order.

B in FIG. 14 and C in FIG. 14 illustrate the order (of sub-bands) of encoded data supplied to the data control unit 137, illustrating being supplied in order from the left. That is to say, first, encoded data of each sub-band of the first line block, which is the topmost line block in the image in the baseband image data, indicated by the hatching from the upper right to the lower left in A in FIG. 14, is supplied to the data control unit 137 in the order from lowband sub-bands to highband sub-bands, as illustrated in B in FIG. 14.

In B in FIG. 14, 1LLL illustrates the sub-band LLL of the first line block, 1LHL illustrates the sub-band LHL of the first line block, 1LLH illustrates the sub-band LLH of the first line block, 1LHH illustrates the sub-band LHH of the first line block, 1HL illustrates the sub-band HL of the first line block, 1LH illustrates the sub-band LH of the first line block, and 1HH illustrates the sub-band HH of the first line block. In this example in B in FIG. 14, first, the encoded data of 1LLL (the encoded data obtained by encoding the coefficient data of 1LLL) is supplied, following which the encoded data of 1LHL, the encoded data of 1LLH, the encoded data of 1LHH, the encoded data of 1HL, and the encoded data of 1LH are supplied in that order, and finally the encoded data of 1HH is supplied.

Upon data of the first line block having all been supplied, next, encoded data of each sub-band of the second line block, which is the line block one below the first line block in the image in the baseband image data, indicated by the hatching from the upper left to the lower right in A in FIG. 14, is supplied to the data control unit 137 in the order from lowband sub-bands to highband sub-bands, as illustrated in C in FIG. 14.

In C in FIG. 14, 2LLL illustrates the sub-band LLL of the second line block, 2LHL illustrates the sub-band LHL of the second line block, 2LLH illustrates the sub-band LLH of the second line block, 2LHH illustrates the sub-band LHH of the second line block, 2HL illustrates the sub-band HL of the second line block, 2LH illustrates the sub-band LH of the second line block, and 2HH illustrates the sub-band HH of the second line block. In this example in C in FIG. 14, the encoded data of each sub-band is supplied in the order of 2LLL (the sub-band LLL of the second line block) 2LHL, 2LLH, 2LHH, 2HL, 2LH, and 2HH, as with the case in B in FIG. 14.

As described above, encoded data is supplied in order from the line block at the top of the image in base band image data, for every line block. That is to say, encoded data for each sub-band of each line block of the third and subsequent line blocks is also supplied in order in the same way as with B in FIG. 14 and C in FIG. 14.

Note that this order for every line block is sufficient to be from lowband to highband, so an arrangement may be made wherein supply is performed in the order of LLL, LLH, LHL, LHH, LH, HL, HH, or may be another order. Also, in cases of division level of 3 or higher as well, supply is made in order from lowband sub-bands to highband sub-bands.

With regard to encoded data supplied in such an order, the data control unit 137 accumulates the encoded data in the memory unit 301 for every line block, while counting the sum of the code amount of the accumulated encoded data, and in the event that the code amount reaches a target value, the encoded data up to the immediately-previous sub-band is read out from the memory unit 301 and supplied to the packetizing unit 302.

Describing with the example of B in FIG. 14 and C in FIG. 14, first, as indicated by arrow 331 in B in FIG. 14, with regard to the encoded data of the first line block, the data control unit 137 accumulates the encoded data in the memory unit 301 in the order supplied, and counts (calculates) the accumulation value of the sum of code amount of the accumulated code data. That is to say, the data control unit 137 adds the code amount of the accumulated code data to the accumulation value, each time encoded data is accumulated in the memory unit 301.

The data control unit 137 accumulates encoded data in the memory unit 301 until the accumulation value reaches the target code amount determined beforehand, and upon the accumulation value reaching the target code amount, ends accumulation of the encoded data, reads the encoded data up to the immediately-preceding sub-band from the memory unit 301, and outputs. This target code amount is set in accordance with the desired bit-rate.

In the case of the example in B in FIG. 14, the data control unit 137 sequentially accumulates the supplied encoded data while counting the code amount thereof as with the arrow 331, and upon being accumulated to a code stream cutoff point P1 where the accumulation value reaches the target code amount, accumulation of encoded data is ended, and as indicated by arrow 332, the encoded data from the encoded data of the leading sub-band to the sub-band immediately-preceding the sub-band being currently accumulated (in the case of B in FIG. 14, 1LLL, 1LHL, 1LLH, 1LHH, and 1HL) is read out and output, and the data from the point P2 which the head of the current sub-band to point P1 (in the case of B in FIG. 14, a part of 1LH) is discarded.

In this way, the reason that the data control unit 137 controls data output in increments of sub-bands is to enable decoding at the video signal decoding unit 121. The entropy encoding unit 215 performs encoding of coefficient data with a method enabling decoding in at least sub-band increments, and the encoded data thereof is configured of a format which can be decoded at the video signal decoding unit 121. Accordingly, the data control unit 137 chooses which to take and which to leave of encoded data in increments of sub-bands, so that this format of the encoded data is not changed.

In the case of wavelet transformation (wavelet inverse transformation) performed in increments of line blocks, even if coefficient data of all sub-bands within the line block is not present, the baseband image data can be restored to a certain extent by performing data supplementation and so forth at the time of wavelet inverse transformation. That is to say, even in a case wherein, in the example in A in FIG. 14, only coefficient data of the lowband sub-bands LLL, LHL, LLH, and LHH exist, and coefficient data of the highband sub-bands HL, LH, and HH do not exist, for example, the lowband sub-bands LLL, LHL, LLH, and LHH can be used to substitute for the highband sub-bands HL, LH, and HH, whereby the image before wavelet transformation can be restored to a certain extent. Note however, in this case, there is no highband component of the image, so the image quality of the restored image will generally deteriorate as compared to the original image (resolution will drop), though this depends on the method of supplementation. However, with wavelet transformation, energy of the image basically concentrates at the lowband components, as described with reference to FIG. 6. Accordingly, the effect of image deterioration due to loss of highband components is small for the user viewing the image.

The data control unit 137 controls the bit rate of the encoded data using the fact that the supplied encoded data has such a nature. That is to say, the data control unit 137 extracts encoded data from the supplied encoded data, in accordance with the supplying order thereof, from the top, until the target code amount is reached, as return encoded data. In the event that the target code amount is smaller than the code amount of the original encoded data, i.e., in the event of the data control unit 137 lowering the bit rate, the return encoded data is configured of lowband components of the original encoded data. In other words, that from which a part of the highband components has been removed from the original encoded data is extracted as return encoded data.

The data control unit 137 performs the above processing on each line block. That is to say, as shown in B in FIG. 14, upon processing ending for the first line block, the data control unit 137 performs processing in the same way on the second line block supplied next as shown in C in FIG. 14, and counts the accumulation value while accumulating the supplied encoded data in the memory unit 301 from the top until reaching the target code amount as indicated by arrow 333, and at the point of reaching the code stream cutoff point P3, the encoded data of the sub-band being currently accumulated (2HL in the case of the example in C in FIG. 14) is discarded as indicated by arrow 334, and encoded data from the top to the immediately-preceding sub-band (2LLL, 2LHL, 2LLH, and 2LHH in the case of the example in C in FIG. 14) is read out from the memory unit 301, and output as return encoded data.

Bit rate conversion processing is performed in the same way, with regard to the third line block which is the next line block after the second line block, and each subsequent line block.

Note that the code amount of each sub-band is independent for every line block, so the positions of the code stream cutoff points (P1 and P3) are also mutually independent, as shown in B in FIG. 14 and C in FIG. 14 (there are cases of being mutually different and case of mutually matching). Accordingly, sub-bands to be discarded (i.e., the positions of point P2 and point P4 in B in FIG. 14 and C in FIG. 14) are also mutually independent.

Note that the target code amount may be a fixed value or may be variable. For example, it can be conceived that in the event that the resolution drastically differs between line blocks within the same image or between frames, difference in image quality thereof is conspicuous (the user viewing the image takes this as image deterioration). In order to suppress such a phenomenon, an arrangement may be made wherein the target code amount (i.e., bit rate) is suitably controlled, based on the contents of the image, for example. Also, an arrangement may be made wherein the target code amount is suitably controlled based on optional external conditions such as, for example, the band of the transmission path of the triax cable 111 or the like, the processing capability and load state at the transmission unit 110 which is the transmission destination, image quality required for a return video picture, and so on.

As described above, the data control unit 137 can create return encoded data of a desired bit rate independent from the bit rate of the supplied encoded data, without decoding the supplied encoded data. Also, the data control unit 137 can perform this bit rate conversion processing with simple processing of extracting and outputting encoded data from the top in the supplied order, so the bit rate of encoded data can be converted easily and at high speed.

That is to say, the data control unit 137 can further shorten the delay time from the main line digital video being supplied to returning of the return digital video signal to the transmission unit 110.

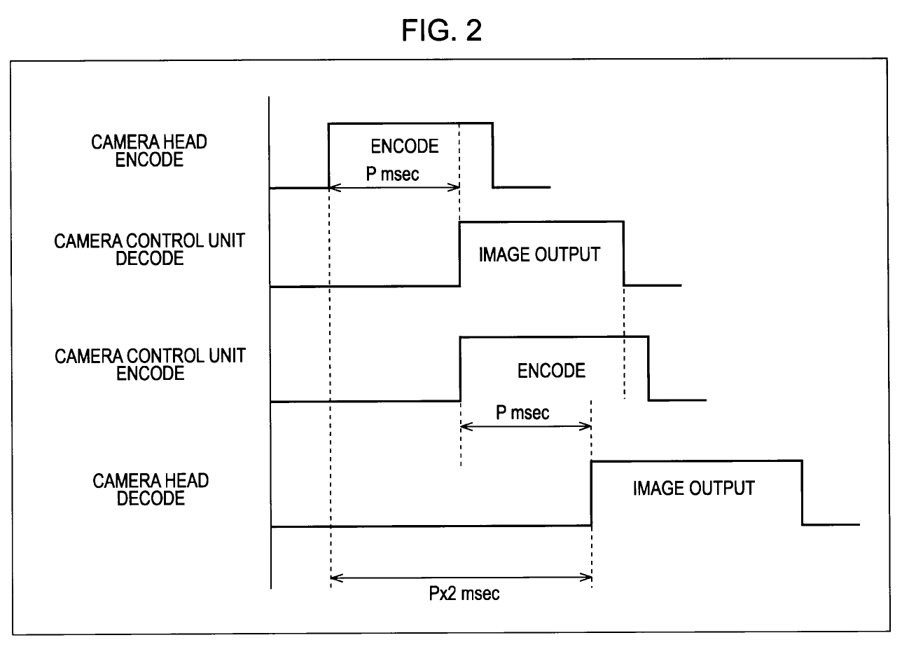

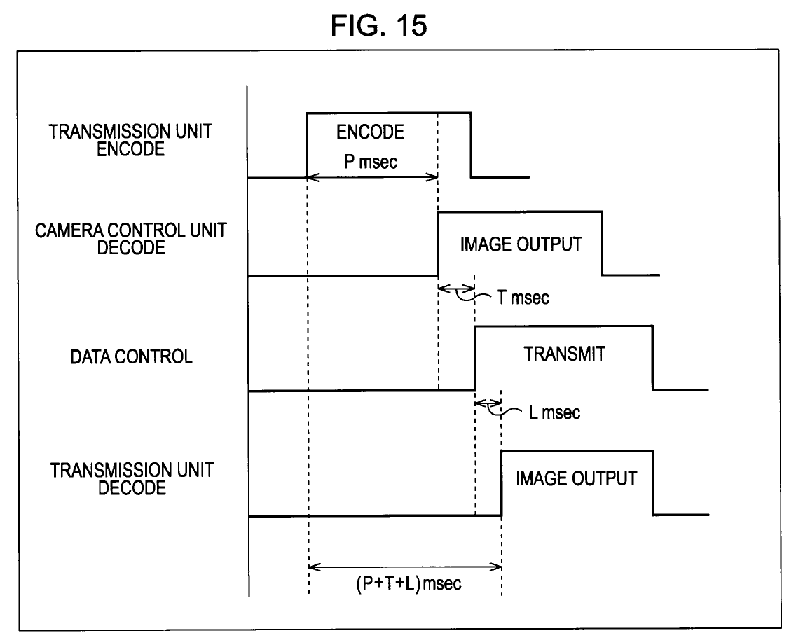

FIG. 15 is a schematic diagram illustrating the relation in timing of each processing executed at each part of the digital triax system 100 shown in FIG. 3, and is a diagram corresponding to FIG. 2. The encoding processing at the video signal encoding unit 120 of the transmission unit 110 shown at the topmost tier in FIG. 15, and the decoding processing at the video signal decoding unit 136 of the camera control unit 112 shown at the second tier from the top in FIG. 15 are executed at the same timing as with the case shown in FIG. 2, so the delay time from encoding processing being started to the decoding processing results being output is P[msec].

Subsequently, the data control unit 137 outputs the return encoded data T[msec] following starting of output of the decoding results, as shown at the third tier from the top in FIG. 15, and the video signal decoding unit 121 decodes the return encoded data L[msec] later as shown at the bottommost tier in FIG. 15, and outputs the image.

That is to say, the time from starting encoding of the main line video picture to starting output of the decoded image of the return line video picture is (P+T+L) [msec], and if the time of T+L is shorter than P, this means that the delay time is shorter than the case in FIG. 2.

P[msec] is the sum of time necessary for encoding processing and decoding processing (the sum of time for minimum information necessary for encoding processing to be collected and time for minimum information necessary for encoding processing to be collected), and L[msec] is time necessary for decoding processing (the time for minimum information necessary for decoding processing to be collected). That is to say, this means that if T[msec] is shorter than the time necessary for encoding processing, the delay time is shorter than the case in FIG. 2.

With encoding processing, processing such as wavelet transformation, coefficient rearranging, and entropy encoding and so forth is performed, as described with reference to FIG. 4 and so forth. In the wavelet transformation, division processing is recursively repeated, and during this time, data is accumulated in the midway calculation buffer unit 211 time and time again. Also, coefficient data obtained by wavelet transformation is held in the coefficient rearranging buffer unit 212 until at least one line block worth of data is accumulated. Further, entropy encoding is performed on the coefficient data. Accordingly, the time required for encoding processing is clearly longer than the time for one line block worth of input image data to be input.

In contrast, T[msec] is the time until extracting a part of the encoded data and starting transmission at the data control unit 137. For example, in the event that the main line encoded data is 150 Mbps, and the return encoded data is 50 Mbps, 50 Mbps of data is accumulated from the top of the supplied 150 Mbps of data, and output is started at the point that the 50 Mbps of encoded data is accumulated. This time for choosing which to take and which to leave of data is T[msec]. That is to say, T[msec] is shorter than the time of one line of the 150 Mbps of encoded data being supplied.

Accordingly, T[msec] is clearly shorter than the time necessary for encoding processing, so the delay time from starting encoding of the main line video picture to starting output of the decoded image of the return line video picture is clearly shorter with the case in FIG. 15 as to the case in FIG. 2.

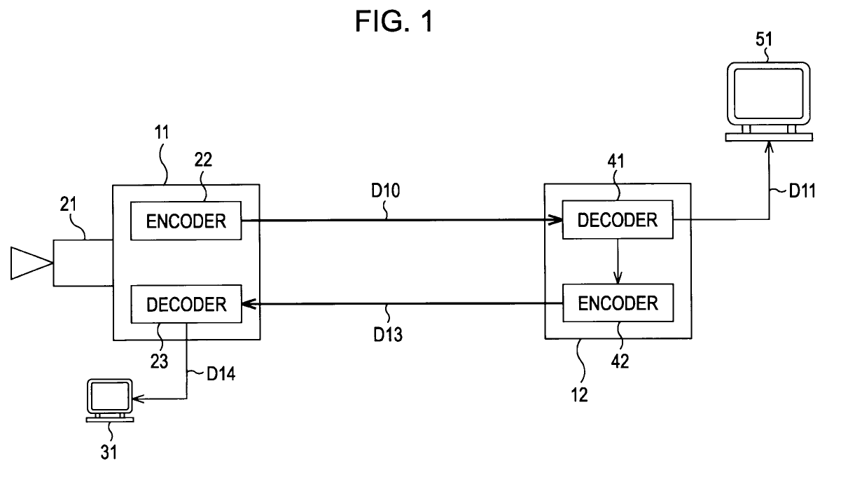

Note that the processing at the data control unit 137 is easy as described above, and while the detailed configuration thereof will be described later, the circuit configuration thereof can be clearly reduced in scale as compared to a conventional case using an encoder as shown in FIG. 1. That is to say, by applying this data control unit 137, the circuit scale and cost of the camera control unit 112 can be reduced.

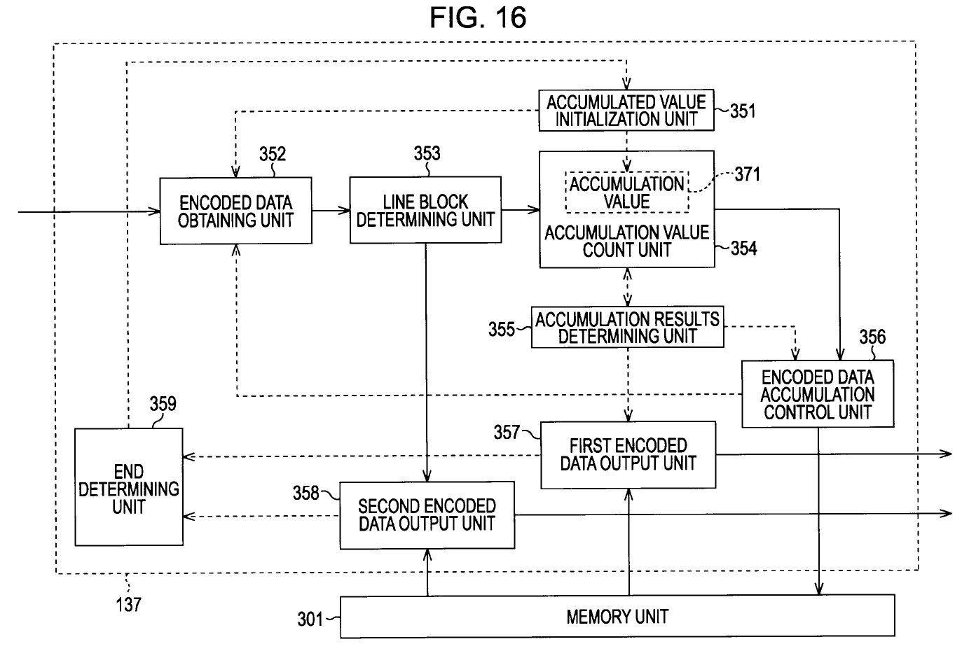

Next, the internal configuration of the data control unit 137 which performs such processing will be described. FIG. 16 is a block diagram illustrating a detailed configuration example of the data control unit 137. In FIG. 16, the data control unit 137 has an accumulation value initialization unit 351, encoded data obtaining unit 352, line block determining unit 353, accumulation value count unit 354, accumulation results determining unit 355, encoded data accumulation control unit 356, first encoded data output unit 357, second encoded data output unit 358, and end determining unit 359. Note that in the drawing, the solid line arrows indicate the relation between blocks including the movement direction of encoded data, and the dotted line arrows indicate the control relation between blocks not including the movement direction of encoded data.

The accumulation value initialization unit 351 initializes the value of the accumulation value 371 counted at the accumulation value count unit 354. The accumulation value is the sum total of the code amount of the encoded data accumulated in the memory unit 301. Upon performing initialization of the accumulation value, the accumulation value initialization unit 351 causes the encoded data obtaining unit 352 to start obtaining of encoded data.

The encoded data obtaining unit 352 is controlled by the accumulation value initialization unit 351 and the encoded data accumulation control unit 356 to obtain encoded data supplied from the video signal decoding unit 136, supply this to the line block determining unit 353, and cause to perform line block determination.

The line block determining unit 353 determines whether or not the encoded data supplied from the encoded data obtaining unit 352 is the last encoded data of the line block currently being obtained. For example, along with encoded data, a part or all of the header information of that packet is supplied from the de-packetizing unit 321 of the video signal decoding unit 136. The line block determining unit 353 determines whether or not the supplied encoded data is the last encoded data of the current line block, based on such information. In the event that determination is made that this is not the last encoded data, the line block determining unit 353 supplies the encoded data to the accumulation value count unit 354, and causes to execute counting of accumulation value. Conversely, in the event that determination is made that this is the last encoded data, the line block determining unit 353 supplies the encoded data to the second encoded data output unit 358, and starts output of encoded data.

The accumulation value count unit 354 has an unshown storage unit built in, and holds an accumulation value which is a variable indicating the sum of code amount of the encoded data accumulated in the memory unit 301 in that storage unit. Upon being supplied with encoded data from the line block determining unit 353, the accumulation value count unit 354 adds the code amount of that encoded data to the accumulation value, and supplies the accumulation result thereof to the accumulation results determining unit 355.

The accumulation results determining unit 355 determines whether or not the accumulation value thereof has reached the target code amount corresponding to the bit rate of the return encoded data determined beforehand, and in the event of determining that this has not been reached, controls the accumulation value count unit 354 to cause to supply encoded data to the encoded data accumulation control unit 356, and further controls the encoded data accumulation control unit 356 to cause to accumulate the encoded data in the memory unit 301. Also, in the event of determining that the accumulation value has reached the target code amount, the accumulation results determining unit 355 controls the first encoded data output unit 357 to cause to start output of encoded data.

Upon obtaining encoded data from the accumulation value count unit 354, the encoded data accumulation control unit 356 supplies this to the memory unit 301 to be stored. Upon causing the encoded data to be stored, the encoded data accumulation control unit 356 causes the encoded data obtaining unit 352 to start obtaining new encoded data.

Upon being controlled by the accumulation results determining unit 355, the first encoded data output unit 357 reads and externally outputs, of the encoded data accumulated in the memory unit 301, from the first encoded data up to the encoded data of the sub-band immediately-preceding the sub-band currently being processed. Upon outputting the encoded data, the first encoded data output unit 357 causes the end determining unit 359 to determined processing ending.

Upon encoded data being supplied from the line block determining unit 353, the second encoded data output unit 358 reads out all encoded data accumulated in the memory unit 301, and externally outputs these encoded data from the data control unit 137. Upon outputting the encoded data, the second encoded data output unit 358 causes the end determining unit 359 to determine processing ending.

The end determining unit 359 determines whether or not input of encoded data has ended, and in the event that determination is made that not ended, the accumulation value initialization unit 351 is controlled and caused to initialize the accumulation value 371. Also, in the event that determination is made that ended, the end determining unit 359 ends bit rate conversion processing.

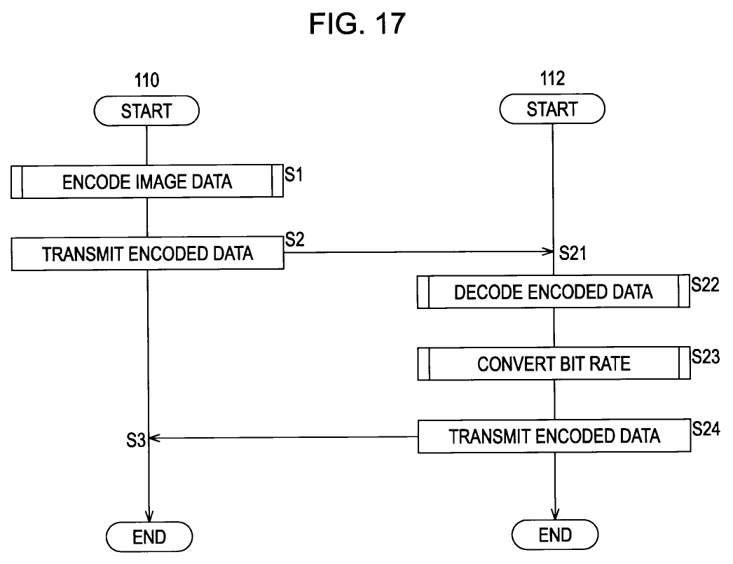

Next, a specific example of the flow of processing executed at each part in FIG. 3 will be described. FIG. 17 is a flowchart illustrating an example of the primary flow of processing executed at the entire digital triax system 100 (transmission unit 110 and camera control unit 112).

As shown in FIG. 17, in step S1, the transmission unit 110 encodes image data supplied from the video camera unit 113, and in step S2, performs such as modulation and signal amplification as to the encoded data obtained by the encoding thereof, and supplies to the camera control unit 112.

In step S21, upon obtaining the encoded data, the camera control unit 112 performs processing such as signal amplification and demodulation and so forth, and further in step S22, decodes the encoded data, in step S23 converts the bit rate of the encoded data, and in step S24 performs such as modulation and signal amplification of the encoded data of which the bit rate has been converted, and transmits to the transmission unit 110.

In step S3, the transmission unit 110 obtains the encoded data. The transmission unit 110 which has obtained the encoded data subsequently performs processing such as signal amplification and demodulation and so forth, and further decodes the encoded data, and performs processing such as displaying the image on the display unit 151 and so forth.

Note that the detailed flow of encoding processing of image data in step S1, the decoding processing of encoded data in step S22, and bit rate conversion processing in step S23 will be described later. Also, each processing of step S1 through step S3 at the transmission unit 110 may be executed parallel to each other. In the same way, at the camera control unit 112, each processing of step S21 through step S24 may be executed parallel to each other.

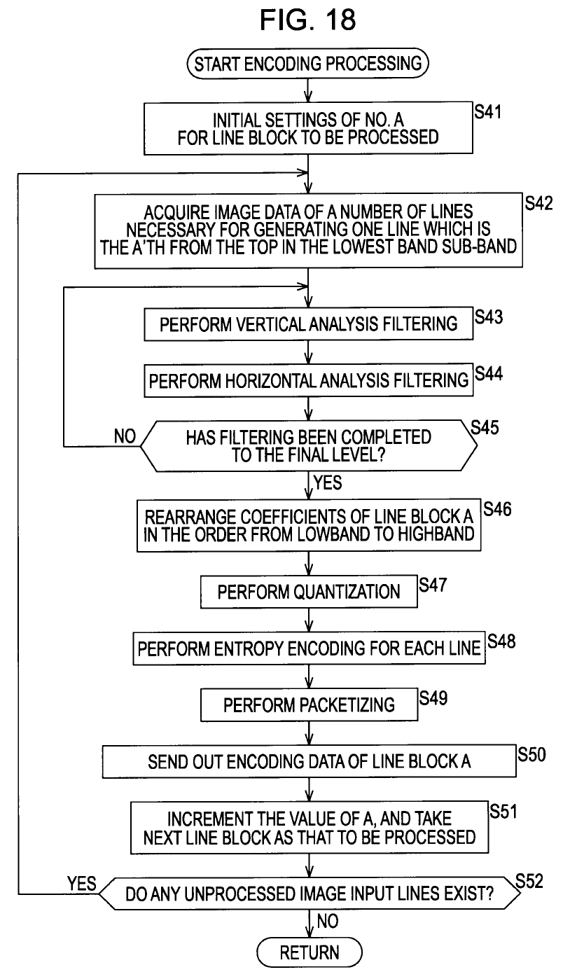

Next, an example of detailed flow of encoding process executed at step S1 in FIG. 17 will be described with reference to the flowchart in FIG. 18.

Upon the encoding processing starting, in Step S41, the wavelet transformation unit 210 sets No. A of the line block to be processed to initial settings. In normal cases, No. A is set to “1”. Upon the setting ending, in Step S42 the wavelet transformation unit 210 obtains image data for the line numbers necessary (i.e. one line block) for generating the one line of the A'th line from the top of the lowest band sub-band, in Step S43 performs vertical analysis filtering processing for performing analysis filtering as to the image data arrayed in the screen vertical direction as to the image data thereof, and in Step S44 performs horizontal analysis filtering processing for performing analysis filtering as to the image data arrayed in the screen horizontal direction.

In Step S45 the wavelet transformation unit 210 determines whether or not the analysis filtering process has been performed to the last level, and in the case of determining the division level has not reached the last level, the process is returned to Step S43, wherein the analysis filtering processing in Step S43 and Step S44 is repeated as to the current division level.

In the event that the analysis filtering processing is determined in Step S45 to have been performed to the last level, the wavelet transformation unit 210 advances the processing to Step S46.

In Step S46, the coefficient rearranging unit 213 rearranges the coefficients of the line block A (the A'th line block from the top of the picture (field, in the case of interlacing method)) in the order from lowband to highband. In Step S47, the quantization unit 214 performs quantization as to the rearranged coefficients using a predetermined quantization coefficient. In step S48, the entropy encoding unit 215 subjects the coefficient to entropy encoding in line increments. Upon the entropy encoding ending, in Step S49 the packetizing unit 217 packetizes the encoded data of line block A, and in step S50, sends that packet (the encoded data of the line block A) out externally.

The wavelet transformation unit 210 increments the value in No. A by “1” in Step S51, takes the next line block as an object of processing, and in Step S52 determines whether or not there are unprocessed image input lines in the picture (field, in the case of interlacing method) to be processed. In the event it is determined there are, the process is returned to Step S42, and the processing thereafter is repeated for the new line block to be processed.

As described above, the processing in Step S42 through Step S52 is repeatedly executed to encode each line block. In the event determination is made in Step S252 that there are no unprocessed image input lines, the wavelet transformation unit 210 ends the encoding processing for that picture. A new encoding process is started for the next picture.

Thus, with the wavelet transformation unit 210, vertical analysis filtering processing and horizontal analysis filtering processing is continuously performed in increments of line blocks to the last level, so compared to a conventional method, the amount of data needing to be held (buffered) at one time (during the same time period) is small, thus greatly reducing the memory capacity to be prepared in the buffer. Also, by performing the analysis filtering processing to the last level, the later steps for coefficient rearranging or entropy encoding processing can also be performed (i.e. coefficient rearranging or entropy encoding can be performed in increments of line blocks). Accordingly, delay time can be greatly reduced as compared to a method wherein wavelet transformation is performed as to an entire screen.

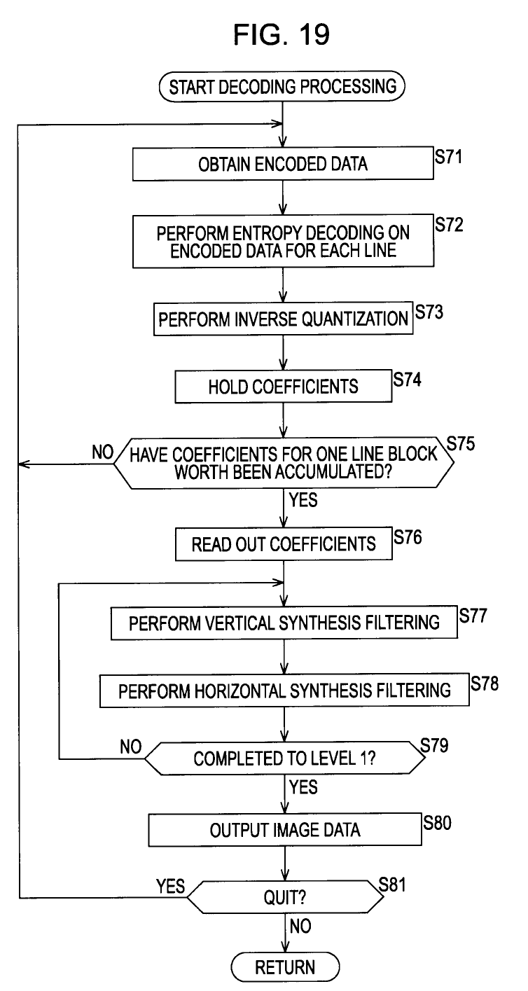

Next, an example of the detailed flow of the decoding process executed in step S22 in FIG. 17 will be described with reference to the flowchart in FIG. 19. This decoding process corresponds to the encoding process illustrated in the flowchart in FIG. 18.

Upon the decoding processing starting, in Step S71 the de-packetizing unit 321 de-packetizes the obtained packet and obtains encoded data. In step S72, the entropy decoding unit 322 subjects the encoded data to entropy decoding for each line. In Step S73, the inverse quantization unit 323 performs inverse quantization on the coefficient data obtained by entropy decoding. In step S74, the coefficient buffer unit 324 holds the coefficient data subjected to inverse quantization. In step S75, the wavelet inverse transformation unit 325 determines whether or not coefficients worth one line block have accumulated in the coefficient buffer unit 324, and if it is determined not to be accumulated, the processing is returned to Step S71, the processing thereafter is executed, and stands by until coefficients worth one line block have accumulated in the coefficient buffer unit 324.

In the event it is determined in Step S75 that coefficients worth one line block have been accumulated in the coefficient buffer unit 324, the wavelet inverse transformation unit 325 advances the processing to Step S76, and reads out coefficients worth one line block, held in the coefficient buffer unit 324.

The wavelet inverse transformation unit 325 in Step S77 subjects the read out coefficient to vertical synthesis filtering processing which performs synthesis filtering processing as to the coefficients arrayed in the screen vertical direction, and in Step S78, performs horizontal synthesis filtering processing which performs synthesis filtering processing as to the coefficients arrayed in the screen horizontal direction, and in Step S79 determines whether or not the synthesis filtering processing has ended through level one (the level wherein the value of the division level is “1”), i.e. determines whether or not inverse transformation has been performed to the state prior to wavelet transformation, and if it is determined not to have reached level 1, the processing is returned to Step S77, whereby the filtering processing in Step S77 and Step S78 is repeated.

In Step S79, if the inverse transformation processing is determined to have ended through level 1, the wavelet inverse transformation unit 325 advances the processing to Step S80, and outputs the image data obtained by inverse transformation processing externally.

In Step S81, the entropy decoding unit 322 determines whether or not to end the decoding processing, and in the case of determining that the input of encoded data via the de-packetizing unit 321 is continuing and that the decoding processing will not be ended, the processing returns to Step S71, and the processing thereafter is repeated. Also, in Step S81, in the case that input of encoded data is ended and so forth so that the decoding processing is ended, the entropy decoding unit 322 ends the decoding processing.

In the case of the wavelet inverse transformation unit 325, as described above, the vertical synthesis filtering processing and horizontal synthesis filtering processing is continuously performed in increments of line blocks up to the level 1, therefore compared to a method wherein wavelet transformation is performed as to an entire screen, the amount of data needing to be buffered at one time (during the same time period) is markedly smaller, thus facilitating reduction in memory capacity to be prepared in the buffer. Also, by performing synthesis filtering processing (wavelet inverse transformation processing) up to level 1, the image data can be output sequentially before all of the image data within a picture is obtained (in increments of line blocks), thus compared to a method wherein wavelet transformation is performed as to an entire screen, the delay time can be greatly reduced.

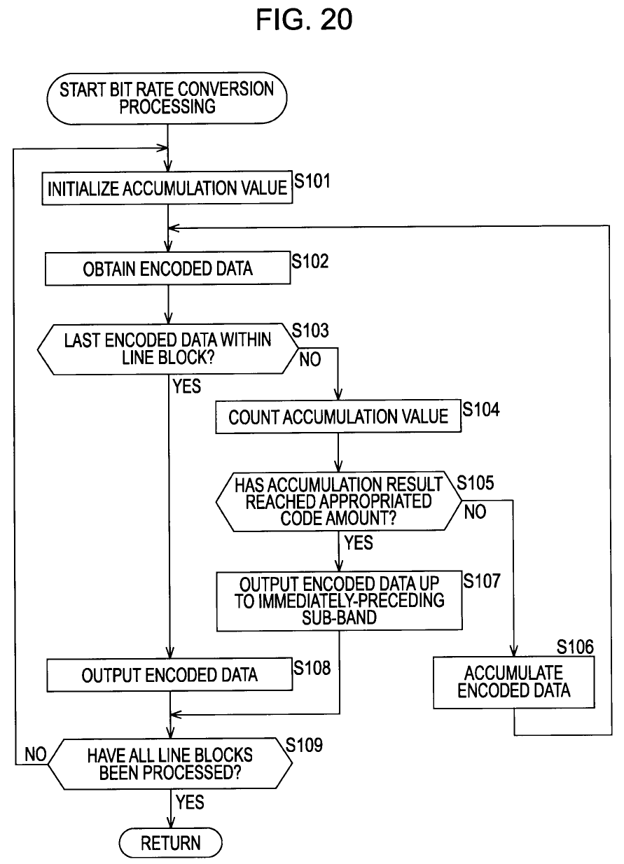

Next, an example of the flow of bit rate conversion processing executed in step S23 in FIG. 17 will be described with reference to the flowchart in FIG. 20.

Upon the bit rate conversion processing being started, in step S101 the accumulation value initialization unit 351 initializes the value of the accumulation value 371. In step S102, the encoded data obtaining unit 352 obtains the encoded data supplied from the video signal decoding unit 136. In step S103, the line block determining unit 353 determines whether or not the last encoded data in the line block. In the event of determining that not the last encoded data, the processing advances to step S104. In step S104, the accumulation value count unit 354 counts the accumulation value by adding to the accumulation value held thereby, the code amount of the newly-obtained encoded data.

In step S105, the accumulation results determining unit 355 determines whether or not the accumulation results which is the current accumulation value has reached the code amount appropriated to the line block to be processed beforehand, i.e., the code amount appropriated which is the target code amount of the line block to be processed. In the event of determining that the appropriated code amount has not been reached, the processing advances to step S106. In step S106, the encoded data accumulation control unit 356 supplies the encoded data obtained in step S102 to the memory unit 301, and causes it to be accumulated. Upon the processing of step S106 ending, the processing returns to step S102.

Also, in the event of determining that the accumulation result has reached the appropriated code amount in step S105, the processing advances to step S107. In step S107, the first encoded data output unit 357 reads out and outputs, of the encoded data stored in the memory unit 301, encoded data from the top sub-band to the sub-band immediately preceding the sub-band to which the encoded data obtained in step S102 belongs. Upon ending the processing of step S107, the processing advances to step S109.

Also, in step S103, in the event that determination is made that the encoded data obtained by the processing in step S102 is the last encoded data within the line block, the processing advances to step S108. In step S108, the second encoded data output unit 358 reads out all of the encoded data within the line block to be processed that is stored in the memory unit 301, and outputs along with the encoded data obtained by the processing in step S102. Upon the processing in step S108 ending, the processing advances to step S109.

In step S109, the end determining unit 359 determines whether or not all line blocks have been processed. In the event that determination is made that there are unprocessed line blocks existing, the processing returns to step S101, and the subsequent processing is repeated on the next unprocessed line block. Also, in the event that determination is made in step S109 that all line blocks have been processed, the bit rate conversion processing ends.

By performing bit rate conversion processing as that above, the data control unit 137 can convert the bit rate thereof to a desired value without decoding the encoded data, easily and with low delay. Accordingly, the digital triax system 100 can easily reduce the delay time from starting the processing in step S1 in the flowchart in FIG. 17 to ending of the processing in step S3. Also, due to this arrangement, there is no need to provide encoding of the return encoded data, and the circuit scale and cost of the camera control unit 112 can be reduced.

In FIG. 4, coefficient rearranging has been described as being performed immediately following the wavelet transformation (before quantization), but it is sufficient for encoded data to be supplied to the video signal decoding unit 136 in order from lowband to highband (i.e., it is sufficient to be supplied in the order of encoded data obtained by encoding coefficient data belonging to the lowband sub-bands, to encoded data obtained by encoding coefficient data belonging to the highband sub-bands), and the timing for rearranging may be other than immediately following wavelet transformation.

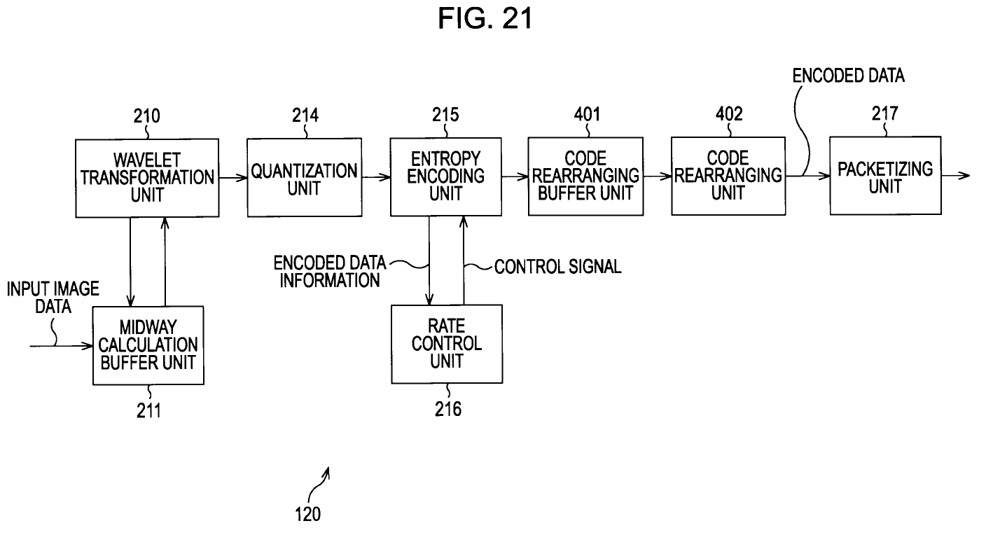

For example, the order of encoded data obtained by entropy encoding may be rearranged. FIG. 21 is a block diagram illustrating a configuration example of the video signal encoding unit 120 in this case.

In the case in FIG. 21, the video signal encoding unit 120 includes a wavelet transformation unit 210, midway calculation buffer unit 211, quantization unit 214, entropy encoding unit 215, rate control unit 216, and packetizing unit 217, in the same way as with the case in FIG. 4, but has a code rearranging buffer unit 401 and code rearranging unit 402 instead of the coefficient rearranging buffer unit 212 and coefficient rearranging unit 213.

The code rearranging buffer unit 401 is a buffer for rearranging the output order of encoded data encoded at the entropy encoding unit 215, and the code rearranging unit 402 rearranges the output order of the encoded data by reading out the encoded data accumulated in the code rearranging buffer unit 401 in a predetermined order.

That is to say, in the case in FIG. 21, the wavelet coefficients output from the wavelet transformation unit 210 are supplied to the quantization unit 214 and quantized. The output of the quantization unit 214 is supplied to the entropy encoding unit 215 and encoded. Each encoded data obtained by that encoding is sequentially supplied to the code rearranging buffer unit 401, and temporarily stored for rearranging.

The code rearranging unit 402 reads out the encoded data written in the code rearranging buffer unit 401 in a predetermined order, and supplies to the packetizing unit 217.

In the case in FIG. 21, the entropy encoding unit 215 performs encoding of each coefficient data in the output order by the wavelet transformation unit 210, and writes the obtained encoded data to the code rearranging buffer unit 401. That is to say, the code rearranging buffer unit 401 stores encoded data in an order corresponding to the output order of wavelet coefficients by the wavelet transformation unit 210. In a normal case, comparing coefficient data belonging to one line block one with another, the wavelet transformation unit 210 outputs the coefficient data earlier that belongs to a higher sub-band, and outputs the coefficient data later that belongs to a lower sub-band. That is to say, each encoded data is stored in the code rearranging buffer unit 401 in an order heading from the encoded data obtained by performing entropy encoding of coefficient data belonging to highband sub-bands toward the encoded data obtained by performing entropy encoding of coefficient data belonging to lowband sub-bands.

Conversely, the code rearranging unit 402 performs rearranging of encoded data by reading out each encoded data accumulated in the code rearranging buffer unit 401 thereof in an arbitrary order independent from this order.

For example, the code rearranging unit 402 reads out with greater priority encoded data obtained by encoding coefficient data belonging to lower band sub-bands, and finally reads out encoded data obtained by encoding coefficient data belonging to the highest band sub-band. Thus, by reading out encoded data from lowband to highband, the code rearranging unit 402 enables the video signal decoding unit 136 to decode each encoded data in the obtained order, thereby reducing delay time occurring at the decoding processing by the video signal decoding unit 136.

The code rearranging unit 402 reads out the encoded data accumulated in the code rearranging buffer unit 401, and supplies this to the packetizing unit 217.

Note that the data encoded at the video signal encoding unit 120 shown in FIG. 21 can be decoded in the same way as the encoded data output from the video signal encoding unit 120 shown in FIG. 4, by the video signal decoding unit 136 already described with reference to FIG. 13.

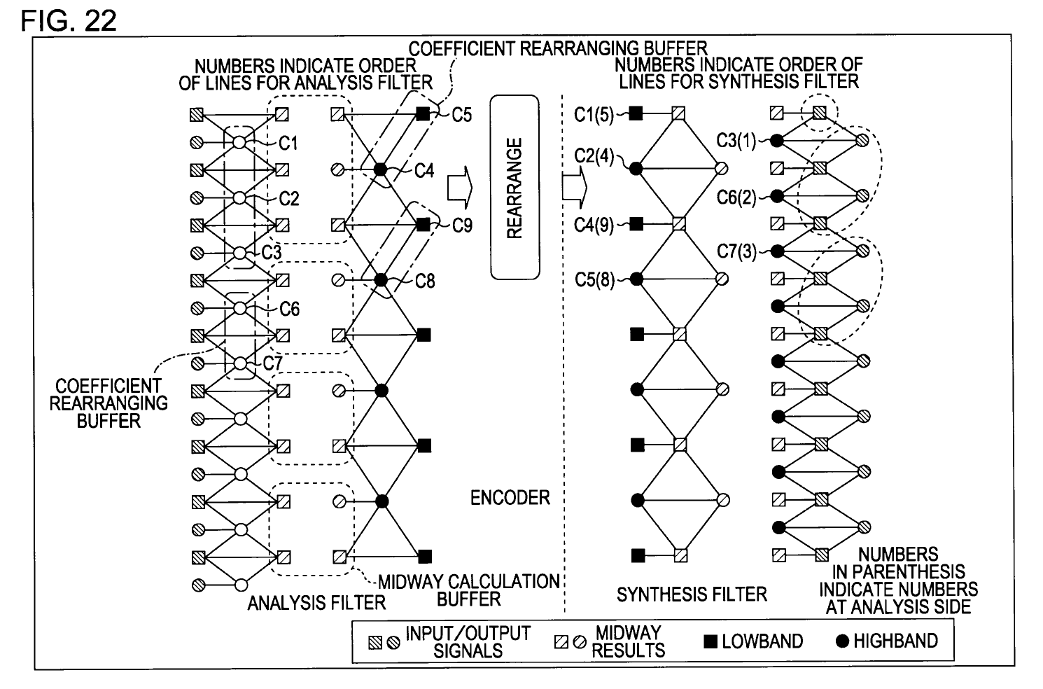

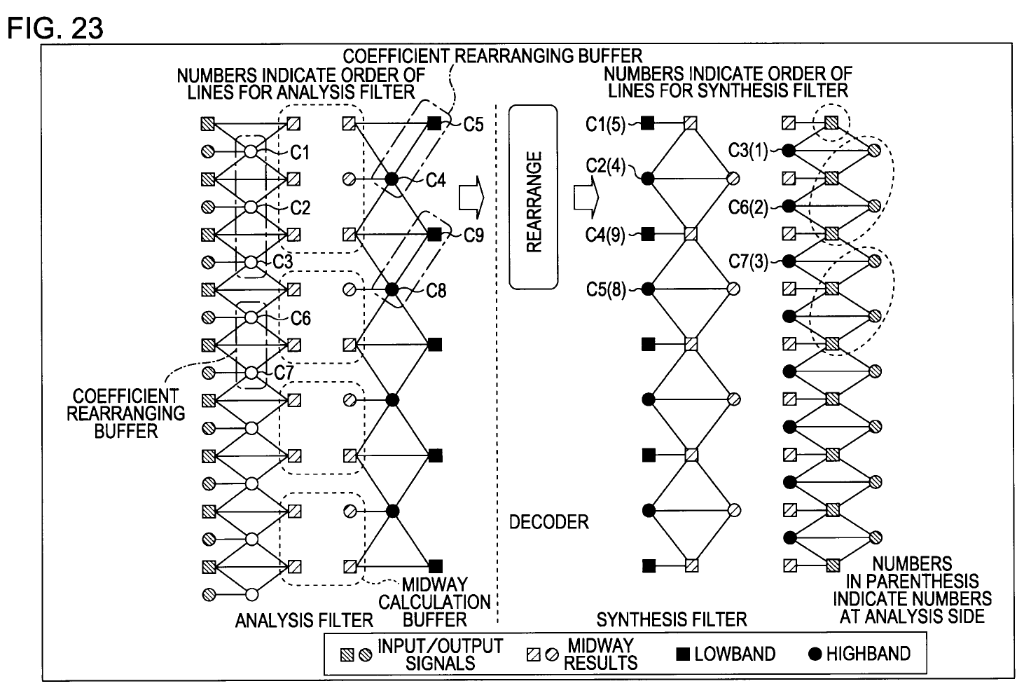

Also, the timing for performing rearranging may be other than the above-described. For example, as an example is shown in FIG. 22, this may be performed at the video signal encoding unit 120, or as an example is shown in FIG. 23, this may be performed at the video signal decoding unit 136.

In processing for rearranging coefficient data generated by wavelet transformation, a relatively large capacity is necessary as storage capacity for the coefficient rearranging buffer, and also, high processing capability is required for coefficient rearranging processing itself. In this case as well, there is no problem whatsoever in a case wherein the processing capability of the transmission unit 110 is at or above a certain level.

Now, let us consider situations in which the transmission unit 110 is installed in a device with relatively low processing capability, such as so-called mobile terminals such as a cellular telephone terminal or PDA (Personal Digital Assistant). For example, in recent years, products wherein imaging functions have been added to cellular telephone terminals have come into widespread use (called cellular telephone terminal with camera function). A situation may be considered wherein the image data imaged by a cellular telephone device with such a camera function is subjected to compression encoding by wavelet transformation and entropy encoding, and transmitted via wireless or cable communications.

Such mobile terminals are restricted in the CPU (Central Processing Unit) processing capabilities, and also have a certain upper limit to memory capacity. Therefore, the load for processing with the above-described coefficient rearranging is a problem which cannot be ignored.

Thus, as with one example shown in FIG. 23, by building the rearranging processing into the camera control unit 112, the load on the transmission unit 110 can be alleviated, thus enabling the transmission unit 110 to be installed in a device with relatively low processing ability such as a mobile terminal.

Also, in the above, description has been made that data amount control is performed in increments of line blocks, but is not restricted to this, and an arrangement may be made wherein, for example data control is made in increments of multiple line blocks. Generally, a case wherein data control is made in increments of multiple line blocks has improved image quality as compared to a case wherein data control is made in increments of line blocks, but the delay time is accordingly longer.

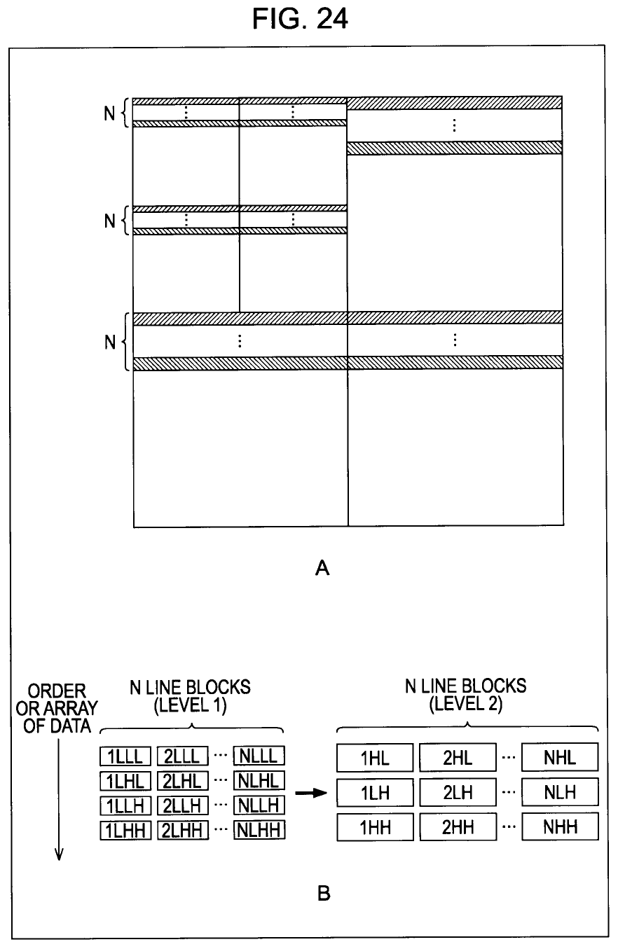

FIG. 24 is a diagram illustrating the way in which data amount is counted from lowband to highband following buffering each sub-band within N (N is an integer) line blocks. In A in FIG. 24, the portion indicated by hatching from the upper right to the lower left indicates each sub-band of the first line block, and the portion indicated by hatching from the upper left to the lower right indicates each sub-band of the N'th line block.

The data control unit 137 may perform data control with N line blocks which are continuous in this way as a single group. At this time, the array order of the encoded data is arrayed with the N line blocks as a single group. B in FIG. 24 illustrates an example of the array order thereof.

As described above, the data control unit 137 is supplied with encoded data in the order heading from the encoded data corresponding to coefficient data belonging to lowband sub-bands toward the encoded data belonging to highband sub-bands, in increments of line blocks. The data control unit 137 stores N line blocks worth of the encoded data in the memory unit 301.

Then, at the time of reading out the encoded data of the N line blocks worth accumulated in the memory unit 301 thereof, as shown in the example in B in FIG. 24, the data control unit 137 first reads out the encoded data of the sub-band LLL of the lowest band (level 1) of the first line block through the N'th line block (1LLL, 2LLL, . . . , NLLL), next reads out the encoded data of the sub-band LHL of the first line block through the N'th line block (1LHL, 2LHL, . . . , NLHL), reads out the encoded data of the sub-band LLH of the first line block through the N'th line block (1LLH, 2LLH, . . . , NLLH), and reads out the encoded data of the sub-band LHH of the first line block through the N'th line block (1LHH, 2LHH, . . . , NLHH).

Upon ending reading out of the level 1 encoded data, the data control unit 137 next reads out the encoded data of level 2, which is one higher. That is to say, as shown in the example in B in FIG. 24, the data control unit 137 reads out the encoded data of the sub-band HL of the level 2 of the first line block through the N'th line block (1HL, 2HL, . . . , NHL), next reads out the encoded data of the sub-band LH of the first line block through the N'th line block (1LH, 2LH, . . . , NLHL), and reads out the encoded data of the sub-band HH of the first line block through the N'th line block (1HH, 2HH, . . . , NHH).

As described above, the data control unit 137 takes N line blocks as a single group, and reads out the encoded data of each line block within the group in parallel, from the lowest band sub-band toward the highest band sub-band.

That is to say, the data control unit 137 reads out the encoded data stored in the memory unit 301 in the order of (1LLL, 2LLL, . . . , NLLL, 1LHL, 2LHL, . . . , NLHL, 1LLH, 2LLH, . . . , NLLH, 1LHH, 2LHH, . . . , NLHH, 1HL, 2HL, . . . , NHL, 1LH, 2LH, . . . , NLH, 1HH, 2HH, . . . , NHH, . . . ).

While reading out the encoded data of the N line blocks, the data control unit 137 counts the sum of the code amount, and in the event of reaching the target code amount, ends the reading out, and discards subsequent data. Upon the processing on the N line blocks ends, the data control unit 137 performs the same processing on the next N line blocks. That is to say, the data control unit 137 controls the code amount (converts the bit rate) of every N line blocks.

In this way, by controlling the code amount of every N line blocks, the difference in image quality between line blocks can be reduced and local marked deterioration in resolution and so forth of the display image can be suppressed, so image quality of the display image can be improved.

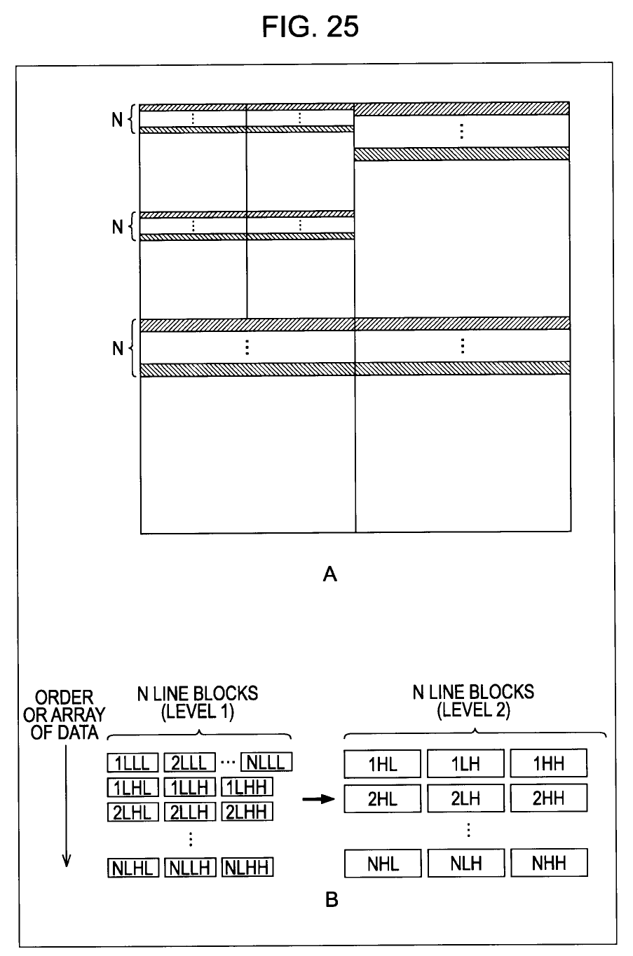

FIG. 25 illustrates a different example of the order of reading out encoded data. As shown in A in FIG. 25, the data control unit 137 processes encoded data for each N (N is an integer) line blocks, in the same way as with FIG. 24. That is to say, in this case as well, the data control unit 137 performs data control with N line blocks which are continuous as a single group. At this time, the array order of the encoded data is arrayed with the N line blocks as a single group. B in FIG. 25 illustrates an example of the array order thereof.

As described above, the data control unit 137 is supplied with encoded data in the order heading from the encoded data corresponding to coefficient data belonging to lowband sub-bands toward the encoded data belonging to highband sub-bands, in increments of line blocks. The data control unit 137 stores N line blocks worth of the encoded data in the memory unit 301.

Then, at the time of reading out the encoded data of the N light blocks worth accumulated in the memory unit 301 thereof, as shown in the example in B in FIG. 24, the data control unit 137 first reads out the encoded data of the sub-band LLL of the lowest band (level 1) of the first line block through the N'th line block (1LLL, 2LLL, . . . , NLLL).

From here differs from the case in B in FIG. 24, and as shown in B in FIG. 25, the data control unit 137 reads out the coefficient data of the remaining sub-bands of level 1 (LHL, LLH, LHH) for each line block. That is to say, following reading out the encoded data of the sub-band LLL, the data control unit 137 next reads out the encoded data of the remaining level 1 sub-bands of the first line block (1LHL, 1LLH, 1LHH), next in the same way reads out the encoded data from the second line block (2LHL, 2LLH, 2LHH), and subsequently repeats until reading out the encoded data from the N'th line block (NLHL, NLLH, NLHH).

Upon ending reading out all of the encoded data of the sub-bands of the level 1 for the first line block through the N'th line block in the above order, the data control unit 137 next reads out the encoded data of level 2, which is one higher. At this time, the data control unit 137 reads out the encoded data of the remaining sub-bands of level 2 (HL, LH, HH) for each block. That is to say, the data control unit 137 reads out the encoded data of the remaining sub-bands of level 2 in the first line block (1HL, 1LH, 1HH), next reads out encoded data in the same way for the second line block (2HL, 2LH, 2HH), and subsequently repeats until reading out the encoded data for the N'th line block (NHL, NLH, NHH).

The data control unit 137 reads out the encoded data to the highest band sub-bands in the above-described order, in the same way for the subsequent levels as well.

That is to say, the data control unit 137 reads out the encoded data stored in the memory unit 301 in the order of (1LLL, 2LLL, . . . , NLLL, 1LHL, 1LLH, 1LHH, 2LHL, 2LLH, 2LHH, . . . , NLHL, NLLH, NLHH, 1HL, 1LH, 1HH, 2HL, 2LH, 2HH, . . . , NHL, NLH, NHH, . . . ).

While reading out the encoded data of the N line blocks, the data control unit 137 counts the sum of the code amount, and in the event of reaching the target code amount, ends the reading out, and discards subsequent data. Upon the processing on the N line blocks ends, the data control unit 137 performs the same processing on the next N line blocks. That is to say, the data control unit 137 controls the code amount (converts the bit rate) of every N line blocks.

In this way, further, imbalance in appropriation for each sub-band can be suppressed, visual sense of unnaturalness in the displayed image can be reduced, and image quality can be improved.

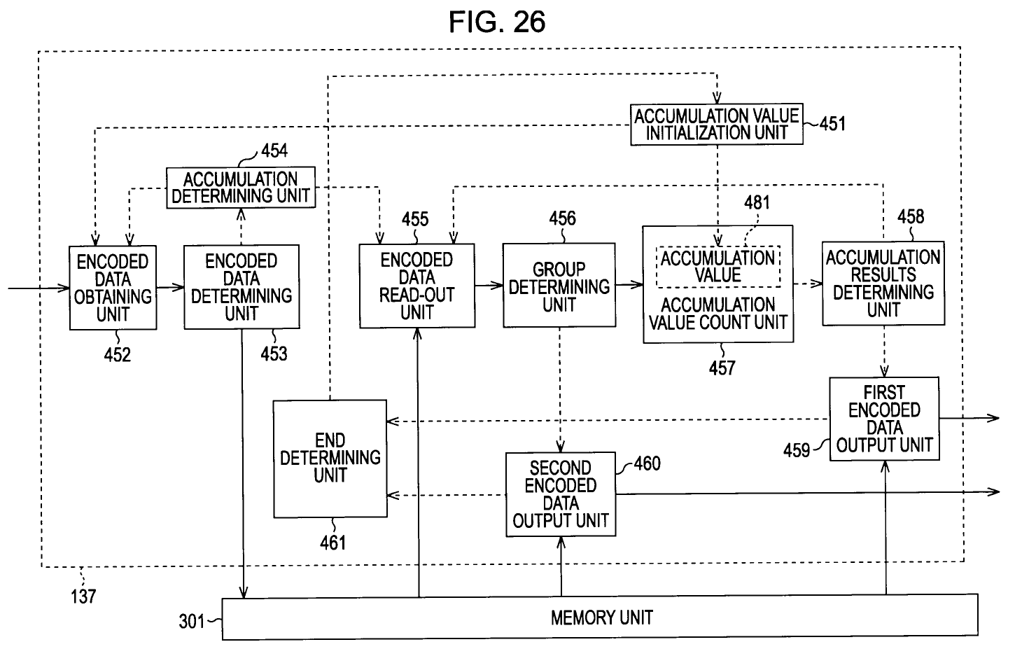

FIG. 26 shows a detailed configuration example of the data control unit 137 in a case of converting the bit rate for each N line blocks, as described with reference to FIG. 24 and FIG. 25.

In FIG. 26, the data control unit 137 has an accumulation value initialization unit 451, encoded data obtaining unit 452, encoded data accumulation control unit 453, accumulation determining unit 454, encoded data read-out unit 455, group determining unit 456, accumulation value count unit 457, accumulation results determining unit 458, first encoded data output unit 459, second encoded data output unit 460, and end determining unit 461.

The accumulation value initialization unit 451 initializes the value of the accumulation value 481 counted at the accumulation value count unit 457. Upon performing initialization of the accumulation value 481, the accumulation value initialization unit 451 causes the encoded data obtaining unit 452 to start obtaining of encoded data.

The encoded data obtaining unit 452 is controlled by the accumulation value initialization unit 451 and the accumulation determining unit 454 to obtain encoded data supplied from the video signal decoding unit 136, supply this to the encoded data accumulation control unit 453, and cause to perform accumulation of encoded data. The encoded data accumulation control unit 453 accumulates the encoded data supplied from the encoded data obtaining unit 452 in the memory unit 301, and notifies the accumulation determining unit 454 to that effect. The accumulation determining unit 454 determines whether or not N line blocks worth of encoded data has been accumulated in the memory unit 301, based on the notification from the encoded data accumulation control unit 453. In the event of determining that N line blocks worth of encoded data has not been accumulated, the accumulation determining unit 454 controls the encoded data obtaining unit 452 and causes to obtain new encoded data. Also, in the event of determining that N line blocks worth of encoded data has been accumulated in the memory unit 301, the accumulation determining unit 454 controls the encoded data read-out unit 455, to cause to start reading out of the encoded data accumulated in the memory unit 301.

An encoded data read-out unit 455 is controlled by the accumulation determining unit 454 or the accumulation results determining unit 458, reads out encoded data accumulated in the memory unit 301, and supplies the encoded data that has been read out to the group determining unit 456. At this time, the encoded data read-out unit 455 takes encoded data of N line blocks worth as a single group, and reads out encoded data for every group in a predetermined order. That is to say, upon the encoded data accumulation control unit 453 storing one group worth of encoded data in the memory unit 301, the encoded data read-out unit 455 takes that group as an object of processing, and reads out the encoded data of that group in a predetermined order.

The group determining unit 456 determines whether or not the encoded data read out by the encoded data read-out unit 455 is the last data of the last line block of the group currently being processed. In the event that determination is made that the supplied encoded data is not the last encoded data to be read out of the group to which the encoded data belongs, the group determining unit 456 supplies the supplied encoded data to the accumulation value count unit 457. Also, in the event that determination is made that the supplied encoded data is the last encoded data to be read out of the group to which the encoded data belongs, the group determining unit 456 controls the second encoded data output unit 460.

The accumulation value count unit 457 has an unshown storage unit built in, counts the sum of code amount of the encoded data supplied from the group determining unit 456, holds the count value thereof as an accumulation value 481 in the storage unit, and also supplies the accumulation value 481 to the accumulation results determining unit 458.

The accumulation results determining unit 458 determines whether or not the accumulation value 481 has reached the target code amount corresponding to the bit rate of the return encoded data determined beforehand, and in the event of determining that this has not reached, controls the encoded data read-out unit 455 to cause to read out new encoded data. Also, in the event of determining that the accumulation value 481 has reached the target code amount allocated to that group, the accumulation results determining unit 458 controls the first encoded data output unit 459.

Upon being controlled by the accumulation results determining unit 458, the first encoded data output unit 459 reads out and externally outputs from the data control unit 137, of the encoded data belonging to the group to be processed, all encoded data from the top up to the immediately-preceding sub-band.

As described with reference to B in FIG. 24 and B in FIG. 25, the encoded data accumulated in the memory unit 301 is read out in increments of sub-bands of each line block. Accordingly, in the event that determination is made that the accumulation value 481 has reached the target code amount at the time of encoded data belonging to the m'th sub-band being read out, for example, the first encoded data output unit 459 reads out encoded data belonging to the first through (m−1)'th sub-bands read out from the memory unit 301, and externally outputs from the data control unit 137.

Upon outputting the encoded data, the first encoded data output unit 459 causes the end determining unit 461 to determine processing ending.

The second encoded data output unit 460 is controlled by the group determining unit 456, and reads out all encoded data of the group to which the encoded data read out by the encoded data read-out unit 455 belongs, and externally outputs from the data control unit 137. Upon outputting the encoded data, the second encoded data output unit 460 causes the end determining unit 461 to determine processing ending.

The end determining unit 461 determines whether or not input of encoded data has ended, and in the event that determination is made that not ended, the accumulation value initialization unit 451 is controlled and caused to initialize the accumulation value 481. Also, in the event that determination is made that ended, the end determining unit 461 ends bit rate conversion processing.

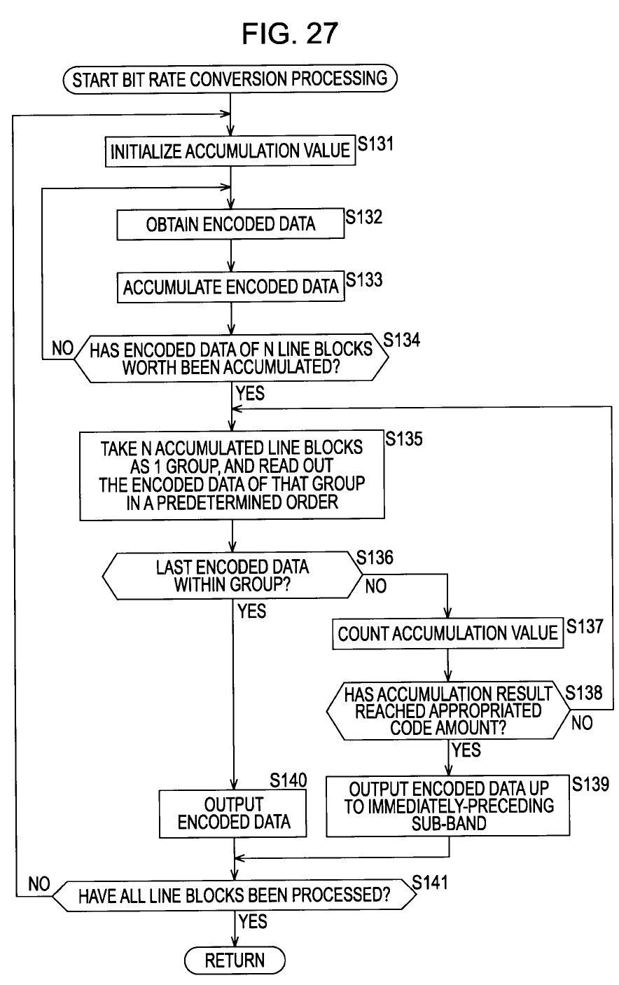

Next, an example of the flow of bit rate conversion processing by the data control unit 137 shown in this FIG. 26 will be described with reference to the flowchart in FIG. 27. This bit rate conversion processing is processing corresponding to the bit rate conversion processing shown in the flowchart in FIG. 20. Note that processing other than this bit rate conversion processing is executed in the same way as described with reference to FIG. 17 through FIG. 19.

Upon the bit rate conversion processing being started, in step S131 the accumulation value initialization unit 451 initializes the value of the accumulation value 481. In step S132, the encoded data obtaining unit 452 obtains the encoded data supplied from the video signal decoding unit 136. In step S133, the encoded data accumulation control unit 453 causes the encoded data obtained in step S132 to be accumulated in the memory unit 301. In step S134, the accumulation determining unit 454 determines whether or not N line blocks of encoded data have been accumulated. In the event that determination is made that N line blocks of encoded data have not been accumulated at the memory unit 301, the processing returns to step S132, and subsequent processing is repeated. Also, in the event that determination is made in step S134 that N line blocks of encoded data have been accumulated at the memory unit 301, the processing advances to step S135.

Upon N line blocks of encoded data being accumulated at the memory unit 301, in step S135 the encoded data read-out unit 455 takes the accumulated N line blocks of encoded data as a single group, and reads out the encoded data of that group in a predetermined order.

In step S136, the group determining unit 456 determines whether or not the encoded data read out in step S135 is the last encoded data to be read out in the group to be processed. In the event of determining that not the last encoded data in the group to be processed, the processing advances to step S137.

In step S137, the accumulation value count unit 457 adds the code amount of the encoded data obtained in step S132 to the accumulation value 481 held thereby, and counts the accumulation value. In step S138, the accumulation results determining unit 458 determines whether or not the accumulation results has reached the target code amount appropriated to the group (the code amount appropriated). In the event of determining that the accumulation result has not reached the appropriated code amount, the processing returns to step S135, and the processing from step S135 on is repeated regarding the next new encoded data.

Also, in the event of determining that the accumulation result has reached the appropriated code amount in step S138, the processing advances to step S139. In step S139, the first encoded data output unit 459 reads out and outputs the encoded data up to the immediately-preceding sub-band, from the memory unit 301. Upon ending the processing of step S139, the processing advances to step S141.

Also, in step S136, in the event that determination is made that the last encoded data within the group has been read out, the processing advances to step S140. In step S140, the second encoded data output unit 460 reads out all of the encoded data within the group from the memory unit 301, and outputs. Upon the processing in step S140 ending, the processing advances to step S141.

In step S141, the end determining unit 461 determines whether or not all line blocks have been processed. In the event that determination is made that there are unprocessed line blocks existing, the processing returns to step S131, and the subsequent processing is repeated on the next unprocessed line block. Also, in the event that determination is made in step S141 that all line blocks have been processed, the bit rate conversion processing ends.

By performing bit rate conversion processing as that above, the data control unit 137 can improve the image quality of the image obtained from data following bit rate conversion.

In FIG. 3, the digital triax system 100 has been described as being configured of one transmission unit 110 and one camera control unit 112, but the numbers of transmission units and camera control units may each be multiple.

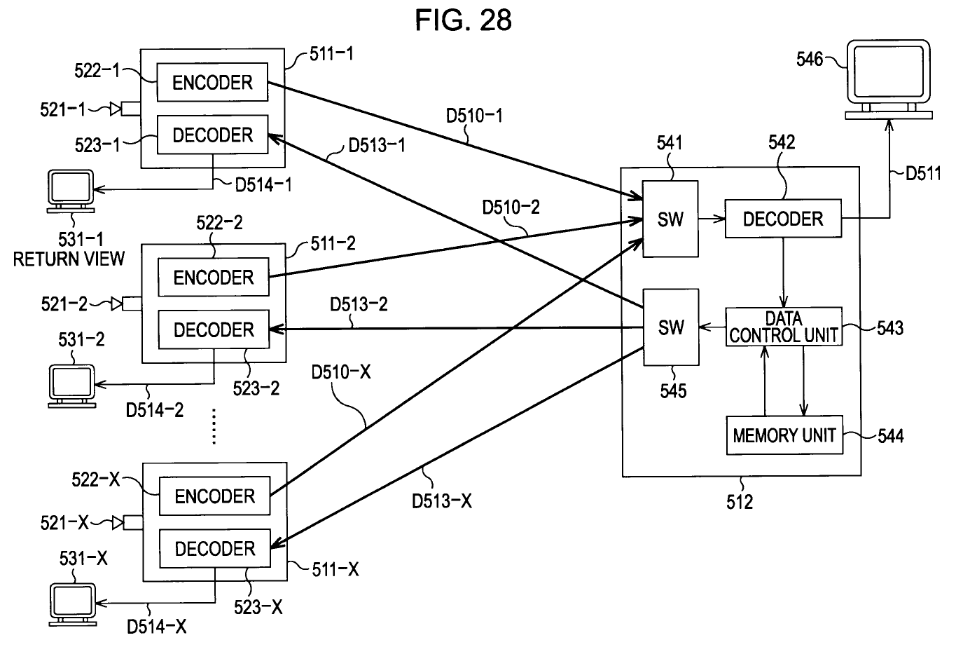

FIG. 28 is a diagram illustrating another configuration example of the digital triax system to which the present invention has been applied. The digital triax system shown in FIG. 28 is a system having X (X is an integer) camera heads (camera head 511-1 through camera head 511-X), and one camera control unit 512, and is a system corresponding to the digital triax system 100 in FIG. 3.

In contrast to the digital triax system 100 in FIG. 3 where one camera control unit 112 controlled one transmission unit 110 (video camera unit 113), with the digital triax system in FIG. 28, one camera control unit 512 controls multiple camera heads (i.e., camera head 511-1 through camera head 511-X). That is to say, the camera head 511-1 through camera head 511-X correspond to the transmission unit 110 in FIG. 3, and the camera control unit 512 corresponds to the camera control unit 112.

The camera head 511-1 has a camera unit 521-1, encoder 522-1 and decoder 523-1, wherein picture data (moving images) taken and obtained at the camera unit 521-1 is encoded at the encoder 522-1, and the encoded data is supplied to the camera control unit 512 via a main line D510-1 which is one system of the transmission cable. Also, the camera head 511-1 decodes encoded data supplied by the camera control unit 512 via a return line D513-1 at the decoder 523-1, and displays the obtained moving images on a return view 531-1 which is a return picture display.

The camera head 511-2 through camera head 511-X also have the same configuration as the camera head 511-1, and perform the same processing. For example, the camera head 511-2 has a camera unit 521-2, encoder 522-2 and decoder 523-2, wherein picture data (moving images) taken and obtained at the camera unit 521-2 is encoded at the encoder 522-2, and the encoded data is supplied to the camera control unit 512 via a main line D510-2 which is one system of the transmission cable. Also, the camera head 511-2 decodes encoded data supplied by the camera control unit 512 via a return line D513-2 at the decoder 523-2, and displays the obtained moving images on a return view 531-2 which is a return picture display.

The camera head 511-X also has a camera unit 521-X, encoder 522-X and decoder 523-X, wherein picture data (moving images) taken and obtained at the camera unit 521-X is encoded at the encoder 522-X, and the encoded data is supplied to the camera control unit 512 via a main line D510-X which is one system of the transmission cable. Also, the camera head 511-X decodes encoded data supplied by the camera control unit 512 via a return line D513-X at the decoder 523-X, and displays the obtained moving images on a return view 531-X which is a return picture display.

The camera control unit 512 has a switch unit (SW) 541, decoder 542, data control unit 543, memory unit 544, and switch unit (SW) 545. The encoded data supplied via the main line D510-1 through main line D510-X is supplied to the switch unit (SW) 541. The switch unit (SW) 541 selects a part from these, and supplies encoded data supplied via the selected line, to the decoder 542. The decoder 542 decodes the encoded data, supplies the decoded picture data to a main view 546 which is a main line picture display via the cable D511, and causes an image to be displayed.

Also, in order to cause the user of the camera head to confirm whether or not the picture sent out from each camera head has been received by the camera control unit 512, the picture data is resent to the camera head as a return video picture. Generally, the bandwidth of the return line D513-1 through return line D513-X for transmitting the return video picture is narrow as compared with the main line D510-1 through main line D510-X.

Accordingly, the camera control unit 512 supplies the encoded data before being decoded at the decoder 542 to the data control unit 543, and causes the bit rate thereof to be converted to a predetermined value. In the same way as the case described with reference to FIG. 16 and so forth, the data control unit 543 uses the memory unit 544 to convert the bit rate of the supplied encoded data to a predetermined value, and supplies the encoded data following conversion of bit rate to the switch unit (SW) 545. Note that description of packetizing will be omitted here, to simplify description. That is to say, a packetizing unit (corresponding to the packetizing unit 302) for packetizing the return encoded data will be described as being included in the data control unit 543.

The switch unit (SW) 545 connects a part of the lines of the return line D513-1 through return line D513-X to the data control unit 543. That is to say, the switch unit (SW) 545 controls the transmission destination of the return encoded data. For example, the switch unit (SW) 545 connects the return line connected to the camera head which is the supplying origin of the encoded data, to the data control unit 543, and supplies the return encoded data as a return video picture to the camera head which is the supplying origin of the encoded data.

The camera head which has obtained the encoded data (return video picture) decodes with a built-in decoder, supplies the decoded picture data to a return view, and causes the image to be displayed. For example, upon return encoded data being supplied from the switch unit (SW) 545 to the camera head 511-1 via the return line D513-1, the decoder 523-1 decodes the encoded data, supplies to a return view 531-1 which is a return picture display via a cable D514-1, and causes the image to be displayed.

This is the same in cases of transmitting encoded data to the camera head 511-2 through camera head 511-X. Note that in the following, in the event that there is no need to make description with the camera head 511-1 through camera head 511-X distinguished one from another, this will be simply called camera head 511. In the same way, in the event that there is no need to make description with the camera unit 521-1 through camera unit 521-X distinguished one from another, this will be simply called camera unit 521, in the event that there is no need to make description with the encoder 522-1 through encoder 522-X distinguished one from another, this will be simply called encoder 522, in the event that there is no need to make description with the decoder 523-1 through decoder 523-X distinguished one from another, this will be simply called decoder 523, in the event that there is no need to make description with the main line D510-1 through main line D510-X distinguished one from another, this will be simply called main line D510, in the event that there is no need to make description with the return line D513-1 through return line D513-X distinguished one from another, this will be simply called return line D513, and in the event that there is no need to make description with the return view 531-1 through return view 531-X distinguished one from another, this will be simply called return view 531.

As described above, the camera control unit 512 shown in FIG. 28 has the same configuration as the camera control unit 112 shown in FIG. 3, and also performs exchange of encoded data via the switch unit (SW) 541 and switch unit (SW) 545, whereby the camera head 511 to serve as the party with which to exchange the encoded data can be selected. That is to say, the user of the camera head 511 selected as the object of control by the camera control unit 512, i.e., the cameraman, can, while shooting, confirm how the taken image is being displayed at the camera control unit 512 side (main view) 546.

With a system for controlling multiple camera heads 511 as well, the camera control unit 512 can easily control the bit rate of return moving image data using the data control unit 543, and can transmit encoded data with low delay.

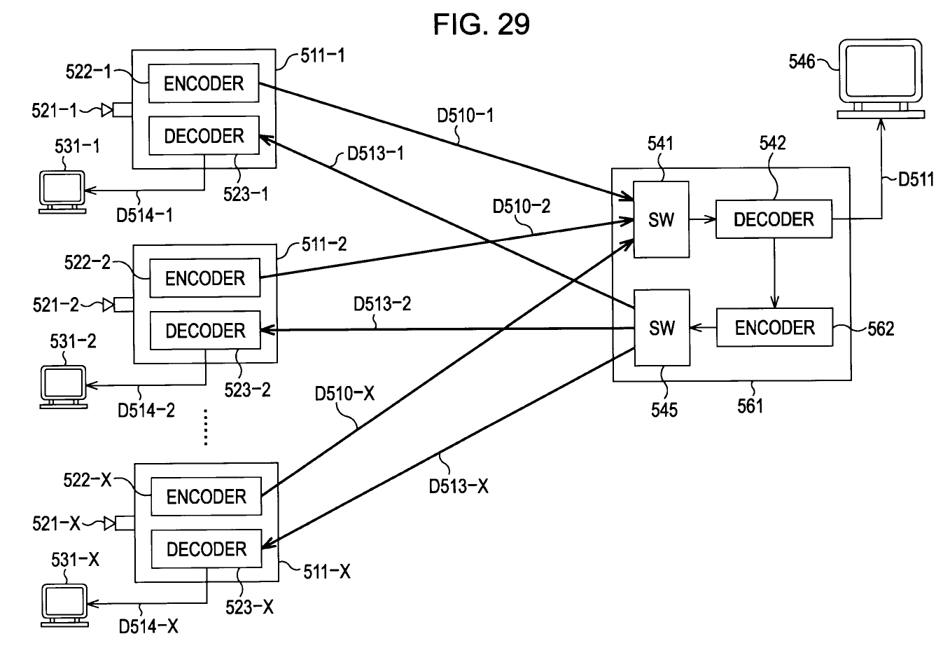

In the case of the conventional digital triax system shown in FIG. 29, the camera control unit 561 has an encoder 562 instead of the data control unit 543 and re-encodes with this encoder 562, the moving image data obtained by decoding at the decoder 532, and outputs. Accordingly, the camera control unit 512 shown in FIG. 28 can convert the bit rate of the moving image data to a desired value easier than with the camera control unit 561 shown in FIG. 29, and can transmit encoded data with low delay.

That is to say, the delay time from shooting to the return moving image being displayed on the return view is shorter with the case of the system in FIG. 28 as to the case of the system in FIG. 29, so the cameraman which is the user of the camera head 511 can confirm the return moving image with low delay. Accordingly, the cameraman can easily perform shooting work while confirming the return moving image. Particularly, as with the digital triax system shown in FIG. 28, in a case of the camera control unit 512 controlling multiple camera heads 511, switching of the object of control occurs, so in the event that the delay time from shooting to the return moving image being displayed is too long as to the switching gap, the cameraman might need to shoot with scarcely being able to confirm the moving image thereof. That is to say, as shown in FIG. 28, the delay time being shortened by the camera control unit 512 easily controlling the bit rate of encoded data has even further important implications.

Note that the camera control unit 512 may be arranged to control multiple camera heads 511 at the same time. In this case, an arrangement may be made wherein the camera control unit 512 transmits the encoded data of each moving image supplied from each camera head 511, i.e., mutually different encoded data, to the supplying origin of each, or an arrangement may be made wherein encoded data of a single moving image simultaneously displaying each moving image supplied from each camera head 511, i.e., shared encoded data, is supplied to the all supplying origins.

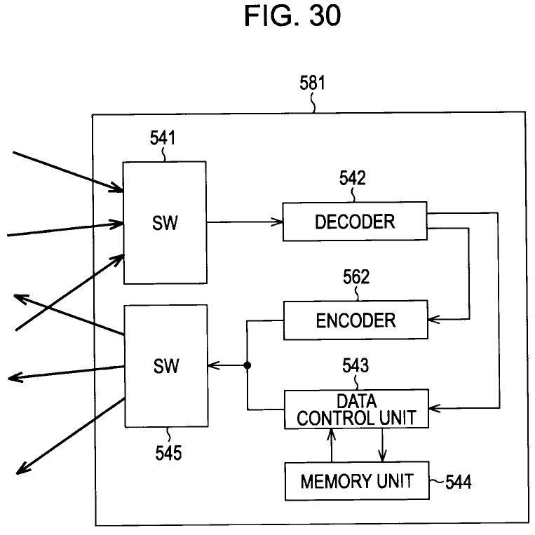

Also, as shown in FIG. 30, an arrangement may be used wherein, instead of the camera control unit 561, a camera control unit 581 having both a data control unit 543 and encoder 562 is used. The camera control unit 581 optionally selects one of the data control unit 543 and encoder 562, and uses for generating return encoded data. For example, in the event of lowering the bit rate of the return encoded data as to the bit rate of the main line encoded data, the camera control unit 581 selects the data control unit 543, supplies the encoded data before decoding and causes bit rate conversion, and thereby can perform conversion of bit rate easily and at high speed. Also, in the event of raising the bit rate of the return encoded data as to the bit rate of the main line encoded data, the camera control unit 581 selects the encoder, supplies the moving image data after decoding and causes bit rate conversion, and thereby can perform conversion of bit rate appropriately.

Such a digital triax system is used at broadcast stations or the like, or used in relaying and the like of events such as sports and concerts and the like, for example. This can also be applied as systems for centrally managing surveillance cameras installed in facilities.

Note that the above-described data control unit may be applied to any sort of system or device, and for example, the data control unit may be made to serve as a standalone device. That is to say, an arrangement may be made to function as a bit rate conversion device. Also, for example, in an image encoding device for encoding image data, an arrangement may be made wherein the data control unit controls the output bit rate of an encoding unit which performs encoding processing. Also, with an image decoding device wherein encoded data, where image data has been encoded, is decoded, an arrangement may be made wherein the data control unit controls the input bit rate of the decoding unit which performs decoding processing.

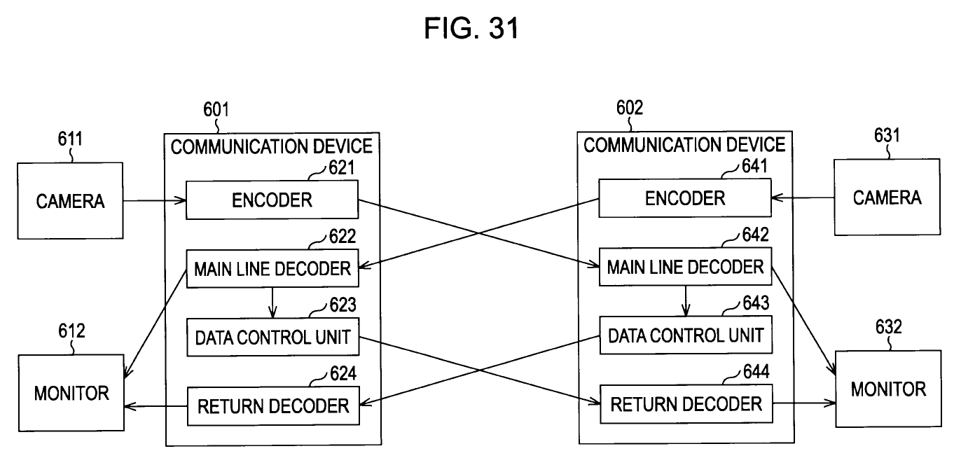

For example, as shown in FIG. 31, this may be applied to a system wherein return images are mutually transmitted/received between communication devices which exchange main line image data.

With the communication system shown in FIG. 31, a communication device 601 and communication device 602 exchange moving image data. The communication device 601 supplies moving image data obtained by imaging at a camera 611 as main line moving image data to the communication device 602, and obtains main line moving image data supplied from the communication device 602 and return moving image data corresponding to the main line moving image data supplied by the communication device 601 itself, and causes these images to be displayed on a monitor 612.

The communication device 601 has an encoder 621, main line decoder 622, data control unit 623, and return decoder 624. The communication device 601 encodes the moving image data supplied form the camera 611, and supplies the obtained encoded data to the communication device 602. Also, the communication device 601 decodes the main line encoded data supplied by the communication device 602 at the main line decoder 622, and causes the images to be displayed on the monitor 612. Also, the communication device 601 converts the bit rate of the encoded data before decoding supplied from that communication device 602 at the data control unit 623, and supplies to the communication device 602 as return encoded data. Further, the communication device 601 obtains return encoded data supplied by the communication device 602, decodes at the return decoder 624, and causes the images to be displayed on the monitor 612.

In the same way, the communication device 602 has an encoder 641, main line decoder 642, data control unit 643, and return decoder 644. The communication device 602 encodes the moving image data supplied form the camera 631, and supplies the obtained encoded data to the communication device 601. Also, the communication device 602 decodes the main line encoded data supplied by the communication device 601 at the main line decoder 622, and causes the images to be displayed on the monitor 632. Also, the communication device 602 converts the bit rate of the encoded data before decoding supplied from that communication device 601 at the data control unit 643, and supplies to the communication device 601 as return encoded data. Further, the communication device 602 obtains return encoded data supplied by the communication device 601, decodes at the return decoder 644, and causes the images to be displayed on the monitor 632.

This encoder 621 and encoder 641 correspond to the video signal encoding unit 120 in FIG. 3, the main line decoder 622 and main line decoder 642 correspond to the video signal decoding unit 136 in FIG. 3, the data control unit 623 and data control unit 643 correspond to the data control unit 137 in FIG. 3, and the return decoder 624 and return decoder 644 correspond to the video signal decoding unit 121 in FIG. 3.

That is to say, both the communication device 601 and communication device 602 have the configuration and functions of both the transmission unit 110 and camera control unit 112 in FIG. 3, and supply each other the encoded data of shot images obtained at the own side camera (camera 611 or camera 631) to the other party side, and obtain the main line moving images which are shot images shot at the other party side camera that are supplied from the other party side, and encoded data of return moving images of shot images transferred by itself to the other party side.

At this time, the communication device 601 and communication device 602 can use the data control unit 623 or data control unit 643 as with the case in FIG. 3, whereby the bit rate of the return encoded data can be controlled easily and at high speed, and return encoded data can be transmitted at even lower delay.

Note that the arrows between the communication device 601, communication device 602, camera 611, monitor 612, camera 631, and monitor 632 indicate the transmission direction of data, and do not indicate busses (or cables) as such. That is to say, the number of busses (or cables) between the devices is optional.

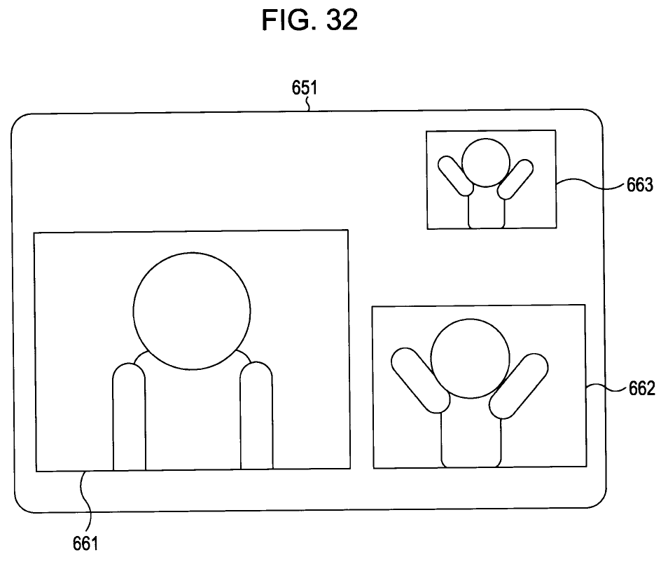

FIG. 32 illustrates a display example of images on the monitor 612 or monitor 632. Displayed on a display screen 651 shown in FIG. 32 are, besides a moving image 661 of the other party of communication shot at the camera 631, a moving image 662 of itself shot at the camera 611, and return moving image 663. The moving image 662 is a moving image supplied to the communication device which is the other party of communication for main line, and the moving image 663 is a return moving image corresponding to that moving image 662. That is to say, the moving image 663 is an image for confirming how the moving image 662 has been displayed on the monitor of the other party of communication.

Accordingly, the user of the communication device 601 side uses the camera 611 and monitor 612, and the user of the communication device 602 side uses the camera 631 and monitor 632, and can perform communication (exchange of moving images) with each other. Note that audio will be omitted for simplification of explanation. Thus, the users can see images such as exemplarily shown in FIG. 32, and can simultaneously see not only taken images of the other party, but also taken images shot at the own side camera, and further, images for confirming how the taken images are displayed at the other party side.

The moving image 662 and the moving image 663 are moving images of the same contents, but as described above, the moving image data is transmitted in communication between the communication devices having been compression encoded. Accordingly, in a normal case, the image displayed at the other party side (moving image 663) has the image quality deteriorated as to that when taken (moving image 662), and the way in which it looks might be different, and accordingly conversation between users might not hold up. For example, a picture which can be confirmed in the moving image 662 might not be able to be confirmed in the moving image 663, and the users might not be able to converse with each other based on that image. Accordingly, being able to confirm how the moving image is being displayed at the other party side is very important.

At this time, in the event that there is a long delay time occurring until display of the confirmation moving image (i.e., in the event that the delay time between the moving image 662 and moving image 663 is too long), the users might find conversation (calling) while confirming the moving image to be difficult. Accordingly, for the communication device 601 and communication device 602 to be able to transmit return encoded data at lower delay is more important in accordance with the necessity to perform conversation while confirming the moving image 663.

Also, by enabling control of the return encoded data to be easily performed, the band required for transmission of the return encoded data can be easily reduced. That is, the return encoded data can be transmitted at a suitable bit rate in accordance with band restrictions of a transmission path or circumstances of a display screen, for example. In this case as well, the encoded data can be transmitted with low delay.

Such a system can be used for, for example, a videoconferencing system for exchanging moving images between meeting rooms which are apart from each other, remote medical systems wherein physicians examine patients at remote locations, and so forth. As described above, the system shown in FIG. 31 enables return encoded data to be transmitted with low delay, so for example, presentations and instructions can be performed efficiently, and examinations can be performed accurately.

Note that in the above, description has been made such that in the case of controlling the bit rate of the encoded data at the data control unit 137, the data control unit 137 counts the code amount, but an arrangement may be made wherein, for example, the encoded data to transmit is marked at the position where the target code amount corresponding to the bit rate following conversion reaches by a predetermined method at the video signal encoding unit 120 which is the encoder. That is to say, the video signal encoding unit 120 determines a code stream cutoff point at the data control unit 137. In this case, the data control unit 137 can easily identify code stream cutoff simply by detecting the marked position. That is to say, the data control unit 137 can omit counting of the code amount. This marking can be performed by any method. For example, flag information indicating the code stream cutoff position may be provided in the header of the packet. Of course, other methods may be used as well.

Also, in the above, description has been made such that encoded data is temporarily accumulated at the data control unit 137, but it is sufficient for the data control unit 137 to count the code amount of the obtained encoded data, and only needs to output the encoded data of the necessary coding amount worth, and does not necessarily have to temporarily accumulate the obtained encoded data. For example, an arrangement may be made wherein the data control unit 137 obtains the encoded data supplied in order from lowband component, outputs the encoded data while counting the code amount of the obtained encoded data, and stops output of the encoded data at the point that the count value reaches the target code amount.

Further, with each system described above, the data transmission paths, such as busses, networks, etc., may be cable or may be wireless.

As described above, the present invention can be applied to various embodiments, and can be easily applied to various applications (i.e., has high versatility), which also is a great advantage thereof.

Now, with the digital triax system described above, OFDM (Orthogonal Frequency Division Multiplexing (Orthogonal Frequency Division Multiplexing)) is used for data transmission over a triax cable (coaxial cable). OFDM is a method which is a type of digital modulation, wherein orthogonality is used to array multiple carrier waves densely in a way that there is no mutual interference, and transmitting data in parallel over a frequency axis. With OFDM, using orthogonality enables the usage efficiency of frequencies to be improved, and bandwidth transmission efficiently using a narrow range of frequencies can be realized. With the above-described digital triax system, using a plurality of such OFDM and subjecting each of the modulated signals to frequency multiplexing for data transmission realizes data transmission with even greater capacity.

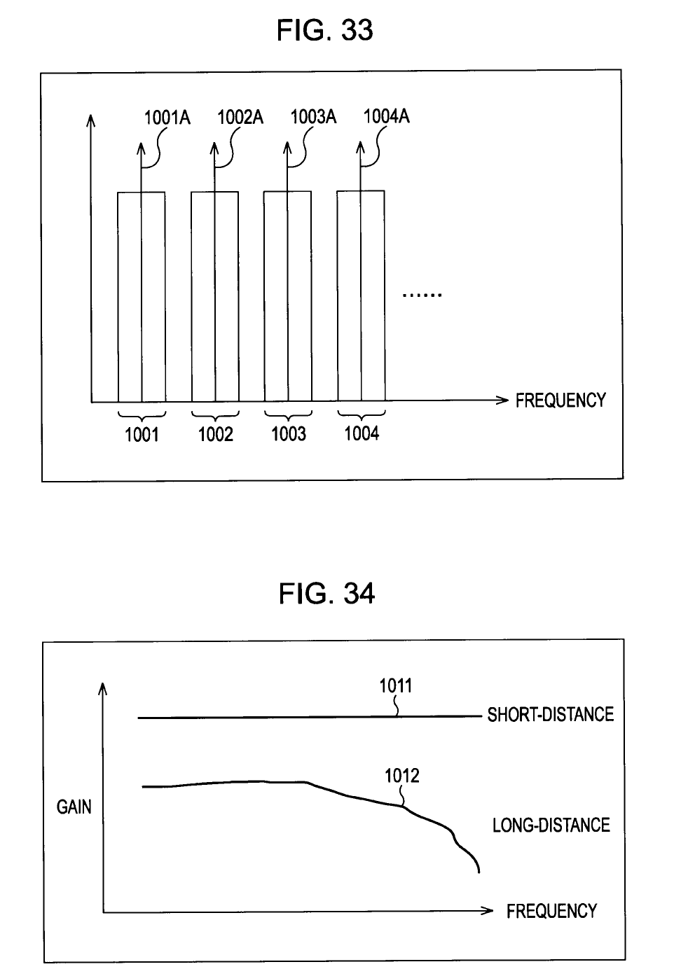

FIG. 33 illustrates an example of frequency distribution of data to be transmitted with a digital triax system. As described above, the data to be transmitted is modulated to different frequency bands one from another by multiple OFDM modulators. Accordingly, as shown in FIG. 33, the modulated data is distributed into multiple OFDM channels with different bands one from another (OFDM channel 1001, OFDM channel 1002, OFDM channel 1003, OFDM channel 1004, . . . ). In FIG. 33, arrow 1001A indicates the center of the band of the OFDM channel 1001. In the same way, arrow 1002A through arrow 1004A each indicate the centers of the bands of the OFDM channel 1002 through OFDM channel 1004. The frequencies of the arrow 1001A through arrow 1004A (the centers of each OFDM channel) and the bandwidths of each OFDM channel are determined beforehand so as to not overlap.

Thus, with the digital triax system, the data is transmitted in multiple bands, but in the case of data transmission with a triax cable, there is a property in that highband gain readily attenuates due to various causes such as the cable length, heaviness, material, etc., of the triax cable, for example.

The graph shown in FIG. 34 illustrates an example of the way in which attenuation of gain occurs due to cable length with the triax cable. In the graph in FIG. 34, line 1011 indicates the way in which gain for each frequency is in a case that the cable length of the triax cable is short, and line 1012 indicates the way in which gain for each frequency is in a case that the cable length of the triax cable is long. As indicated by line 1011, in the event that the cable length is short, the gain of the highband component is generally the same as the gain of the lowband component. Conversely, as indicated by line 1021, in the event that the cable length is long, the gain of the highband component is smaller than the gain of the lowband component.

That is to say, in the event that the cable length is long, the attenuation rate is greater for the highband component as compared with the lowband component, symbol error rate in data transmission is higher due to increased noise component, and consequently the error rate may be higher in the decoding processing. With a digital triax system, a single data is appropriated to multiple OFDM channels, so in the event that decoding processing of the highband component fails, decoding of the entire image might not be able to be performed (i.e., the decoded image is deteriorated).

With a digital triax system, low delay data transmission is demanded as described above, so performing reduction of symbol error rate by retransmission, redundant data buffering, and so forth, is impossible for all practical purposes.

Accordingly, in order to avoid failure of decoding processing, there is the need to increase the appropriation amount of error correction bits and so forth to lower the transmission rate, and perform data transmission in a more stable manner, but in the event that only the highband component has great attenuation rate and sufficient gain is obtained in the lowband component, performing rate control to match the highband component might unnecessarily lower the transmission efficiency. As described above, with a digital triax system, low delay data transmission is demanded, so the higher the data transmission efficiency is, the better.

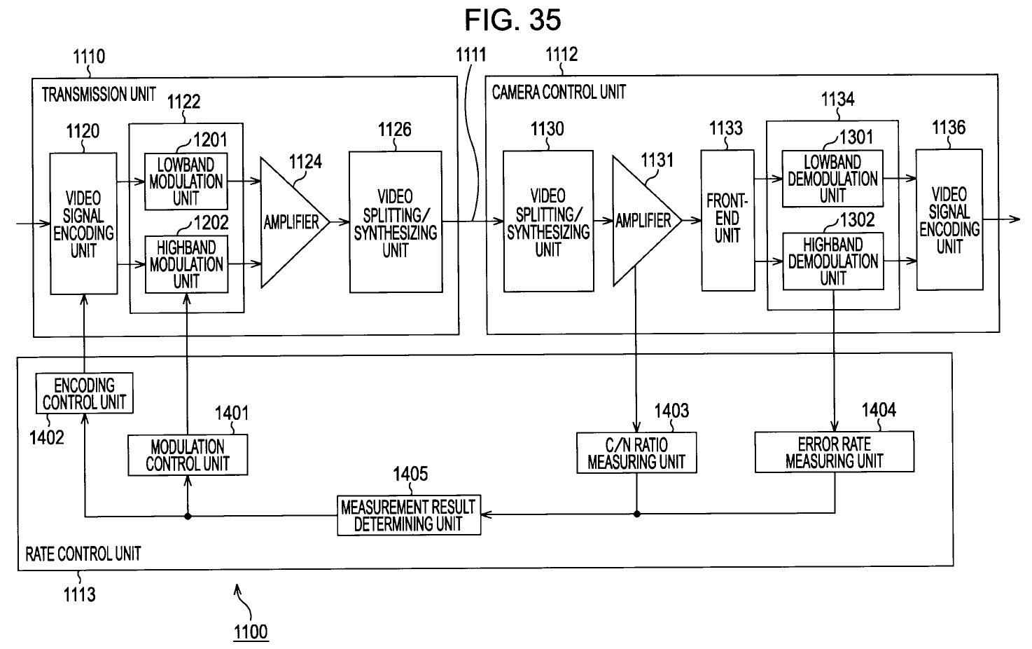

Accordingly, an arrangement may be made wherein OFDM control for the purpose of rate control is performed separately at the highband side and lowband side. FIG. 35 is a block diagram illustrating a configuration example of a digital triax system in that case. The digital triax system 1100 shown in FIG. 35 is a system which is basically the same as the digital triax system 100 shown in FIG. 3, and has basically the same components as the digital triax system 100, but in FIG. 35, only the portions necessary for description are shown.

The digital triax system 1100 has a transmission unit 1110 and camera control unit 1112 connected to each other by a triax cable 1111. The transmission unit 1110 has basically the same configuration as the transmission unit 110 in FIG. 3, and the triax cable 1111 is basically the same coaxial cable as with the triax cable 111 in FIG. 3, and the camera control unit 1112 has basically the same configuration as the camera control unit 112 in FIG. 3.

In FIG. 35, only the configuration relating to the operations of the transmission unit 1110 encoding video signals supplied from an unshown video camera unit and modulating by OFDM, transmitting the modulated signals to the camera control unit 1112 via the triax cable 1111, and the camera control unit 1112 demodulating and decoding the received modulated signals and outputting to the downstream system, are shown to facilitate description.

That is to say, the transmission unit 1110 has a video signal encoding unit 1120 the same as the video signal encoding unit 120 of the transmission unit 110, a digital modulation unit 1122 the same as the digital modulation unit 122 of the transmission unit 110, an amplifier 1124 the same as the amplifier 124 of the transmission unit 110, and a video splitting/synthesizing unit 1126 the same as the video splitting/synthesizing unit 126 of the transmission unit 110.

The video signal encoding unit 1120 compression encodes video signals supplied form the unshown video camera unit with the same method as the video signal encoding unit 120 described with reference to FIG. 4, and supplies the encoded data (encoded stream) to the digital modulation unit 1122.

AS shown in FIG. 35, the digital modulation unit 1122 has a lowband modulation unit 1201 and highband modulation unit 1202, and modulates the encoded data of the two frequency bands of lowband and highband by OFDM method (hereafter, to modulate with the OFDM method will be referred to as “to OFDM”). That is to say, the digital modulation unit 1122 divides the encoded data supplied from the video signal encoding unit 1120 into two, and modulates each at mutually different bands (OFDM channels) as described with reference to FIG. 33, using the lowband modulation unit 1201 and highband modulation unit 1202 (of course, the lowband modulation unit 1201 performs OFDM at a lower band than the highband modulation unit 1202).

Note that here, description is made assuming that the digital modulation unit 1122 has two modulation units (lowband modulation unit 1201 and highband modulation unit 1202) and performs modulation with two OFDM channels, but the number of modulation units which the digital modulation unit 1122 has (i.e., the number of OFDM channels) may be any number as long as it is multiple and is a realizable number.

The lowband modulation unit 1201 and highband modulation unit 1202 each supply modulated signals wherein the encoded data has been subjected to OFDM, to the amplifier 1124.

The amplifier 1124 subjects the modulated signals to frequency multiplexing and amplification as shown in FIG. 33, and supplies to the video splitting/synthesizing unit 1126. The video splitting/synthesizing unit 1126 synthesizes the supplied modulated signals of the video signals with other signals transmitted along with the modulated signals, and transmits the synthesized signals to the camera control unit 1112 via the triax cable 1111.

Thus, the video signals subjected to OFDM are transmitted to the camera control unit 1112 via the triax cable 1111.

The camera control unit 1112 has a video splitting/synthesizing unit 1130 the same as the video splitting/synthesizing unit 130 of the camera control unit 112, an amplifier 1131 the same as the amplifier 131 of the camera control unit 112, a front-end unit 1133 the same as the front-end unit 133 of the camera control unit 112, a digital demodulation unit 1134 the same as the digital demodulation unit 134 of the camera control unit 112, and a video signal decoding unit 1136 the same as the video signal decoding unit 136 of the camera control unit 112.

Upon receiving signals transmitted from the transmission unit 1110, the video splitting/synthesizing unit 1130 separates and extracts the modulated signals of the video signals from the signals, and supplies to the amplifier 1131. The amplifier 1131 amplifies the signals, and supplies to the front end unit 1133. The front end unit 1133 has a gain control unit for adjusting the gain of input signals, and a filter unit for performing predetermined filtering processing on input signals, as with the front end unit 133, and performs gain adjustment and filtering processing and so forth on the modulated signals supplied from the amplifier 1131, and supplies the signals following processing to the digital demodulation unit 1134.

As shown in FIG. 35, the digital demodulation unit 1134 has a lowband demodulation unit 1301 and highband demodulation unit 1302, and demodulates by OFDM method the modulated signals subjected to OFDM with the two frequency bands of lowband and highband (OFDM channels), using the lowband demodulation unit 1301 and highband demodulation unit 1302, in their respective bands (of course, the lowband demodulation unit 1301 performs demodulation of modulated signals of an OFDM channel at a lower band than the highband demodulation unit 1302).

Note that here, description is made assuming that the digital demodulation unit 1134 has two demodulation units (lowband demodulation unit 1301 and highband demodulation unit 1302) and performs demodulation with two OFDM channels, but the number of demodulation units which the digital demodulation unit 1134 has (i.e., the number of OFDM channels) may be any number as long as it is the same as the number of modulation units which the digital modulation unit 1122 has (i.e., the number of OFDM channels).

The lowband demodulation unit 1301 and highband demodulation unit 1302 each supply the encoded data obtained by being demodulated to the video signal decoding unit 1136.

The video signal decoding unit 1136 synthesizes the encoded data supplied from the lowband demodulation unit 1301 and highband demodulation unit 1302 into one by a method corresponding to the dividing method thereof, and decompresses and decodes the encoded data with the same method as the video signal decoding unit 136 described with reference to FIG. 12 and so forth. The video signal decoding unit 1136 outputs the obtained video signals to a downstream processing unit.

Note that the digital triax system 1100 has a rate control unit 1113 for performing control so as to further perform data transmission in a stable manner such that failure does not occur (such that decoding processing does not fail) as shown in FIG. 35, with regard to the system of data transmission between the transmission unit 1110 and camera control unit 1112 via the triax cable 1111 such as described above.

The rate control unit 1113 includes a modulation control unit 1401, encoding control unit 1402, C/N ratio (Carrier to Noise ratio) measuring unit 1403, and error rate measuring unit 1404.

The modulation control unit 1401 controls the constellation signal point distance and error correction bit appropriation amount of the modulation which the digital modulation unit 1122 (lowband modulation unit 1201 and highband modulation unit 1202) performs. With OFDM, digital modulation methods such as PSK (Phase Shift Keying: phase modulation) (including DPSK (Differential Phase Shift Keying: differential phase modulation)) and QAM (Quadrature Amplitude Modulation: Quadrature Amplitude Modulation) are employed. Constellation is primarily one observation method of digital modulation waves, and is for observing the spread of the locus of signals drawn so as to travel back and forth ideal signal points at mutually orthogonal I-Q coordinates. The constellation signal point distance indicates the distance between signal points at the I-Q coordinates.

With a constellation, the greater the noise component included in the signal is, the greater the locus of signals spreads. That is to say, generally, the shorter the signal distance is, the easier symbol error occurs due to noise component, and the weaker the noise component resistance of decoding processing becomes (is easier to fail in decoding processing).

Accordingly, the modulation control unit 1401 controls the length of signal point distance in each of the modulation processing by setting modulation methods for each of the lowband modulation unit 1201 and highband modulation unit 1202 based on the decay rate of each of the highband component and lowband component, such that excessive rise in symbol error rate can be suppressed and data transmission can be performed in a stable manner. Note that the modulation methods for each of the case of small and case of great attenuation rate which the modulation control unit 1401 sets are set beforehand.

Further, the modulation control unit 1401 sets the error correction bit appropriation amount as to data (the error correction bit length to be appropriated to data) for each of the lowband modulation unit 1201 and highband modulation unit 1202, based on the decay rate of the highband component and lowband component, such that excessive rise in symbol error rate can be further suppressed and data transmission can be performed in an even more stable manner. Increasing the error correction bit appropriation amount (making the error correction bit length to be longer) means that the data transmission efficiency deteriorates due to increase in originally-unnecessary data amount, but the symbol error rate due to noise component can be lowered, so the resistance of the decoding processing as to noise component can be strengthened. Note that the error correction bit appropriation amounts for each of the case of small and case of great attenuation rate which the modulation control unit 1401 sets are set beforehand.

The encoding control unit 1402 controls the compression rate of compression encoding which the video signal encoding unit 1120 performs. The encoding control unit 1402 controls the video signal encoding unit 1120 and sets the compression rate, wherein in the event that the attenuation is great, the compression rate is set high so as to reduce the data amount of encoded data, reducing the data transmission rate. Note that the values for compression rate for each of the case of small and case of great attenuation rate which the modulation control unit 1401 sets are set beforehand.

The C/N ratio measuring unit 1403 measures the C/N ratio which is the ratio of carrier wave and noise, with regard to the modulated signals received at the video splitting/synthesizing unit 1130 and supplied to the amplifier 1131. The CN ratio (CNR) can be obtained by the following Expression (4), for example. The unit is [dB].

CNR[dB]=10 log(PC/PN) (4)

where PN is noise power [W], and PC is carrier wave power [W]

The C/N ratio measuring unit 1403 supplies the measurement results (C/N ratio) to a measurement result determining unit 1405.

Based on the processing results of demodulation processing by the digital demodulation unit 1134 (lowband demodulation unit 1301 and highband demodulation unit 1302), the error rate measuring unit 1404 measures the error rate (symbol error occurrence rate) in the demodulation processing thereof. The error rate measuring unit 140 supplies the measurement results (error rate) to the measurement result determining unit 1405.

The measurement result determining unit 1405 determines the attenuation rate of the lowband component and high band component of the transmitted data based on at least one of the C/N ratio of the transmitted data received from the camera control unit 1112 that has been measured by the C/N ratio measuring unit 1403, and the error rate in demodulation processing that has been measured by the error rate measuring unit 1404, and supplies the determination result thereof to the modulation control unit 1401 and the encoding control unit 1402. The modulation control unit 1401 and encoding control unit 1402 each perform control such as described above, based on the determination results (e.g., whether or not the attenuation rate of the highband component is clearly higher than the lowband component).

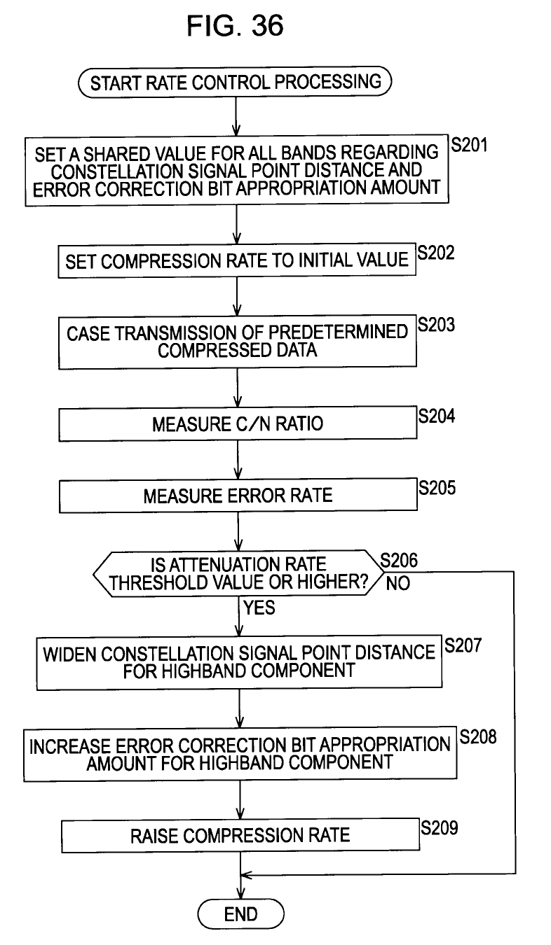

An example of the flow of rate control processing executed at this rate control unit 1113 will be described with reference to the flowchart in FIG. 36.

The rate control processing is executed at a predetermined timing, such as at the time of starting data transmission between the transmission unit 1110 and the camera control unit 1112, for example. Upon the rate control processing starting, in step S201 the modulation control unit 1401 controls the digital modulation unit 1122 to set the constellation signal point distance and error correction bit appropriation amount to a common value for all bands, determined beforehand to be set to in the event that the attenuation rate is not great. That is to say, the modulation control unit 1401 sets the same modulation method and the same error correction bit appropriation amount for both the lowband modulation unit 1201 and highband modulation unit 1202.

In step S202, the encoding control unit 1402 controls the video signal encoding unit 1120 to set the compression ratio to a predetermined initial value determined beforehand to be set to in the event that the attenuation rate is not great.

In a state with the lowband and highband both set to the same in this way, in step S203 the modulation control unit 1401 and encoding control unit 1402 control each part of the transmission unit 1110 so as to cause execution of each processing at the set values, and to cause transmission of predetermined compression data determined beforehand to the camera control unit 1112.

For example, the rate control unit 1113 (modulation control unit 1401 and encoding control unit 1402) causes predetermined video signals (image data) determined beforehand to be input to the transmission unit 1110, causes the video signal encoding unit 1120 to encode the video signals, causes the digital modulation unit 1122 to perform OFDM of the encoded data, causes the amplifier 1124 to amplify the modulated signals, and causes the video splitting/synthesizing unit 1126 to transmit the signals. The transmission data thus transmitted is transmitted via the triax cable 1111, and received at the camera control unit 1112.

The C/N ratio measuring unit 1403 measures the C/N ratio of the transmission data transmitted in this way for each OFDM channel in step S204, and supplies the measurement results to the measurement result determining unit 1405. In step S205 the error rate measuring unit 1404 measures the symbol error occurrence rate (error rate) in demodulation processing by the digital demodulation unit 1134 for each OFDM channel, and supplies the measurement results to the measurement result determining unit 1405.

In step S206, the measurement result determining unit 1405 determines whether or not the attenuation rate of the highband component of the transmitted data is at or above a predetermined threshold value, based on the C/N ratio supplied from the C/N ratio measuring unit 1403 and the error rate supplied from the error rate measuring unit 1404. In the event that the attenuation rate of the highband of the transmitted data is clearly higher than the attenuation rate of the lowband, and the attenuation rate of the highband is determined to be at or above the threshold value, the measurement result determining unit 1405 advances the processing to step S207.

In step S207, the modulation control unit 1401 converts the modulation method of the highband modulation unit 1202 so as to widen the constellation signal point distance of the highband component, and further, in step S208, changes settings so as to increase the error correction bit appropriation amount of the highband modulation unit 1202.

Also, in step S208 the encoding control unit 1402 controls the video signal encoding unit 1120 to raise the compression rate.

Upon changing settings as described above, the rate control unit 1113 ends rate control processing.

Also, in the event that the attenuation rate of the highband is around the same as the lowband in step S206, and determination is made that the attenuation rate of the highband is smaller than the threshold value, the measurement result determining unit 1405 omits the processing of step S207 through step S209, and ends the rate control processing.

As described above, the rate control unit 1113 controls the signal point distance (modulation method) and error bit appropriation amount for each modulation unit (each OFDM channel), whereby the transmission unit 1110 and camera control unit 1112 can perform data transmission in a more stable and more efficient manner. Accordingly, a more stable and low-delay digital triax system can be realized.

Note that in the above, description has been made with regard to a case of two OFDM channels (a case wherein the digital modulation unit 1122 has the two modulation units of the lowband modulation unit 1201 and highband modulation unit 1202) to facilitate description, but the number of OFDM channels (number of modulation units) is optional, and for example, there may be three or more modulation units. In this case, these modulation units may be divided into two groups of highband and lowband according to the OFDM channel band, with rate control being performed as described above on each group as described with reference to the flowchart in FIG. 36, or the rate control described with reference to the flowchart in FIG. 36 may be performed on three or more modulation units (or groups).

For example, in the event that there are three modulation units, the attenuation rate may be determined for each of the modulation units. That is to say, in this case, the C/N ratio and error rate are measured for the transmission data regarding the three of lowband, midband, and highband. The settings of each modulation unit are set to a value (method) common to all bands as described above for the initial value, and in the event that only the highband has great attenuation rate, only the settings of the highband modulation unit are changed, and in the event that the attenuation rate of the highband and midband is great, only the settings of the highband and midband modulation units are changed. The settings of compression rate of the video signal encoding unit 1120 are arranged such that the greater the attenuation rate of a band is, the greater the compression rate is.

By performing control with finer bands in this way, control more suitable to attenuation properties of the triax cable can be performed, and data transmission efficiency can be further improved in a stable state.

Note that any rate control may be employed as long as a method which is more suitable control for attenuation properties of the triax cable, and in the event of performing rate control on three or more modulation units as described above, the control method thereof may be a method other than that described above, such as changing the error correction bit appropriation amount for each band, or the like.

Also, while description has been made in the above that rate control is performed at a predetermined timing such as at the time of starting data transmission, the timing and number of times of execution of this rate control is optional, and for example, and arrangement may be made wherein the rate control unit 1113 measures the actual attenuation rate (C/N ratio and error rate) during actual data transmission as well, and controls at least one of modulation method, error correction bit appropriation amount, and compression rate, in real time (instantaneously).

Further, while measurement of the C/N ratio and error rate has been described as indicators for determining attenuation rate, what sort of parameters are used in what way to calculate or determine attenuation rate is optional. Accordingly, parameters other than those described above, such as S/N ratio (Signal Noise Ratio) for example, may be measured.

Also, while description has been made in FIG. 35 regarding only a case wherein the rate control unit 1113 controls data transmission performed from the transmission unit 1110 to the camera control unit 1112 via the triax cable 1111, but as described above, with a digital triax system, there are cases wherein data transmission is performed from the camera control unit 1112 toward the transmission unit 1110 as well. The rate control unit 1113 may perform rate control regarding such a transmission system as well. In this case as well, regarding the data transmission of the transmission system, the method is basically the same as with the case shown in FIG. 35, even though the direction changes, so the rate control unit 1113 can perform rate control in the same way as with the case described with reference to FIG. 35 and FIG. 36.

Further, while description has been made in the above that the rate control unit 1113 is configured separately from the transmission unit 1110 and the camera control unit 1112, but the configuration method of each portion of the rate control unit 1113 is optional, and an arrangement may be made wherein, for example, the rate control unit 1113 is built into one of the transmission unit 1110 or the camera control unit 1112. Also, for example, an arrangement may be made wherein the transmission unit 1110 and the camera control unit 1112 each have built in different portions of the rate control unit 1113, such as for example, the modulation control unit 1401 and encoding control unit 1402 being built into the transmission unit 1110, and the C/N ration measuring unit 1403, error rate measuring unit 1404, and measurement result determining unit 1405 being built into the camera control unit 1112, and so forth.

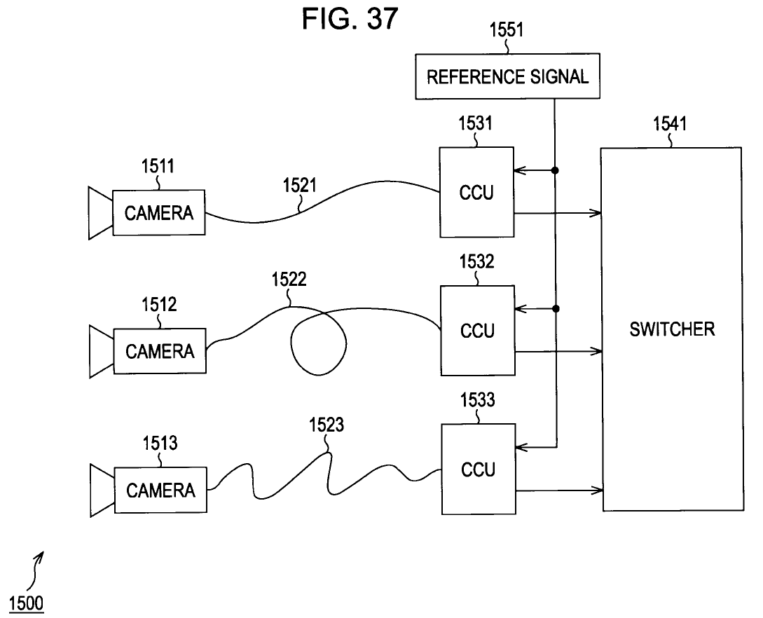

Now, a digital triax system such as shown in FIG. 3 for example, is often actually realized as a large system wherein multiple cameras and multiple CCUs are combined, as shown in FIG. 37. For example, with a digital triax system 1500 shown in FIG. 37, the configuration is such that three of the configurations shown in FIG. 3 are compounded. That is to say, with the digital triax system 1500, camera 1511 through camera 1513 corresponding to the video camera unit 113 and transmission unit 110 in FIG. 3 are each connected to CCU 1531 through CCU 1533 corresponding to the camera control unit 112 in FIG. 3, with triax cable 1521 through triax cable 1523 corresponding to the triax cable 111 in FIG. 3, such that three transmission systems the same as the transmission system shown in FIG. 3 are formed. Note that the data output from each of the CCU 1531 through CCU 1533 is put together as data of a single system by selection operations by a switcher 1541.

For example, with a single system digital triax system such as described with reference to FIG. 3, in order to make the delay from shooting with a camera (generating image data) to output of the image data from a CCU to be low delay, it is sufficient that the encoders built into each camera and decoders built into the CCU operate based on synchronization signals unique to each, with the encoder executing encoding processing upon image data being obtained by shooting by the camera, and the decoder decoding the encoded data upon encoded data being transmitted to the CCU. However, with a system having multiple transmission system such as shown in FIG. 37, there is the need to match the timing (phase) of image data output from each CCU, in order to put together at the switcher 1541.

Accordingly, as shown in FIG. 37, a reference signal 1551 which is an external synchronization signal is supplied to not only each CCU but to each camera as well, via each CCU. That is to say, the operations of the encoders built into each camera and the decoders built into each CCU are all synchronized to this reference signal 1551. Thus, data transmission of each system, i.e., the output timing of image data from each CCU, can be synchronized with each other, without performing unnecessary buffering or the like. That is to say, synchronization among systems can be held while maintaining low delay.

However, generally, data transmission from a camera to a CCU cannot be performed with no delay. That is to say, in order to not perform unnecessary buffering (i.e., suppress increase in delay), it is desirable that the execution timing of the decoding processing of the decoder built into the CCU be somewhat later as to the execution timing of the encoding processing by the encoder built into the camera.

The suitable delay time of this execution timing depends on the delay time of the transmission system, and accordingly might differ between systems due to various factors, such as cable length or the like, for example. Accordingly, an arrangement may be made wherein a suitable value is obtained for this delay time for each system, and set the synchronization timing between the encoder and decoder based on the value for each system. By setting synchronization timing for each system in this way, synchronization can be made between systems based on the reference signal, while maintaining further low delay.

Calculation of the delay time is performed by transmitting image data from the camera to CCU in the same way as in real. At this time, in the event that the data amount of the image data to be transmitted is unnecessarily great (i.e., the content of the image is complex), the delay time might be set greater than the delay time necessary for actually performing data transmission. That is to say, unnecessary delay time might occur in data transmission.

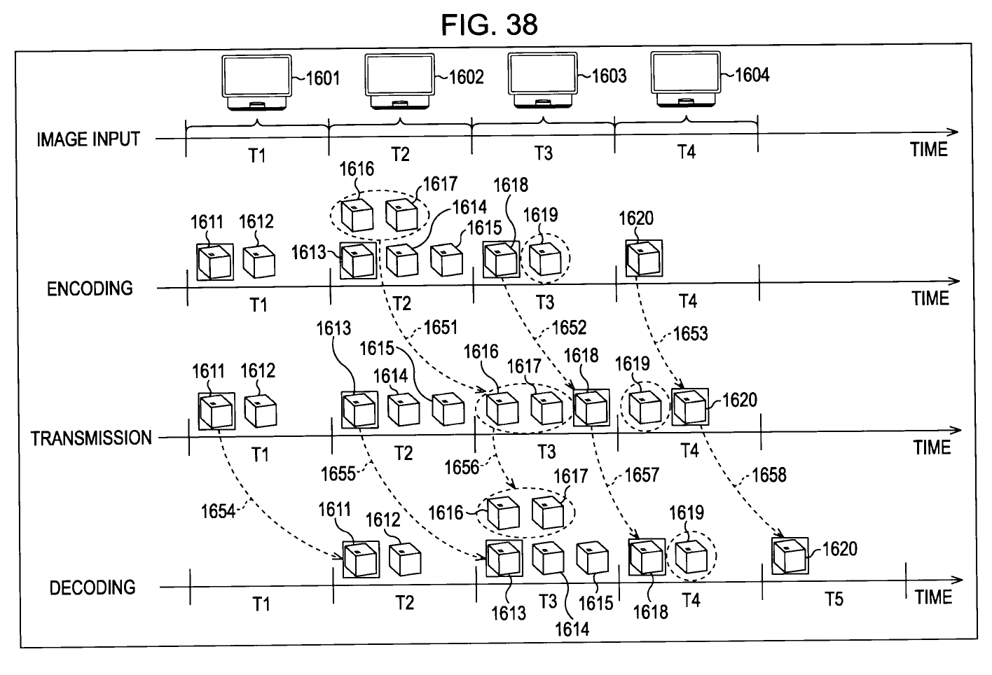

FIG. 38 is a diagram illustrating an example of the way data transmission is in the digital triax system 1500 in FIG. 37, and illustrates an example of the way the processing timing is at each processing process at the time of transmitting image data from a camera to a CCU. In FIG. 38, T1 through T5 at each tier represent the synchronization timing of the reference signal.

In FIG. 38, the topmost tier illustrates the way that data is at the time of image data being obtained by shooting with the camera (image input). As shown here, at each timing of T1 through T4, one frame worth of image data (image data 1601 through image data 1604) is input.

In FIG. 38, the second tier from the top illustrates the way that data is at the time of encoding processing being performed by the encoder built into the camera (encoding). As shown here, at timing T1, upon the encoder built into the camera encoding the image data 1601 with an encoding method such as described with reference to FIG. 4 and so forth, two packets worth of encoded data (packet 1611 and packet 1612) is generated. Here, “packet” indicates encoded data divided into every predetermined data amount (partial data of encoded data). In the same way, at timing T2, five packets worth of encoded data (packet 1613 through packet 1617) is generated from the image data 1602, at timing T3, two packets worth of encoded data (packet 1618 and packet 1619) is generated from the image data 1603, and at timing T4, one packet worth of encoded data (packet 1620) is generated from the image data 1604. Note here that the packet 1611, packet 1613, packet 1618, and packet 1620, enclosed with squares, represent the head packets of image data for each frame.

In FIG. 38, the third tier from the top illustrates the way that data is at the time of transmission from the camera to the CCU (transmission). As shown here, with the transmission from the camera to the CCU, the upper limit for the transmission rate is set, and if we say that a maximum of three packets can be transmitted at each timing, the two packets (packet 1616 and packet 1617) at timing T2, enclosed with the dotted line at the second tier from the top, will be transmitted at the next timing T3. That is to say, as indicated by arrow 1651, the transmission timing is offset by one timing. Accordingly, as indicated by the arrow 1652, the head packet 1618 is transmitted at the end of the timing T3, and the packet 1619 enclosed by the dotted line at the second tier from the top is transmitted at the next timing T4.

As indicated by arrow 1653, the head packet 1620 is transmitted at the end of the timing T4.

As described above, there are cases wherein data transmission requires time if the code amount is great, such that data transmission cannot be ended within one timing. In FIG. 38, the bottom tier illustrates an example of the way data is at the time of the transmitted encoded data being decoded by the decoder built into the CCU. In the event that such occurs, the packet 1613 through packet 1617 generated from the image data 1602 are all present at the CCU side at timing T3, and accordingly decoding processing of these is performed at timing T3.

Accordingly, so that continuous decoding can be performed, the packet 1611 and packet 1612 generated from the image data 1601 are decoded at timing T2, the packet 1618 and packet 1619 generated from the image data 1603 are decoded at timing T4, and the packet 1620 generated from the image data 1604 is decoded at timing T5.

As described above, in the event of measuring delay time using image data with great data amount such as with the image data 1602 for example, an unnecessary delay time might be measured. Accordingly, in the event of transmitting image data for measuring delay time, an arrangement may be made wherein image data with little data amount, such as a black image or white image for example, may be used.

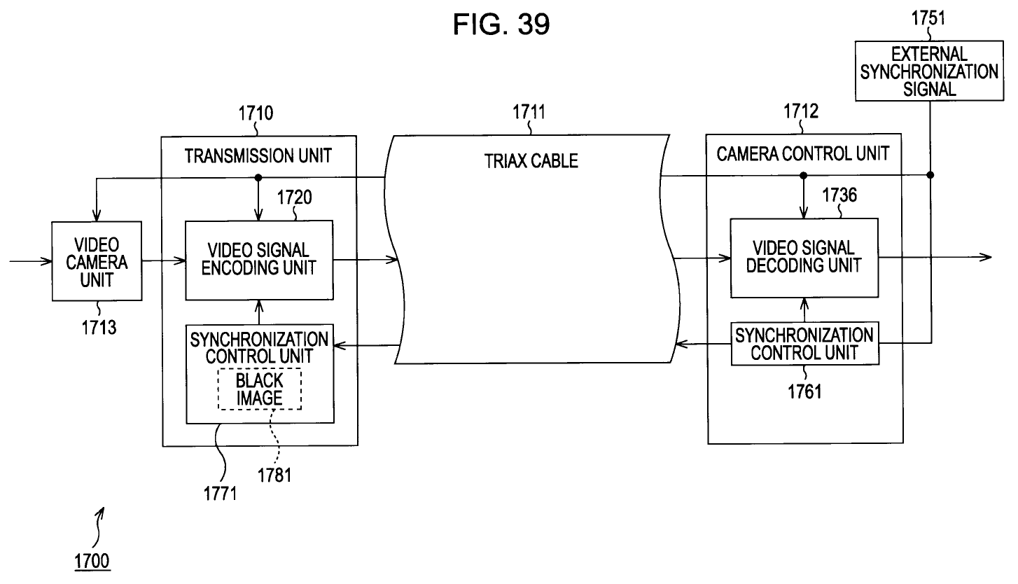

FIG. 39 is a block diagram illustrating a configuration example of a digital triax system in that case. The digital triax system 1700 shown in FIG. 39 is a system corresponding to a portion of the digital triax system 1500 described with reference to FIG. 37, and basically has the same configuration as the digital triax system 100 in FIG. 3. Only the configuration necessary for description is shown in FIG. 39.

As shown in FIG. 39, the digital triax system 1700 has a video camera unit 1713 and transmission unit 1710 corresponding to the camera 1511 of the digital triax system 1500 (FIG. 37) for example, a triax cable 1711 corresponding to the triax cable 1521 of the digital triax system 1500 (FIG. 37) for example, and a camera control unit 1712 corresponding to the CCU 1531 of the digital triax system 1500 (FIG. 37) for example. Note that the video camera unit 1713 also corresponds to the video camera unit 113 of the digital triax system 100 (FIG. 3), the transmission unit 1710 also corresponds to the transmission unit 110 of the digital triax system 100 (FIG. 3), the triax cable 1711 also corresponds to the triax cable 111 of the digital triax system 100 (FIG. 3), and the camera control unit 1712 also corresponds to the camera control unit 112 of the digital triax system 100 (FIG. 3).

The transmission unit 1710 has a video signal encoding unit 1720 equivalent to the video signal encoding unit 120 of the transmission unit 110, and the camera control unit 1712 has a video signal decoding unit 1736 equivalent to the video signal decoding unit 136 of the camera control unit 112. The video signal encoding unit 1720 of the transmission unit 1710 encodes image data supplied from the video camera unit 1713 with the same method as the video signal encoding unit 120 described with reference to FIG. 4 and so forth. Further, the transmission unit 1710 performs OFDM on the obtained encoded data, and transmits the obtained modulated signals to the camera control unit 1712 via the triax cable 1711. Upon receiving the modulated signals, the camera control unit 1712 demodulates this with the OFDM method. The video signal decoding unit 1736 of the camera control unit 1712 decodes the encoded data obtained by demodulation, and outputs the obtained image data to a downstream system (e.g., a switcher or the like)

Note that an external synchronization signal 1751 is supplied to the camera control unit 1712. Also, the external synchronization signal 1751 is also supplied to the transmission unit 1710 via the triax cable 1711. The transmission unit 1710 and camera control unit 1712 operate synchronously with this external synchronization signal.

Also, the transmission unit 1710 has a synchronization control unit 1771 for controlling synchronization timing with the camera control unit 1712. In the same way, the camera control unit 1712 has a synchronization control unit 1761 for controlling synchronization timing with the transmission unit 1710. Of course, the external synchronization signal 1751 is also supplied to the synchronization control unit 1761 and the synchronization control unit 1771. The synchronization control unit 1761 and synchronization control unit 1771 each perform control such that the camera control unit 1712 and transmission unit 1710 have suitable synchronization timing with each other while synchronizing with the external synchronization signal 1751.

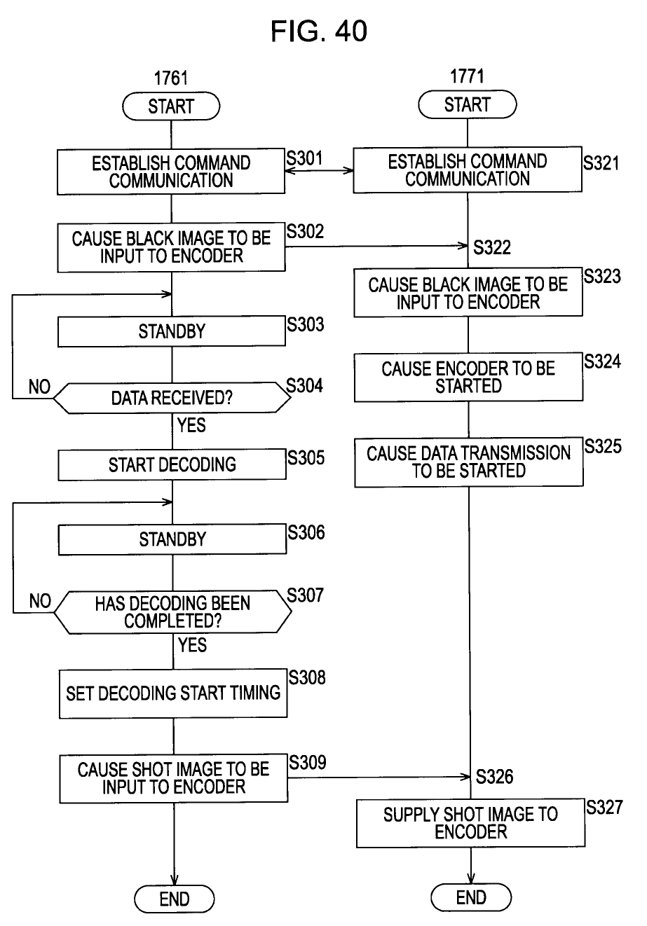

An example of the flow of the control processing will be described with reference to the flowchart in FIG. 40.

Upon control processing being started, in step S301 the synchronization control unit 1761 of the camera control unit 1712 performs communication with the synchronization control unit 1771, and establishes command communication so that control commands can be exchanged. Corresponding to this, in step S321 the synchronization control unit 1771 of the transmission unit 1710 also performs communication with the synchronization control unit 1761 in the same way, and establishes command communication.

Once control commands can be exchanged, in step S302 the synchronization control unit 1761 inputs to the synchronization control unit 1771 a black image which is one picture worth of image in which all pixels are black, to the encoder. The synchronization control unit 1771 has image data 1781 of a black image with little data amount (one picture worth of image in which all pixels are black) (hereafter called black image 1781), and in the event of receiving the instruction in step S322 from the synchronization control unit 1761, in step S323 supplies this black image 1781 to the video signal encoding unit 1720 (encoder), and in step S324 controls the video signal encoding unit 1720 and encodes the black image 1781 in the same way with the image data supplied from the video camera 1713 (actual case). Further, the synchronization control unit 1771 controls the transmission unit 1710 in step S325 and causes starting of data transmission of the obtained encoded data. More specifically, the synchronization control unit 1771 controls the transmission unit 1710, causes the encoded data to be subjected to OFDM in the same way as in real, and causes the obtained modulated signals to be transmitted to the camera control unit 1712 via the triax cable 1711.

After giving an instruction to the synchronization control unit 1771, in step S303 and step S304 the synchronization control unit 1761 stands by until the modulated signals are transmitted from the transmission unit 1710 to the camera control unit 1712. In step S304, in the event that the camera control unit 1712 has determined that data (modulated signals) has been received, the synchronization control unit 1761 advances the processing to step S305, controls the camera control unit 1712, demodulates the modulated signals with the OFDM method, and causes the video signal decoding unit 1736 to start decoding (decoding) the obtained encoded data. Upon causing the decoding to start, the synchronization control unit 1761 stands by in step S306 and S307 until decoding is completed. In the event that determination is made in step S307 that decoding is complete and a black image has been obtained, the synchronization control unit 1761 advances the processing to step S308.

In step S308, the synchronization control unit 1761 sets a decoding start timing (a relative timing as to the encoding start timing of the video signal encoding unit 1720) of the video signal decoding unit 1736 based on the time from issuing the instruction in step S302 till determining that decoding has been completed in step S307 as described above. Of course, this timing is synchronized with the external synchronization signal 1751.

In step S309, the synchronization control unit 1761 gives an instruction to the synchronization control unit 1771 to input an imaged image from the video camera unit 1713 in the encoder. Upon obtaining the instruction in step S326, in step S327 the synchronization control unit 1771 controls the transmission unit 1710, and causes to supply image data of the imaged image supplied from the video camera unit 1713 to the video signal encoding unit 1720 at a predetermined timing.

The video signal encoding unit 1720 starts encoding of the imaged image at a predetermined timing corresponding to the supply timing thereof. Also, the video signal decoding unit 1736 starts decoding at a predetermined timing corresponding to the encoding start timing, based on the setting performed in step S308.

As described above, the synchronization control unit 1761 and synchronization control unit 1771 perform control of synchronization timing between the encoder and decoder using image data with little data amount, and accordingly can suppress increase in unnecessary delay time due to setting of the synchronization timing. Accordingly, the digital triax system 1700 can synchronize the output of image data with other systems while maintaining low delay and suppressing increase in the buffer necessary for data transmission.

Note that in the above, description has been made regarding using a black image for control of the synchronization timing, but it is sufficient for the data amount to be small, and any image may be used such as a white image which is an image wherein all pixels are white, for example.

Also, description has been made in the above that the synchronization control unit 1761 built into the camera control unit 1712 gives instructions such as starting encoding and so forth to the synchronization control unit 1771 built into the transmission unit 1710, but is not restricted to this, and an arrangement may be made wherein the synchronization control unit 1771 serves as the main entity to perform control processing, and gives instructions such as starting of decoding and so forth. Also, the synchronization control unit 1761 and the synchronization control unit 1771 may both be configured separate from the transmission unit 1710 and camera control unit 1712. Also, the synchronization control unit 1761 and the synchronization control unit 1771 may be configured as a single processing unit, and at that time, the synchronization control unit 1761 and synchronization control unit 1771 may be built into the transmission unit 1710, or may be built into the camera control unit 1712, or may be configured separately from these.

The above-described series of processing may be executed by hardware, or may be executed by software. In the event of causing the series of processing by software, a program configuring the software is installed into a computer assembled into dedicated hardware, or a general-use personal computer for example which is capable of executing various types of functions by having various types of programs installed, or an information processing device of an information processing system made up of multiple devices, from a program recording medium.

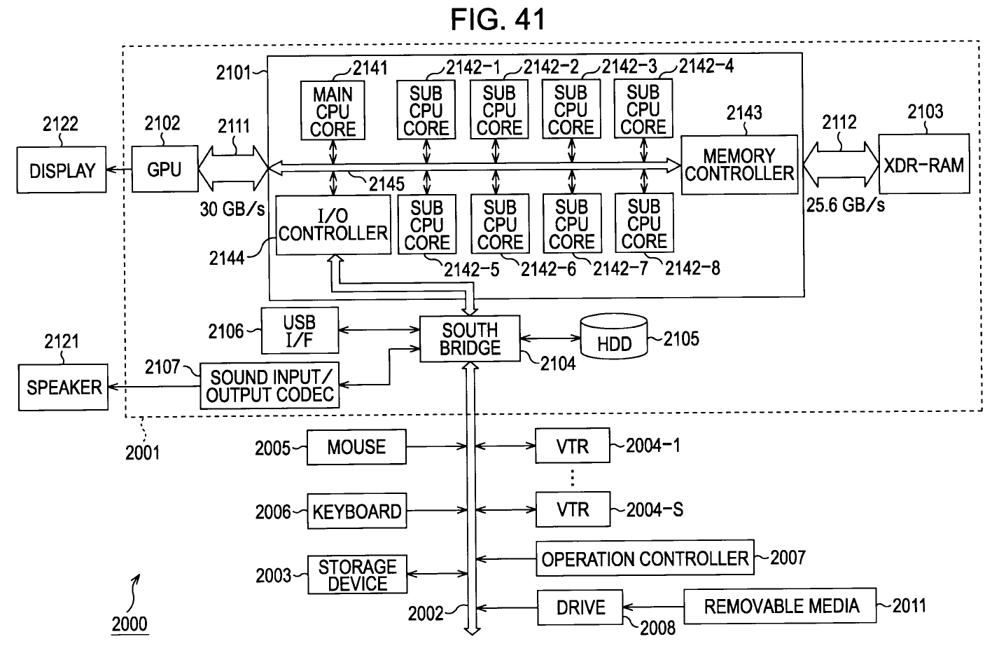

FIG. 41 is a block diagram illustrating an example of an information processing system for executing the above-described series of processing by a program.

As shown in FIG. 41, an information processing system 2000 is a system configured of an information processing device 2001, and a storage device 2003, VTR 2004-1 through VTR 2004-S which are multiple video tape recorders (VTR), a mouse 2005, keyboard 2006, and operation controller 2007 for a user to perform operating input to these, which are connected to the information processing device 2001 by a PCI bus 2002, and is a system for performing image encoding processing and image decoding processing and the like such as described above by an installed program.

For example, the information processing device 2001 of the information processing system 2000 can record, in the large-capacity storage device 2003 made up of a RAID (Redundant Arrays of Independent Disks), encoded data obtained by encoding moving image contents stored in the storage device 2003, storing in the storage device 2003 decoded image data (moving image contents) obtained by decoding encoded data stored in the storage device 2003, recording encoded data and decoded image data on videotape by way of the VTR 2004-1 through VTR 2004-S, and so forth. Also, the information processing device 2001 is also arranged such that moving image contents recorded in videotapes mounted to the VTR 2004-1 through VTR 2004-S can be taken into the storage device 2003. At this time, the information processing device 2001 may encode the moving image contents.

The information processing device 2001 has a microprocessor 2101, GPU (Graphics Processing Unit) 2102, XDR (Extreme Data Rate)-RAM 2103, south bridge 2104, HDD (Hard Disk Drive) 2105, USB (Universal Serial Bus) interface (USB I/F (interface)) 2106, and sound input/output codec 2107.

The GPU 2102 is connected to the microprocessor 2101 via a dedicated bus 2111. The XDR-RAM 2103 is connected to the microprocessor 2101 via a dedicated bus 2112. The south bridge 2104 is connected to an I/O (In/Out) controller 2144 of the microprocessor 2101 via a dedicated bus. The south bridge 2104 is also connected to the HDD 2105, USB interface 2106, and sound input/output codec 2107. The sound input/output codec 2107 is connected to a speaker 2121. Also, the GPU 2102 is connected to a display 2122.

Also, the south bridge 2104 is further connected to a mouse 2005, keyboard 2006, VTR 2004-1 through VTR 2004-S, storage device 2003, and operation controller 2007 via the PCI bus 2002.

The mouse 2005 and keyboard 2006 receive user operation input, and supply a signal indicating content of the user operation input to the microprocessor 2101 via the PCI bus 2002 and south bridge 2104. The storage device 2003 and VTR 2004-1 through VTR 2004-S are configured to be able to record or play back predetermined data.

The PCI bus 2002 is further connected to a driver 2008 as necessary, and removable media 2011 such as a magnetic disk, optical disc, magneto-optical disc, or semiconductor memory is mounted thereupon as appropriate, and the computer program read out therefrom is installed in the HDD 2105 as needed.

The microprocessor 2101 is configured with a multi-core configuration integrated on a single chip, having a general-use main CPU core 2141 which executes basic programs such as an OS (Operating System), sub-CPU core 2142-1 through sub-CPU core 2142-8 which are multiple (eight in this case) signal processing processors of a RISC (Reduced Instruction Set Computer) type connected to the main CPU core 2141 via a shared bus 2145, a memory controller 2143 to perform memory control as to the XDR-RAM 2103 having a capacity of 256 [Mbyte] for example, and an I/O controller 2144 to manage the input/output of data between the south bridge 2104, and for example realizes an operational frequency of 4 [GHz].

At time of startup, the microprocessor 2101 reads the necessary application program stored in the HDD 2105 and expands this in the XDR-RAM 2103, based on the control program stored in the HDD 2105, and executes necessary control processing thereafter based on the application program and operator operations.

Also, by executing the software, the microprocessor 2101 realizes the above-described image encoding processing and image decoding processing for the various embodiments, supplies the encoded stream obtained as a result of the encoding via the south bridge 2104, and can supply and store this in the HDD 2105, or transfer the data of the playback picture of the moving image content obtained as a result of decoding to the GPU 2102, and display this on a display 2122.

The usage method for each CPU core within the microprocessor 2101 is optional, but an arrangement may be made wherein, for example, the main CPU core 2141 performs processing relating to control of the bit rate conversion processing performed by the data control unit 137, and controls the eight sub-CPU core 2142-1 through sub-CPU core 2142-8 so as to execute the detailed processing of bit rate conversion processing such as counting code amount for example. Using multiple CPU cores enables multiple processing to be performed concurrently for example, enabling bit rate conversion processing to be performed at higher speed.

Also, an arrangement may be made wherein processing other than bit rate conversion, such as image encoding processing, image decoding processing, or processing relating to communication, for example, is performed at an optional CPU core within the microprocessor 2101. At this time, the CPU cores may each be arranged to execute different processing form each other concurrently, whereby the efficiency of processing can be improved, the delay time of overall processing reduced, and further the load, processing time, and memory capacity necessary for processing be reduced.

Also, in the event that an independent encoder or decoder, or codex processing device is connected to the PCI bus 2002 for example, the eight sub CPU core 2142-1 through sub CPU core 2142-8 of the microprocessor 2101 may be arranged so as to control processing executed by these devices via the south bridge 2104 and PCI bus 2002. Further, in the event that a plurality of these devices are connected, or in the event that these devices include multiple decoders or encoders, the eight sub CPU core 2142-1 through sub CPU core 2142-8 of the microprocessor 2101 may be arranged so as to each take partial charge and control the processing executed by the multiple decoders or encoders.

At this time, the main CPU core 2141 manages the operations of the eight sub CPU core 2142-1 through sub CPU core 2142-8, and assigns processing to each sub CPU core 2142 and retrieves processing results and so forth. Further, the main CPU core 2141 performs processing other than performed by these sub CPU core 2142-1 through sub CPU core 2142-8. For example, the main CPU core 2141 accepts commands supplied from the mouse 2005, key board 2006, or operation controller 2007, via the south bridge 2104, and executes various types of processing in accordance with the commands.

In addition to a final rendering processing relating to waiting for texture when the playback picture of the moving image contents displayed on the display 2122 is moved, the GPU 2102 can control the functions performing coordinate transformation calculating processing for displaying multiple playback pictures of moving image content and still images of still image content on a display 2122 at one time, expanding/reducing processing as to the playback picture of the moving image content and still images of the still image content, and lighten the processing load on the microprocessor 2101.

The GPU 2102 performs, under control of the microprocessor 2101, predetermined signal processing as to the supplied picture data of the moving image content or image data of the still image content, and consequently sends the obtained picture data and image data to the display 2122, and displays the image signal on the display 2122.

Incidentally, the playback images with multiple moving image contents wherein the eight sub CPU core 2142-1 through sub CPU core 2142-8 of the microprocessor 2101 are decoded simultaneously and in parallel are subjected to data transfer to the GPU 2102 via the bus 2111, but the transfer speed at this time is for example a maximum of 30 [Gbyte/sec], and is arranged such that a display can be made quickly and smoothly, even if the playback picture is complex and has been subjected to special effects.

Also, of the picture data and audio data of the moving image content, the microprocessor 2101 subjects the audio data to audio mixing processing, and sends the edited audio data obtained as a result thereof to the speaker 2121 via the south bridge 2104 and sound input/output coded 2107, whereby audio based on the audio signal can be output from the speaker 2121.

In the event of executing the above-described series of processing by software, a program making up that software is installed from a network or recording medium.

This recording medium is not only configured of removable media 2011 such as a magnetic disk (including flexible disks), optical disc (including CD-ROM (Compact Disc-Read Only Memory), DVD (Digital Versatile Disc)), magneto-optical disk (including MD (Mini-Disk)), or semiconductor memory in which the program is recorded, distributed separately from the device main unit to distribute the program to the user, and is configured of the HDD 2105 or storage device 2003 and the like in which the program is recorded, distributed to the user in a state of having been assembled into the device main unit beforehand. Of course, the recording medium may be semiconductor memory such as ROM or flash memory or the like, as well.

In the above, description has been made with the microprocessor 2101 being configured with eight sub CPU cores therein, but is not restricted to this, and the number of CPU cores is optional. Also, the microprocessor 2101 does not have to be configured of multiple cores such as the main CPU core 2141 and sub CPU core 2142-1 through sub CPU core 2142-8, and a CPU configured of a single core (1 core) may be used. Also, multiple CPUs may be used instead of the microprocessor 2101, or multiple information processing devices may be used (i.e., the program for executing the processing of the present invention may be executed at multiple devices operating in cooperation with each other).

Note that the steps describing the program recorded in the recording medium with the present specification include processing in time-series in the order described of course, but even if not necessarily processed in time-series, also includes processing executed in parallel or individually.

Also, according to the present specification, system represents the entirety of devices configured of multiple devices (devices).

Note that with the above-described, a configuration described as one device may be divided and configured as multiple devices. Conversely, a configuration described above as multiple devices may be configured together as one device. Also, a configuration other than the device configurations described above may be added. Further, as long as the configuration and operation as an entire system are substantially the same, a portion of the configuration of a certain device may be included in the configuration of another device.

### INDUSTRIAL APPLICABILITY

The present invention can be applied to, for example, a digital triax system.

1. An information processing device for encoding image data and generating encoded data, comprising:
rearranging means for rearranging beforehand coefficient data split into every frequency band, in an order in which synthesizing processing is performed for synthesizing coefficient data of a plurality of sub-bands split into frequency bands to generate image data, for every line block including image data of a number of lines worth necessary to generate one line worth of coefficient data of a lowest band component sub-band;
encoding means for encoding coefficient data, rearranged by said rearranging means, every line block, and generating encoded data;
storage means for storing encoded data generated by said encoding means;
calculating means for calculating the sum of code amount of said encoded data, each time said storage means store a plurality of said line blocks worth of encoded data; and
output means for outputting said encoded data stored in said storage means, in the event that the sum of code amount calculated by said calculating means reaches said target code amount.

2. The information processing device according to claim 1, wherein said output means convert the bit rate of said encoded data.

3. The information processing device according to claim 1, wherein said rearranging means rearrange said coefficient data in order from lowband component to highband component, every line block.

4. The information processing device according to claim 1, further comprising control means for controlling said rearranging means and said encoding means so as to each operate in parallel, every line block.

5. The information processing device according to claim 1, wherein said rearranging means and said encoding means perform each processing in parallel.

6. The information processing device according to claim 1, further comprising filter means for performing filtering processing as to said image data every line block, and generating a plurality of sub-bands made up of coefficient data split into every frequency band.

7. The information processing device according to claim 1, further comprising decoding means for decoding said encoded data.

8. The information processing device according to claim 1, further comprising:
modulation means for modulating said encoded data at mutually different frequency regions and generating modulation signals;
amplifying means for performing frequency multiplexing and amplification of modulation signals generated by said modulation means; and
transmission means for synthesizing and transmitting modulation signals amplified by said modulation means.

9. The information processing device according to claim 8, further comprising modulation control means for setting a modulation method of said modulation means, based on attenuation rate of a frequency region.

10. The information processing device according to claim 8, further comprising control means for, in the event that the attenuation rate of a frequency region is at or above a threshold value, setting signal point distance as to a highband component so as to be larger.

11. The information processing device according to claim 8, further comprising control means for, in the event that the attenuation rate of a frequency region is at or above a threshold value, setting an appropriation amount of error correction bits as to the highband component so as to be larger.

12. The information processing device according to claim 8, further comprising control means for, in the event that the attenuation rate of a frequency region is at or above a threshold value, setting a compression rate as to the highband component so as to be larger.

13. The information processing device according to claim 8, wherein said modulation means performs modulation by OFDM method.

14. The information processing device according to claim 1, further comprising a synchronization control unit for performing control of synchronization timing between said encoding means and decoding means for decoding said encoded data, using image data of which a data amount is smaller than a threshold value.

15. The information processing device according to claim 14, wherein said image data of which a data amount is smaller than a threshold value, is an image of one picture worth wherein all pixels are black.

16. An information processing method for an information processing device encoding image data and generating encoded data, comprising the steps of:
rearranging beforehand coefficient data split into every frequency band, in an order in which synthesizing processing is performed for synthesizing coefficient data of a plurality of sub-bands split into frequency bands to generate image data, for every line block including image data of a number of lines worth necessary to generate one line worth of coefficient data of a lowest band component sub-band;
encoding rearranged coefficient data, every line block, and generating encoded data;
storing generated encoded data;
calculating the sum of code amount of said encoded data, each time a plurality of said line blocks worth of encoded data is stored; and
outputting said stored encoded data, in the event that the calculated sum of code amount reaches said target code amount.
